(19) United States
(12) Patent Application Publication
(10) Pub. No.: US 2026/0126602 A1
(43) Pub. Date: May 7, 2026

(54) OPTICAL MODULE

(71) Applicant: HISENSE BROADBAND MULTIMEDIA TECHNOLOGIES CO., LTD., Qingdao, Shandong (CN)

(72) Inventors: Shuhua YE, Qingdao (CN); Hongchao PAN, Qingdao (CN); Yinlong LIU, Qingdao (CN); Hangkong YUAN, Qingdao (CN)

(21) Appl. No.: 19/438,042

(22) Filed: Dec. 31, 2025

Related U.S. Application Data
(63) Continuation of application No. PCT/CN2024/114839, filed on Aug. 27, 2024.

(30) Foreign Application Priority Data
Aug. 31, 2023 (CN) 202311120709.0
Aug. 31, 2023 (CN) 202322368323.3
Dec. 14, 2023 (CN) 202311724941.5
Dec. 18, 2023 (CN) 202311749010.0
Feb. 21, 2024 (CN) 202410194897.X

(51) Int. Cl. G02B 6/42

(52) U.S. Cl. CPC G02B 6/4278; G02B 6/4244; G02B 6/4261; G02B 6/4277; G02B 6/428

(57) ABSTRACT

An optical module, including a lower shell provided with a support plate, an assembly mechanism and a clamping component are arranged on the support plate; the clamping component has an unlocking surface; the unlocking component includes an assembly portion and an unlocking portion, the assembly portion is movably connected with an assembly mechanism; the unlocking surface is configured to enable the unlocking portion to unlock the clamping component; a movable gap for the unlocking component to move is provided between the assembly mechanism and a support surface of the support plate; a first protruding portion is provided on one side of the assembly mechanism facing the unlocking component; and in a reset process of the unlocking component, the first protruding portion is configured to selectively abut against the unlocking component, such that the first protruding portion pushes the unlocking component to move toward the lower shell.

The present disclosure is a continuation of International Application No. PCT/CN2024/114839, filed on Aug. 27, 2024, and claims priority to Chinese Patent Application No. 202311749010.0, filed with the China National Intellectual Property Administration on Dec. 18, 2023; priority to Chinese Patent Application No. 202311724941.5, filed with the China National Intellectual Property Administration on Dec. 14, 2023; priority to Chinese Patent Application No. 202410194897.X, filed with the China National Intellectual Property Administration on Feb. 21, 2024; priority to Chinese Patent Application No. 202311120709.0, filed with the China National Intellectual Property Administration on Aug. 31, 2023; and priority to Chinese Patent Application No. 202322368323.3, filed with the China National Intellectual Property Administration on Aug. 31, 2023, which is incorporated herein by reference in its entirety.

### FIELD OF THE INVENTION

The present disclosure relates to the field of optical fiber communication technology, and in particular, to an optical module.

### BACKGROUND OF THE INVENTION

With the development of new services and application models such as cloud computing, mobile Internet, and video, advances in optical communication technology have become increasingly important. In optical communication technology, the optical module is a device for enabling the conversion between optical and electrical signals, one of the key devices in optical communication equipment, and occupies a core position in optical communication.

### SUMMARY OF THE INVENTION

In a first aspect, embodiments of the present disclosure provide an optical module, and includes:
an upper shell;
a lower shell, covering the upper shell to form a shell, where one of the upper shell and the lower shell is provided with a support plate, a support surface is formed on the support plate, an assembly mechanism is provided on the support surface, the support surface is provided with a clamping component, the clamping component protrudes from the support surface, and an unlocking surface is provided on a side of the clamping component and is lower than a top surface of the clamping component; and
an unlocking component, including an assembly portion and an unlocking portion, where one end of the unlocking portion is in assembly connection with the assembly part, the assembly part is connected to the assembly mechanism and is movable relative to an assembly structure, the unlocking portion is located on a side of the clamping component, and the unlocking surface is configured to abut against the unlocking portion;
a movable gap for the unlocking component to move is provided between the assembly mechanism and the support surface; a first protruding portion is provided on one side of the assembly mechanism facing the unlocking component; and in a reset process of the unlocking component, the first protruding portion is configured to selectively abut against the unlocking component, such that the first protruding portion pushes the unlocking component to move toward the lower shell.

### BRIEF DESCRIPTION OF THE DRAWINGS

To illustrate the technical solutions in the present disclosure more clearly, a brief introduction to the drawings that need to be used in some embodiments of the present disclosure will be provided below. Apparently, the drawings described below are merely the drawings in some embodiments of the present disclosure. Those of ordinary skill in the art can also derive other drawings from these drawings. Furthermore, the drawings described below can be regarded as schematic diagrams and are not intended to limit the actual dimensions of the products, the actual processes of the methods, or the actual timing of the signals involved in the embodiments of the present disclosure.

FIG. 1 is a partial structural diagram of an optical communication system according to some embodiments of the present disclosure;

FIG. 2 is a partial structural diagram of a host computer according to some embodiments of the present disclosure;

FIG. 3 is a structural diagram of an optical module according to some embodiments of the present disclosure;

FIG. 4 is an exploded view of an optical module according to some embodiments of the present disclosure;

FIG. 5 is a schematic structural diagram of an unlocking component according to some embodiments of the present disclosure;

FIG. 6 is a partial enlarged view at A in FIG. 5;

FIG. 7 is a first partial schematic diagram of an unlocking component according to some embodiments of the present disclosure;

FIG. 8 is a second partial schematic diagram of an unlocking component according to some embodiments of the present disclosure;

FIG. 9 is a third partial schematic diagram of an unlocking component according to some embodiments of the present disclosure;

FIG. 10 is a fourth partial schematic diagram of an unlocking component according to some embodiments of the present disclosure;

FIG. 11 is a fifth partial schematic diagram of an unlocking component according to some embodiments of the present disclosure;

FIG. 12 is a schematic structural diagram of a lower shell according to some embodiments of the present disclosure;

FIG. 13 is a first partial schematic diagram of a lower shell according to some embodiments of the present disclosure;

FIG. 14 is a second partial schematic diagram of a lower shell according to some embodiments of the present disclosure;

FIG. 15 is a third partial schematic diagram of a lower shell according to some embodiments of the present disclosure;

FIG. 16 is a schematic assembly diagram of a lower shell and an unlocking component according to some embodiments of the present disclosure;

FIG. 17 is a partial enlarged view at B in FIG. 16;

FIG. 18 is a first partial schematic diagram of an optical module according to some embodiments of the present disclosure;

FIG. 19 is a second partial schematic diagram of an optical module according to some embodiments of the present disclosure;

FIG. 20 is a schematic assembly diagram of an optical module and a cage according to some embodiments of the present disclosure;

FIG. 21 is a third partial schematic diagram of an optical module according to some embodiments of the present disclosure;

FIG. 22 is a first schematic structural diagram of a shielding sheet according to some embodiments of the present disclosure;

FIG. 23 is a second schematic structural diagram of a shielding sheet according to some embodiments of the present disclosure;

FIG. 24 is a first schematic structural diagram of a fixing sheet according to some embodiments of the present disclosure;

FIG. 25 is a second schematic structural diagram of a fixing sheet according to some embodiments of the present disclosure;

FIG. 26 is a schematic diagram of an internal structure of an optical module according to some embodiments of the present disclosure;

FIG. 27 is an exploded schematic diagram of another optical module according to some embodiments of the present disclosure;

FIG. 28 is a cross-sectional view of an optical module according to some embodiments of the present disclosure;

FIG. 29 is a partial enlarged view at C in FIG. 28;

FIG. 30 is a schematic structural diagram of cooperation between an unlocking component and a lower shell in an optical module according to an embodiment of the present disclosure;

FIG. 31 is an exploded schematic structural diagram of cooperation between an unlocking component and a lower shell in an optical module according to an embodiment of the present disclosure;

FIG. 32 is a schematic structural diagram of a lower shell in an optical module according to an embodiment of the present disclosure;

FIG. 33 is a partial enlarged view at A in FIG. 32;

FIG. 34 is another schematic structural diagram of a lower shell in an optical module according to an embodiment of the present disclosure;

FIG. 35 is a schematic structural diagram of cooperation between a lower shell and an unlocking component in an optical module according to an embodiment of the present disclosure;

FIG. 36 is a schematic structural diagram of an unlocking component in an optical module according to an embodiment of the present disclosure;

FIG. 37 is another schematic structural diagram of an unlocking component in an optical module according to an embodiment of the present disclosure;

FIG. 38 is yet another schematic structural diagram of an unlocking component in an optical module according to an embodiment of the present disclosure;

FIG. 39 is a cross-sectional view of an unlocking component in an optical module according to an embodiment of the present disclosure;

FIG. 40 is a partial enlarged view at B in FIG. 39;

FIG. 41 is an exploded schematic structural diagram of cooperation among a lower shell, an unlocking component, and an outer cover plate in an optical module according to an embodiment of the present disclosure;

FIG. 42 is a schematic structural diagram of an outer cover plate in an optical module according to an embodiment of the present disclosure;

FIG. 43 is another schematic structural diagram of an outer cover plate in an optical module according to an embodiment of the present disclosure;

FIG. 44 is yet another schematic structural diagram of an outer cover plate in an optical module according to an embodiment of the present disclosure;

FIG. 45 is a partial enlarged view at C in FIG. 44;

FIG. 46 is a cross-sectional view of cooperation between an unlocking component and a lower shell in an optical module according to an embodiment of the present disclosure;

FIG. 47 is a partial enlarged view at D in FIG. 46;

FIG. 48 is a partial enlarged view when an unlocking component is moved to a preset position in an optical module according to an embodiment of the present disclosure;

FIG. 49 is another cross-sectional view of cooperation between an unlocking component and a lower shell in an optical module according to an embodiment of the present disclosure;

FIG. 50 is a partial enlarged view at E in FIG. 49;

FIG. 51 is a first partial structural diagram of a lower shell in an optical module according to some embodiments of the present disclosure;

FIG. 52 is a structural diagram of an unlocking component in an optical module according to some embodiments of the present disclosure;

FIG. 53 is a first structural diagram of an unlocker in an optical module according to some embodiments of the present disclosure;

FIG. 54 is an exploded assembly diagram of a lower shell and an unlocking component in an optical module according to some embodiments of the present disclosure;

FIG. 55 is a partial top view of a lower shell in an optical module according to some embodiments of the present disclosure;

FIG. 56 is a first assembly diagram of a lower shell and an unlocking component in an optical module according to some embodiments of the present disclosure;

FIG. 57 is a first diagram of an unlocking process of a lower shell and an unlocking component in an optical module according to some embodiments of the present disclosure;

FIG. 58 is a structural diagram of an upper shell in an optical module according to some embodiments of the present disclosure;

FIG. 59 is a structural assembly diagram of an upper shell and an unlocking component in an optical module according to some embodiments of the present disclosure;

FIG. 60 is a first cross-sectional assembly view of an upper shell, a lower shell, and an unlocking component in an optical module according to some embodiments of the present disclosure;

FIG. 61 is a partial assembly diagram of an optical module and a cage of a host computer according to some embodiments of the present disclosure;

FIG. 62 is a cross-sectional assembly view of a lower shell, an unlocking component, and a cage of a host computer in an optical module according to some embodiments of the present disclosure;

FIG. 63 is a second partial structural diagram of a lower shell in an optical module according to some embodiments of the present disclosure;

FIG. 64 is a structural diagram of a lower shell in an optical module according to some embodiments of the present disclosure;

FIG. 65 is a second structural diagram of an unlocker in an optical module according to some embodiments of the present disclosure;

FIG. 66 is a second assembly diagram of a lower shell and an unlocking component in an optical module according to some embodiments of the present disclosure;

FIG. 67 is a second diagram of an unlocking process of a lower shell and an unlocking component in an optical module according to some embodiments of the present disclosure;

FIG. 68 is a second cross-sectional assembly view of an upper shell, a lower shell, and an unlocking component in an optical module according to some embodiments of the present disclosure;

FIG. 69 is an exploded view of an unlocking component according to some embodiments;

FIG. 70 is a structural diagram of an unlocking handle according to some embodiments;

FIG. 71 is a partial structural diagram of an unlocking handle according to some embodiments;

FIG. 72 is a first structural diagram of an unlocker according to some embodiments;

FIG. 73 is a second structural diagram of an unlocker according to some embodiments;

FIG. 74 is a cross-sectional view of an unlocking component according to some embodiments;

FIG. 75 is a cross-sectional view of an optical module according to some embodiments;

FIG. 76 is an exploded cross-sectional view of an optical module according to some embodiments;

FIG. 77 is a schematic diagram of an unlocking principle of an unlocking component according to some embodiments;

FIG. 78 is a cross-sectional view of an unlocking principle of an unlocking component according to some embodiments;

FIG. 79 is a structural diagram of an optical module in a locked state according to some embodiments;

FIG. 80 is a structural diagram of an optical module in an unlocked state according to some embodiments;

FIG. 81 is a first diagram of an unlocking process of an unlocking component according to some embodiments;

FIG. 82 is a second diagram of an unlocking process of an unlocking component according to some embodiments;

FIG. 83 is a third diagram of an unlocking process of an unlocking component according to some embodiments;

FIG. 84 is a structural diagram of an optical network terminal cage according to some embodiments;

FIG. 85 is a structural diagram of an unlocking component according to some embodiments;

FIG. 86 is a first structural diagram of an unlocking handle according to some embodiments;

FIG. 87 is a second structural diagram of an unlocking handle according to some embodiments;

FIG. 88 is a first structural diagram of an unlocker according to some embodiments;

FIG. 89 is a second structural diagram of an unlocker according to some embodiments;

FIG. 90 is a cross-sectional structural diagram of an unlocker according to some embodiments;

FIG. 91 is a structural diagram of an upper shell according to some embodiments;

FIG. 92 is a cross-sectional view of an electrical port module according to some embodiments;

FIG. 93 is a structural diagram of an electrical port module end according to some embodiments;

FIG. 94 is a diagram of an unlocking process of an unlocking component according to some embodiments;

FIG. 95 is a first schematic diagram of an unlocking principle of an unlocking component according to some embodiments;

FIG. 96 is a second schematic diagram of an unlocking principle of an unlocking component according to some embodiments;

FIG. 97 is a first diagram of an initial unlocking state of an unlocking component according to some embodiments;

FIG. 98 is a second diagram of an initial unlocking state of an unlocking component according to some embodiments;

FIG. 99 is a first diagram of an intermediate unlocking state of an unlocking component according to some embodiments;

FIG. 100 is a second diagram of an intermediate unlocking state of an unlocking component according to some embodiments;

FIG. 101 is a first diagram of a final unlocking state of an unlocking component according to some embodiments;

FIG. 102 is a second diagram of a final unlocking state of an unlocking component according to some embodiments; and

FIG. 103 is a third diagram of a final unlocking state of an unlocking component according to some embodiments.

### DETAILED DESCRIPTION OF THE EMBODIMENTS

The technical solutions in some embodiments of the present disclosure will be clearly and detailedly described below with reference to the accompanying drawings. Apparently, the described embodiments are merely some rather than all of the embodiments of the present disclosure. All other embodiments obtained by those of ordinary skill in the art based on the embodiments provided in the present disclosure fall within the scope of protection of the present disclosure.

In optical communication technology, in order to establish information transmission between information processing devices, it is necessary to load information onto light and use the propagation of light to implement the transmission of information. Here, the light loaded with information is an optical signal. When the optical signal is transmitted in the information transmission devices, the loss of optical power can be reduced, such that high-speed, long-distance, and low-cost information transmission can be implemented. The signals that the information processing devices are able to recognize and process are electrical signals. The information processing devices usually include optical network units (ONUs), gateways, routers, switches, mobile phones, computers, servers, tablet computers, televisions, etc. The information transmission devices usually include optical fibers and optical waveguides.

The optical modules enable the conversion between optical signals and electrical signals from the information processing devices and the information transmission devices. For example, at least one of an optical signal input or an optical signal output of an optical module is connected to an optical fiber, and at least one of an electrical signal input or an electrical signal output of the optical module is connected to an optical network unit; a first optical signal from the optical fiber is transmitted to the optical module, and the optical module converts the first optical signal into a first electrical signal and transmits the first electrical signal to the optical network unit; and a second electrical signal from the optical network unit is transmitted to the optical module, and the optical module converts the second electrical signal into a second optical signal and transmits the second optical signal to the optical fiber. Since information can be transmitted through electrical signals between a plurality of information processing devices, at least one information processing device in the plurality of information processing devices is required to be directly connected to the optical module, and all information processing devices are not required to be directly connected to the optical module. Here, the information processing device directly connected to the optical module is referred to as a host computer of the optical module. In addition, the optical signal input or the optical signal output of the optical module can be referred to as an optical port, and the electrical signal input or the electrical signal output of the optical module can be referred to as an electrical port.

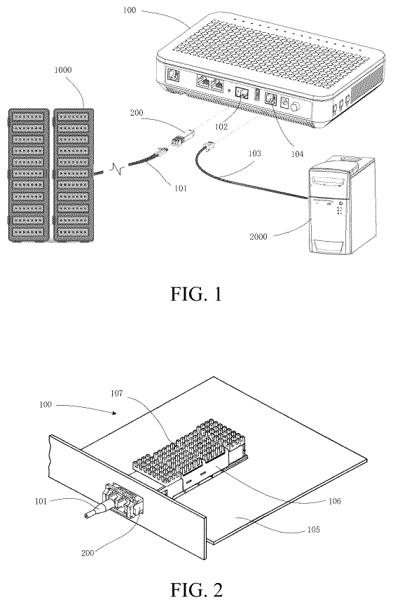

FIG. 1 is a partial structural diagram of an optical communication system according to some embodiments of the present disclosure. As shown in FIG. 1, the optical communication system primarily includes a remote information processing device 1000, a local information processing device 2000, a host computer 100, an optical module 200, an optical fiber 101 and a network cable 103.

One end of the optical fiber 101 extends toward the remote information processing device 1000, and the other end of the optical fiber 101 is connected to the optical module 200 via an optical port of the optical module 200. An optical signal can undergo total reflection in the optical fiber 101, and the propagation of the optical signal in a total reflection direction can make it nearly maintain its original optical power. The optical signal undergoes multiple total reflections in the optical fiber 101 to transmit an optical signal from the remote information processing device 1000 to the optical module 200 or to transmit an optical signal from the optical module 200 to the remote information processing device 1000, thereby achieving long-distance and low-power-loss information transmission.

The optical communication system may include one or more optical fibers 101, and the optical fiber 101 is detachably or fixedly connected to the optical module 200. The host computer 100 is configured to provide a data signal to the optical module 200, receive a data signal from the optical module 200, or monitor or control a working state of the optical module 200.

The host computer 100 includes a generally cuboid-shaped shell (housing), and an optical module interface 102 arranged on the shell. The optical module interface 102 is configured to be connected to the optical module 200, enabling the host computer 100 to establish a one-way or two-way electrical signal connection with the optical module 200.

The host computer 100 further includes an external electrical interface that can be connected to an electrical signal network. For example, the external electrical interface includes a universal serial bus (USB) interface or a network cable interface 104. The network cable interface 104 is configured to be connected to the network cable 103, enabling the host computer 100 to establish a one-way or two-way electrical signal connection with the network cable 103. One end of the network cable 103 is connected to the local information processing device 2000, and the other end of the network cable 103 is connected to the host computer 100, thereby establishing an electrical signal connection between the local information processing device 2000 and the host computer 100 via the network cable 103. For example, a third electrical signal sent by the local information processing device 2000 is transmitted to the host computer 100 via the network cable 103. The host computer 100 generates a second electrical signal according to the third electrical signal. The second electrical signal from the host computer 100 is transmitted to the optical module 200. The optical module 200 converts the second electrical signal into a second optical signal and transmits the second optical signal to the optical fiber 101. The second optical signal is transmitted through the optical fiber 101 to the remote information processing device 1000. For example, a first optical signal from the remote information processing device 1000 is transmitted through the optical fiber 101. The first optical signal from the optical fiber 101 is transmitted to the optical module 200. The optical module 200 converts the first optical signal into a first electrical signal, and then the optical module 200 transmits the first electrical signal to the host computer 100. The host computer 100 generates a fourth electrical signal according to the first electrical signal and transmits the fourth electrical signal to the local information processing device 2000. It should be noted that the optical module is a tool to implement the conversion between optical signals and electrical signals. In the conversion between the optical signals and the electrical signals, the information remains unchanged, and the encoding and decoding methods for the information may vary.

In addition to the optical network unit, the host computer 100 further includes an optical line terminal (OLT), an optical network terminal (ONT), or a data center server.

FIG. 2 is a partial structural diagram of a host computer according to some embodiments. To clearly show the connection relationship between the optical module 200 and the host computer 100, FIG. 2 shows only the structure of the host computer 100 related to the optical module 200. As shown in FIG. 2, the host computer 100 further includes a printed circuit board (PCB) 105 arranged in the shell, a cage 106 arranged on the surface of the PCB 105, a heat sink 107 arranged on the cage 106, and an electrical connector arranged inside the cage 106. The electrical connector is configured to be connected to the electrical port of the optical module 200. The heat sink 107 has protruding structures such as fins that enlarge the heat dissipation area.

The optical module 200 is inserted into the cage 106 of the host computer 100, and the optical module 200 is fixed by the cage 106. Heat generated by the optical module 200 is conducted to the cage 106 and then diffused through the heat sink 107. After the optical module 200 is inserted into the cage 106, the electrical port of the optical module 200 is connected to the electrical connector inside the cage 106, such that the optical module 200 establishes a two-way electrical signal connection with the host computer 100. In addition, the optical port of the optical module 200 is connected to the optical fiber 101, thereby establishing a bidirectional optical signal connection between the optical module 200 and the optical fiber 101.

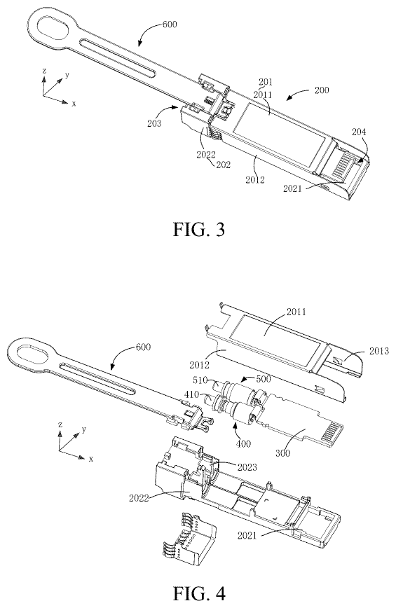

FIG. 3 is a structural diagram of an optical module according to some embodiments of the present disclosure. FIG. 4 is an exploded view of an optical module according to some embodiments of the present disclosure. The x-axis direction is the length direction of the optical module 200, the y-axis direction is the width direction of the optical module 200, and the z-axis direction is the height direction of the optical module 200. As shown in FIG. 3 and FIG. 4, the optical module 200 includes a shell, and a circuit board 300, an optical emission component 400 and an optical reception component 500 which are arranged in the shell. However, the present disclosure is not limited thereto. In some embodiments, the optical module 200 includes either the optical emission component 400 or the optical reception component 500.

The shell includes an upper shell 201 and a lower shell 202, where the upper shell 201 is in assembly connection with the lower shell 202 to form the shell with two openings 203 and 204; and the outer contour of the shell is generally square.

In some embodiments, the lower shell 202 includes a bottom plate 2021 and lower side plates located at both sides of the bottom plate 2021 and perpendicular to the bottom plate 2021, and the upper shell 201 includes a cover plate 2011, where the cover plate 2011 covers the two lower side plates of the lower shell 202 to form the shell.

In some embodiments, the lower shell 202 includes a bottom plate 2021, as well as a first lower side plate 2022 and a second lower side plate 2023 that are located at both sides of the bottom plate 2021 and arranged perpendicular to the bottom plate 2021; the upper shell 201 includes the cover plate 2011, as well as a first upper side plate 2012 and a second upper side plate 2013 that are located at both sides of the cover plate 2011 and arranged perpendicular to the cover plate 2011, where a first lower side plate 2022 and a second lower side plate 2023 are respectively connected to the first upper side plate 2012 and the second upper side plate 2013 to implement the assembly connection of the upper shell 201 to the lower shell 202.

A direction of a connecting line between the opening 203 and the opening 204 may be consistent with a length direction of the optical module 200 or may be inconsistent with the length direction of the optical module 200. For example, the opening 203 is located at the end of the optical module 200 (the right end of FIG. 3), and the opening 204 is also located at the end of the optical module 200 (the left end of FIG. 3). Alternatively, the opening 203 is located at the end of the optical module 200, and the opening 204 is located at the side part of the optical module 200. The opening 203 is an electrical port, and a gold finger of the circuit board 300 extends out from the electrical port and is inserted into the host computer (e.g., an optical network unit 100); and the opening 204 is an optical port, which is configured to access the optical fiber 101 such that the optical fiber 101 is connected into the optical module 200.

The assembly method of combining the upper shell 201 with the lower shell 202 is adopted, such that the circuit board 300, the optical emission component 400 and the optical reception component 500 and other components can be conveniently mounted in the shell, and these devices can be packaged by the upper shell 201 and the lower shell 202 for protection. In addition, when the circuit board 300, the optical emission component 400, and the optical reception component 500 and other components are assembled, it is convenient for the deployment of positioning parts, heat dissipation parts and electromagnetic shielding portions of these devices, and is conducive to the automatic production.

In some embodiments, the upper shell 201 and the lower shell 202 are made of metal materials, facilitating electromagnetic shielding and heat dissipation.

In some embodiments, the optical module 200 further includes an unlocking component 600 located outside the shell. The unlocking component 600 is configured to implement a fixed connection between the optical module 200 and the host computer, or to release the fixed connection between the optical module 200 and the host computer.

For example, a clamping component is provided on the lower shell 202, and configured to fix the optical module 200 in the cage 106. The unlocking component 600 is provided on the lower shell 202. When the unlocking component 600 is pulled, the unlocking component 600 is moved, a connection relationship between the clamping component and the host computer is changed by the unlocking component 600 to release the fixation of the optical module 200 to the host computer, thereby pulling out the optical module 200 from the cage 106.

The circuit board 300 includes circuit traces, electronic components, and chips, where the electronic components and the chips are connected together through the circuit traces according to the circuit design to implement the functions such as power supply, electrical signal transmission, and grounding. The electronic components include, for example, capacitors, resistors, transistors, and metal-oxide-semiconductor field-effect transistors (MOSFETs). The chips include, for example, lasers, photodetectors, microcontroller units (MCUs), laser driver chips, limiting amplifiers (LAs), clock and data recovery (CDR) chips, power management chips, and digital signal processing (DSP) chips.

The circuit board 300 is generally a rigid circuit board. The rigid circuit board can also implement a bearing effect because of its relatively hard material, for example, the rigid circuit board can stably carry the above-mentioned electronic components and chips. The rigid circuit board can also be inserted into the electrical connector in the cage 106 of the host computer 100.

The circuit board 300 further includes a gold finger formed on its end surface, where the gold finger consists of a plurality of pins that are independent of each other. The circuit board 300 is inserted into the cage 106 and is connected to the electrical connector in the cage 106 via the gold finger. The gold finger may be provided only on a side surface of the circuit board 300 (such as an upper surface shown in FIG. 4), or may be provided on upper and lower side surfaces of the circuit board 300 to provide more pins, so as to adapt to occasions requiring a large number of pins. The gold finger is configured to establish an electrical connection with the host computer to implement power supply, grounding, two-wire inter-integrated circuit (I2C) signal transmission, data signal transmission, etc. Certainly, flexible circuit boards are also used in some optical modules. Flexible circuit boards are generally used in conjunction with rigid circuit boards as a supplement to rigid circuit boards.

In some embodiments, the optical emission component 400 and the optical reception component 500 are physically separated from the circuit board 300 and then are electrically connected to the circuit board 300 via corresponding flexible circuit boards or electrical connectors. Of course, in some embodiments, at least one of the optical emission component 400 and the optical reception component 500 may be directly arranged on the circuit board 300. For example, at least one of the optical emission component 400 or the optical reception component 500 may be arranged on a surface of the circuit board 300 or a side of the circuit board 300.

In some embodiments, the optical module 200 further includes a first optical fiber adapter 410 and a second optical fiber adapter 510, where the first optical fiber adapter 410 and the second optical fiber adapter 510 are configured to connect to an external optical fiber 101. For example, one end of the first optical fiber adapter 410 and one end of the second optical fiber adapter 510 are configured to connect to the external optical fiber 101, the other end of the first optical fiber adapter 410 is connected to the optical emission component 400, and the other end of the second optical fiber adapter 510 is connected to the optical reception component 500.

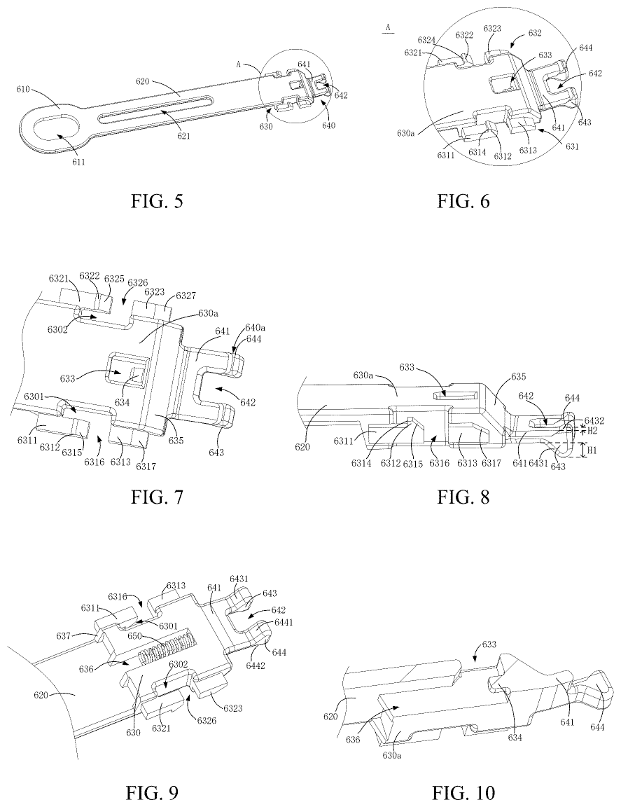

FIG. 5 is a schematic structural diagram of an unlocking component according to some embodiments of the present disclosure. As shown in FIG. 5, the unlocking component 600 includes a gripping portion 610, a connecting portion 620, an assembly portion 630, and an unlocking portion 640. The gripping portion 610 is one end of the unlocking component 600, the unlocking portion 640 is the other end of the unlocking component 600, and the gripping portion 610 and the unlocking portion 640 are sequentially connected via the connecting portion 620 and the assembly portion 630. One end of the connecting portion 620 is connected to the gripping portion 610, the other end of the connecting portion 620 is connected to one end of the assembly portion 630, and the other end of the assembly portion 630 is connected to the unlocking portion 640. The gripping portion 610 is configured to facilitate gripping when the unlocking component 600 is pulled; the connecting portion 620 is configured to implement connection of the gripping portion 610 and the assembly portion 630, so as to facilitate adjusting the length of the unlocking component 600; the unlocking portion 640 is located at a side of the clamping component, and the assembly portion 630 is configured to implement the assembly connection of the lower shell 202, so as to implement the fixation of the unlocking component 600 to the lower shell 202 and allow the unlocking component 600 to move relative to the lower shell 202; and the unlocking portion 640 is configured to release the connection relationship between the clamping component and the host computer when the unlocking component 600 is pulled.

In some embodiments, the unlocking component 600 is integrally formed of plastic material, which facilitates saving the production cost of the unlocking component 600.

In some embodiments, the width of the gripping portion 610 is greater than the width of the connecting portion 620, which facilitates gripping the gripping portion 610. For example, a through hole 611 is provided in the gripping portion 610 to facilitate gripping the gripping portion 610.

In some embodiments, the connecting portion 620 has a preset length to control the overall length of the unlocking component 600, which facilitates mounting the optical module 200 into a cage 106 relatively far from the edge of the host computer. For example, a through hole 621 is provided in the connecting portion 620, the through hole 621 extends along the length direction of the connecting portion 620, and the through hole 621 can increase the elasticity of the connecting portion 620, which facilitates the avoidance of the connector of the external optical fiber 101 when the optical module 200 is connected to the external optical fiber 101.

In some embodiments, the thickness of the assembly portion 630 is greater than the thickness of the connecting portion 620, which facilitates increasing the strength of the assembly portion 630. For example, an assembly component is formed on the assembly portion 630, and an assembly mechanism is provided on the lower shell 202, where the assembly mechanism cooperates with the assembly component, such that the assembly portion 630 can move relative to the lower shell 202.

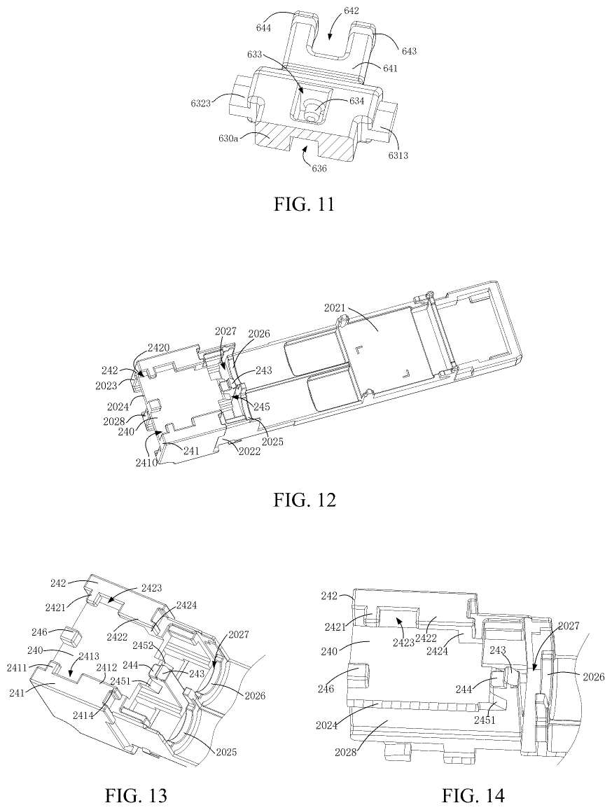

FIG. 6 is a partial enlarged view at A in FIG. 5; FIG. 7 is a first partial schematic diagram of an unlocking component according to some embodiments of the present disclosure; FIG. 8 is a second partial schematic diagram of an unlocking component according to some embodiments of the present disclosure; FIG. 9 is a third partial schematic diagram of an unlocking component according to some embodiments of the present disclosure; FIG. 10 is a fourth partial schematic diagram of an unlocking component according to some embodiments of the present disclosure; FIG. 11 is a fifth partial schematic diagram of an unlocking component according to some embodiments of the present disclosure; and FIG. 6 to FIG. 11 show a detailed structure of an unlocking component.

In some embodiments, the assembly portion 630 includes an assembly body 630a, one end of the assembly body 630a is connected to the connecting portion 620, and the other end of the assembly body 630a is connected to the unlocking portion 640. A first assembly component 631 is provided on one side of the assembly body 630a, and a second assembly component 632 is provided on the other side of the assembly body 630a, which facilitates smooth assembly connection of the assembly body 630a to the lower shell 202.

In some examples, at least one of the first assembly component 631 and the second assembly component 632 may include an assembly post and a limiting protrusion.

In some examples, the first assembly component 631 may include the assembly post and the limiting protrusion.

In some examples, the second assembly component 632 may include the assembly post and the limiting protrusion.

In some embodiments, the first assembly component 631 and the second assembly component 632 may respectively include the assembly post and the limiting protrusion, the limiting protrusion is provided on the assembly post, the assembly post is used for guiding and limiting, and the limiting protrusion is used for limiting, such that the assembly portion 630 can move relative to the lower shell 202 through the assembly body 630a for which the first assembly component 631 is in assembly connection with the second assembly component 632. For example, the assembly mechanism corresponding to the assembly post and the limiting protrusion is provided on the lower shell 202, and the assembly mechanism is in assembly connection with the assembly post and the limiting protrusion. The assembly mechanism may be a sliding slot, sliding rail or the like.

In some embodiments, the first assembly component 631 includes a first assembly post 6311, the first assembly post 6311 extends along the x-axis direction, and a side of the first assembly post 6311 is connected to one side of the assembly body 630a; a first assembly protrusion 6312 is provided on the first assembly post 6311, and the first assembly protrusion 6312 is a protrusion formed by the top of the first assembly post 6311 protruding outward. The first assembly post 6311 is configured to implement the assembly connection of the assembly body 630a with the lower shell 202, and the first assembly protrusion 6312 is configured to limit the movement of the assembly body 630a. For example, the thickness of the first assembly post 6311 is less than the thickness of the assembly body 630a, so as to ensure a connection strength between the first assembly post 6311 and the assembly body 630a.

In some embodiments, one end of the first assembly protrusion 6312 is provided with a first limiting surface 6314, and the other end of the first assembly protrusion 6312 is provided with a first assembly inclined surface 6315; and the bottom of the first limiting surface 6314 is connected to the first assembly post 6311, and the first assembly inclined surface 6315 is inclined toward the other end of the first assembly post 6311. The first limiting surface 6314 facilitates the limiting connection of the first assembly protrusion 6312 to the lower shell 202; and the first assembly inclined surface 6315 has an assembly guiding function, which facilitates the assembly connection of the first assembly post 6311 with the lower shell 202.

In some embodiments, the first assembly component 631 further includes a second assembly post 6313, the second assembly post 6313 extends along the x-axis direction, and a side of the second assembly post 6313 is connected to the side of the assembly body 630a; and a first gap 6316 is provided between the second assembly post 6313 and the first assembly post 6311. The second assembly post 6313 is configured to implement the assembly connection of the assembly body 630a with the lower shell 202; and the first gap 6316 is configured to provide a deformation space for the first assembly protrusion 6312 when the first assembly protrusion 6312 is in assembly connection with the lower shell 202.

In some embodiments, a first notch 6301 is formed on the side of the assembly body 630a, the first notch 6301 is located at a side of the first assembly protrusion 6312, and the first notch 6301 is in communication with the first gap 6316. The first notch 6301 cooperates with the first gap 6316 to provide a sufficient deformation space for the first assembly protrusion 6312, which facilitates the assembly connection of the first assembly component 631 to the lower shell 202.

In some embodiments, a second assembly inclined surface 6317 is provided at a top of the second assembly post 6313, and the second assembly inclined surface 6317 is located at one end of the second assembly post 6313 away from the first gap 6316, and the second assembly inclined surface 6317 is inclined toward the other end of the second assembly post 6313. The second assembly inclined surface 6317 has an assembly guiding function, which facilitates the assembly connection of the second assembly post 6313 to the lower shell 202.

In some embodiments, the second assembly component 632 includes a third assembly post 6321, the third assembly post 6321 extends along the x-axis direction, and a side of the third assembly post 6321 is connected to the other side of the assembly body 630a; a second assembly protrusion 6322 is provided on the third assembly post 6321, and the second assembly protrusion 6322 is a protrusion formed by the top of the third assembly post 6321 protruding outward. The third assembly post 6321 is configured to implement the assembly connection of the assembly body 630a and the lower shell 202, and the second assembly protrusion 6322 is configured to limit the movement of the assembly body 630a. For example, the thickness of the third assembly post 6321 is less than the thickness of the assembly body 630a, so as to ensure a connection strength between the third assembly post 6321 and the assembly body 630a.

In some embodiments, one end of the second assembly protrusion 6322 is provided with a second limiting surface 6324, and the other end of the second assembly protrusion 6322 is provided with a third assembly inclined surface 6325; and the bottom of the second limiting surface 6324 is connected to the third assembly post 6321, and the third assembly inclined surface 6325 is inclined toward the other end of the third assembly post 6321. The second limiting surface 6324 facilitates the limiting connection of the second assembly protrusion 6322 to the lower shell 202; and the third assembly inclined surface 6325 has an assembly guiding function, which facilitates the assembly connection of the third assembly post 6311 to the lower shell 202.

In some embodiments, the second assembly component 632 further includes a fourth assembly post 6323, the fourth assembly post 6323 extends along the x-axis direction, and a side of the fourth assembly post 6323 is connected to the other side of the assembly body 630a; and a second gap 6326 is provided between the fourth assembly post 6323 and the third assembly post 6321. The fourth assembly post 6323 is configured to implement the assembly connection of the assembly body 630a with the lower shell 202; and the second gap 6326 is configured to provide a deformation space for the second assembly protrusion 6322 when the second assembly protrusion 6322 is in assembly connection with the lower shell 202.

In some embodiments, a second notch 6302 is formed on the other side of the assembly body 630a, the second notch 6302 is located at a side of the second assembly protrusion 6322, and the second notch 6302 is in communication with the second gap 6326. The second notch 6302 cooperates with the second gap 6326 to provide a sufficient deformation space for the second assembly protrusion 6322, which facilitates the assembly connection of the second assembly component 632 to the lower shell 202.

In some embodiments, a fourth assembly inclined surface 6327 is provided at a top of the fourth assembly post 6323, and the fourth assembly inclined surface 6327 is located at one end of the fourth assembly post 6323 away from the second gap 6326, and the fourth assembly inclined surface 6327 is inclined toward the other end of the fourth assembly post 6323. The fourth assembly inclined surface 6327 has an assembly guiding function, which facilitates the assembly connection of the fourth assembly post 6323 to the lower shell 202.

In some embodiments, a mounting hole 633 is provided in a top of the assembly body 630a, and an accommodating slot 636 is provided in a bottom of the assembly body 630a, the mounting hole 633 is located above the accommodating slot 636, and the mounting hole 633 is in communication with the accommodating slot 636. A recovery member is provided in the accommodating slot 636, and configured to assist the unlocking component 600 in returning to an initial position.

In some examples, the recovery member may include a spring 650. For example, a second limiting block 634 is provided on a side wall of the accommodating slot 636, the second limiting block 634 is located below the mounting hole 633, and an end of the spring 650 is connected to the second limiting block 634. The spring 650 is installed from the mounting hole 633, and the end thereof is sleeved on the second limiting block 634.

In some examples, the recovery member may include but is not limited to a sponge column, or any one of two same-polarity magnets facing each other.

In some embodiments, one end of the accommodating slot 636 is open, which can meet the assembly requirement of the spring 650 and adapt to the small dimension requirement of the assembly body 630a. Of course, in some embodiments, one end of the accommodating slot 636 may also be closed.

In some embodiments, the thickness of the assembly body 630a is greater than the thickness of the connecting portion 620, and the top of one end of the assembly body 630a is connected to the connecting portion 620, which facilitates the provision of the first assembly component 631 and the second assembly component 632 on the assembly body 630a. A reinforcing rib 637 is provided at one end of the assembly body 630a, the reinforcing rib 637 is connected to the assembly body 630a and the bottom surface of the connecting portion 620, and the reinforcing rib 637 is configured to increase the connection strength between the assembly body 630a and the connecting portion 620, and reduce the risk of fracture at the connection between the assembly body 630a and the connecting portion 620 caused by bending or pulling the connecting portion 620. For example, a plurality of reinforcing ribs 637 are provided on the assembly body 630a, such as four reinforcing ribs.

In some embodiments, the bottom of the other end of the assembly body 630a is connected to one end of the unlocking portion 640, and the thickness of the assembly body 630a is greater than the thickness of the other end of the unlocking portion 640. The other end of the assembly body 630a is provided with a transition surface 635, the transition surface 635 is an inclined surface, and the transition surface 635 extends from the assembly body 630a toward the direction of the unlocking portion 640, such that the thickness of the other end of the assembly body 630a gradually decreases in the direction close to the unlocking portion 640.

In some embodiments, the unlocking portion 640 includes an unlocking body 641 and an unlocking support body 640a, one end of the unlocking body 641 is connected to the assembly body 630a, and the other end of the unlocking body 641 is connected to the unlocking support body 640a. The thickness of the unlocking support body 640a is greater than the thickness of the unlocking body 641, where the unlocking body 641 is configured to connect to the assembly body 630a and the unlocking support body 640a, and the unlocking support body 640a is configured to support the unlocking clamping component.

In some embodiments, the width of the unlocking body 641 is less than the width of the assembly body 630a, which facilitates the reduction of the overall dimension of the unlocking portion 640 and then reduces the space occupied by the assembly of the unlocking portion 640.

In some embodiments, the unlocking support body 640a includes a first support body 643 and a second support body 644, where one end of the first support body 643 and one end of the second support body 644 are respectively connected to the unlocking body 641; a notch 642 is formed between the first support body 643 and the second support body 644, and the notch 642 is cooperatively connected to the clamping component. For example, the clamping component is located within the notch 642, such that the first support body 643 is located on one side of the clamping component, and the second support body 644 is located on the other side of the clamping component. The thickness of the other end of the first support body 643 (one end away from the unlocking body 641) is greater than the thickness of one end of the first support body 643, and the thickness of the other end of the second support body 644 (one end away from the unlocking body 641) is greater than the thickness of one end of the second support body 644.

In some embodiments, the first support body 643 includes a first extension surface 6431, where one end of the first extension surface 6431 is connected to the bottom surface of the unlocking body 641, and the first extension surface 6431 extends along a direction away from the unlocking body 641 to increase the thickness of the first support body 643 from the bottom thereof.

In some embodiments, the first support body 643 further includes a second extension surface 6432, where one end of the second extension surface 6432 is connected to the top surface of the unlocking body 641, and the second extension surface 6432 extends along a direction away from the unlocking body 641 to increase the thickness of the first support body 643 from the top thereof. For example, the bottom of the first support body 643 protrudes from the bottom surface of the unlocking body 641 by a height H1, the top of the first support body 643 protrudes from the top surface of the unlocking body 641 by a height H2, and the extension height of the second extension surface 6432 is less than the extension height of the first extension surface 6431, such that H1>H2.

In some embodiments, the second support body 644 includes a third extension surface 6441, where one end of the third extension surface 6441 is connected to the bottom surface of the unlocking body 641, and the third extension surface 6441 extends along a direction away from the unlocking body 641 to increase the thickness of the second support body 644 from the bottom thereof.

In some embodiments, the second support body 644 further includes a fourth extension surface 6442, where one end of the fourth extension surface 6442 is connected to the top surface of the unlocking body 641, and the fourth extension surface 6442 extends along a direction away from the unlocking body 641 to increase the thickness of the second support body 644 from the top thereof. The specific configuration of the third extension surface 6441 and the fourth extension surface 6442 on the second support body 644 may refer to that of the first extension surface 6431 and the second extension surface 6432 on the first support body 643.

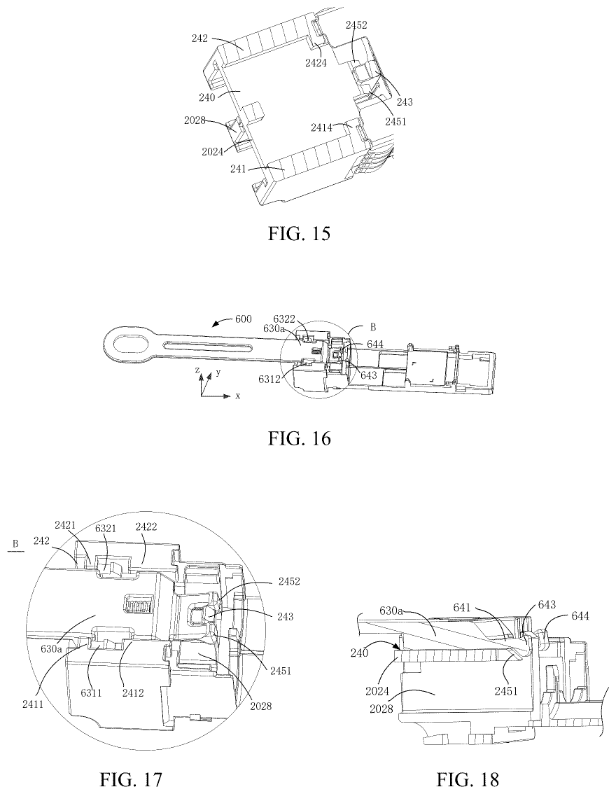

FIG. 12 is a schematic structural diagram of a lower shell according to some embodiments of the present disclosure; FIG. 13 is a first partial schematic diagram of a lower shell according to some embodiments of the present disclosure; FIG. 14 is a second partial schematic diagram of a lower shell according to some embodiments of the present disclosure; FIG. 15 is a third partial schematic diagram of a lower shell according to some embodiments of the present disclosure; and FIG. 12 to FIG. 15 illustrate a detailed structure of a lower shell.

In some embodiments, one end of the lower shell 202 is provided with a support plate 2024, the support plate 2024 is connected to a first lower side plate 2022 and a second lower side plate 2023; and the support plate 2024, the first lower side plate 2022, and the second lower side plate 2023 together enclose the optical port of the optical module 200. A support surface 240 is provided at the top of the support plate 2024, and a clamping component 243 is provided at the end of the support plate 2024. The clamping component 243 protrudes from the support surface 240, and an unlocking surface 245 is provided at the side of the clamping component 243, where the unlocking surface 245 is lower than the top surface of the clamping component 243. The unlocking surface 245 is configured to abut against the unlocking portion 640, where the unlocking surface 245 is configured to assist the unlocking component 600 in changing the connection relationship between the clamping component 243 and the cage 106. For example, the clamping component 243 is a clamping protrusion, and an inclined surface is provided on the clamping protrusion; the inclined surface guides the assembly of the optical module 200 with the cage 106, and the clamping protrusion is in assembly connection with the cage 106 to implement locking between the optical module 200 and the cage 106.

In some embodiments, a partition plate 2028 is further provided at the optical port of the optical module 200, where the partition plate 2028 extends along the x-axis direction, the bottom of the partition plate 2028 is connected to the bottom plate 2021, and the top of the partition plate 2028 is connected to the support plate 2024. For example, the clamping component 243 is located above the partition plate 2028, and the partition plate 2028 supports the clamping component 243, which facilitates increasing the support strength of the clamping component 243.

In some embodiments, the unlocking surface 245 is an inclined surface, and inclines from the direction of the optical port of the optical module 200 toward the direction of the electrical port of the optical module 200. When the unlocking component 600 is pulled, the unlocking surface 245 is configured to lift up the end of the unlocking portion 640, such that the unlocking portion 640 pushes up the locking spring tab on the cage 106. For example, the unlocking surface 245 includes a first unlocking surface 2451 and a second unlocking surface 2452, where the first unlocking surface 2451 is located on one side of the clamping component 243, and the second unlocking surface 2452 is located on the other side of the clamping component 243.

In some embodiments, a side of the first unlocking surface 2451 is connected to a side surface of the partition plate 2028, and a side of the second unlocking surface 2452 is connected to the side surface of the partition plate 2028, so as to increase the support strength of the first unlocking surface 2451 and the second unlocking surface 2452 through the partition plate 2028.

In some embodiments, a locking surface 244 is further provided at the top of the other end of the support plate 2024, where the locking surface 244 is located on one side of the clamping component 243 close to the lower shell 202 and away from the electrical port, and a position of the locking surface 244 is higher than a position of the support surface 240. The locking surface 244 is configured to support the locking spring tab on the cage 106. When the unlocking component 600 is pulled, the locking surface 244 facilitates the separation of the cage 106 from the clamping component 243.

In some embodiments, an assembly mechanism is provided on the support surface 240, where the assembly mechanism is configured to implement the assembly connection of the unlocking component 600. The assembly mechanism and the support plate 2024 form an assembly cavity, the assembly portion 630 is in assembly connection with the assembly cavity, and the assembly mechanism can be configured to both fix the unlocking component 600 to the lower shell 202 and enable the unlocking component 600 to move relative to the assembly mechanism with the assembly portion 630 as the center.

In some embodiments, the assembly mechanism includes a first baffle 241 and a second baffle 242, where a bottom of the first baffle 241 is connected to an edge of one side of the support surface 240, and a bottom of the second baffle 242 is connected to an edge of the other side of the support surface 240. A first limiting assembly is provided on one side of the first baffle 241 facing the second baffle 242, and the first baffle 241, the first limiting assembly, and the support surface 240 form a first assembly cavity; a second limiting assembly is provided on one side of the second baffle 242 facing the first baffle 241, and the second baffle 242, the second limiting assembly, and the support surface 240 form a second assembly cavity. The first assembly cavity and the second assembly cavity are configured to implement the assembly connection of the assembly portion 630, such that both sides of the assembly portion 630 are in assembly connection with the lower shell 202, ensuring the firmness of the assembly connection between the assembly portion 630 and the lower shell 202. The first limiting assembly and the second limiting assembly respectively include limiting posts, where the limiting posts are configured to implement limiting connection of the assembly portion 630, such that the assembly portion 630 can move relative to the lower shell 202 within a preset range.

In some embodiments, the first limiting assembly includes a first limiting plate 2411 and a second limiting plate 2412, wherein the sides of the first limiting plate 2411 and the second limiting plate 2412 are respectively connected to the first baffle 241, and the first limiting plate 2411, the second limiting plate 2412, the first baffle 241, and the support surface 240 together form a first assembly cavity 2410. A first limiting hole 2413 is provided between the first limiting plate 2411 and the second limiting plate 2412, where the first limiting hole 2413 is configured to implement limiting connection of the first assembly protrusion 6312. For example, the first limiting plate 2411 is provided at one end or on a side close to one end of the first baffle 241.

In some embodiments, the first limiting assembly further includes a third limiting plate 2414, wherein the third limiting plate 2414 is provided at the other end of the first baffle 241, the bottom of the third limiting plate 2414 is connected to the support surface 240, and the first limiting plate 2411, the second limiting plate 2412, the third limiting plate 2414, the first baffle 241, and the support surface 240 together form the first assembly cavity 2410. The third limiting plate 2414 is configured to limit the second assembly post 6313, so as to implement limiting connection of the assembly portion 630 to the first assembly cavity at multiple positions.

In some embodiments, the second limiting assembly includes a fourth limiting plate 2421 and a fifth limiting plate 2422, where sides of the fourth limiting plate 2421 and the fifth limiting plate 2422 are respectively connected to the second baffle 242, and the fourth limiting plate 2421, the fifth limiting plate 2422, the second baffle 242, and the support surface 240 together form the second assembly cavity 2420. A second limiting hole 2423 is provided between the fourth limiting plate 2421 and the fifth limiting plate 2422, where the second limiting hole 2423 is configured to implement limiting connection of the second assembly protrusion 6312. For example, the fourth limiting plate 2421 is provided at one end or on a side close to one end of the second baffle 242.

In some embodiments, the second limiting assembly further includes a sixth limiting plate 2424, where the sixth limiting plate 2424 is provided at the other end of the second baffle 242, the bottom of the sixth limiting plate 2424 is connected to the support surface 240, and the fourth limiting plate 2421, the fifth limiting plate 2422, the sixth limiting plate 2424, the second baffle 242, and the support surface 240 together form the second assembly cavity 2420. The sixth limiting plate 2424 is configured to limit the fourth assembly post 6323, so as to implement limiting connection of the assembly portion 630 to the second assembly cavity at multiple positions.

In some embodiments, a first limiting block 246 is further provided on the support surface 240, where the first limiting block 246 is located within the accommodating slot 636 and is configured to implement limiting connection of the spring 650.

In some embodiments, a first support boss 2025 and a second support boss 2026 are provided on the lower shell 202, where the first support boss 2025 and the second support boss 2026 are located at the side below the support plate 2024, the bottoms of the first support boss 2025 and the second support boss 2026 are respectively connected to the bottom plate 2021, the first support boss 2025 is configured to implement supporting connection of the first optical fiber adapter 410, and the second support boss 2026 is configured to support the second optical fiber adapter 510.

In some embodiments, an assembly slot 2027 is provided in the inner side wall of the lower shell 202, where the assembly slot 2027 is distributed in the inner side wall of the first lower side plate 2022 and the inner side wall of the second lower side plate 2023, and the assembly slot 2027 is located between the first support boss 2025 and the support plate 2024. The assembly slot 2027 is configured to implement the assembly connection of the shielding sheet, where the shielding sheet is configured to implement electromagnetic shielding at the optical port of the optical module 200.

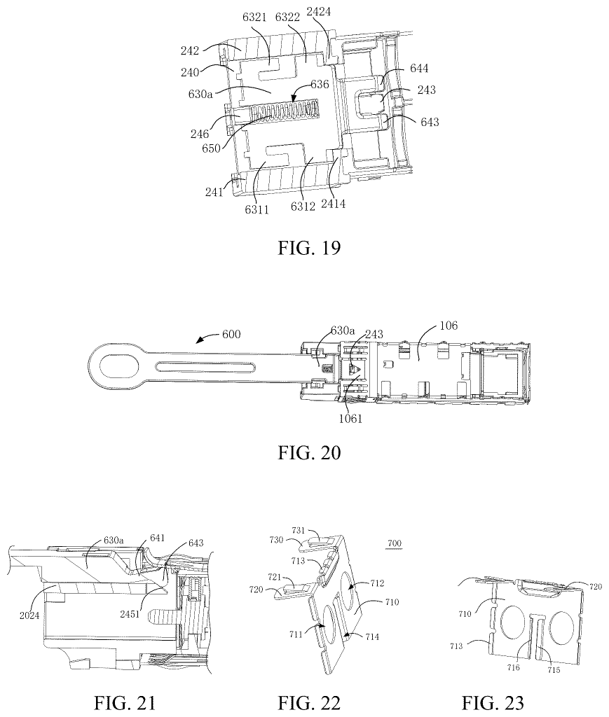

FIG. 16 is a schematic assembly diagram of a lower shell and an unlocking component according to some embodiments of the present disclosure; FIG. 17 is a partial enlarged view at B in FIG. 16; FIG. 18 is a first partial schematic diagram of an optical module according to some embodiments of the present disclosure; and FIG. 19 is a second partial schematic diagram of an optical module according to some embodiments of the present disclosure. FIG. 18 illustrates an assembly form of the assembly portion 630 and the unlocking portion 640 with the lower shell 202 when the unlocking component 600 is in an initial state thereof.

As shown in FIG. 16 to FIG. 19, along the x direction, the unlocking component 600 is assembled to the lower shell 202, such that the second assembly post 6313 and the first assembly post 6311 are assembled into the first assembly cavity 2410, the fourth assembly post 6323 and the third assembly post 6321 are assembled into the second assembly cavity 2420, the first assembly protrusion 6312 is located in the first limiting hole 2413 and the second assembly protrusion 6322 is located in the second limiting hole 2423. The first assembly cavity 2410 and the second assembly cavity 2420 cooperate to assemble the assembly body 630a onto the support plate 2024, such that the support surface 240 supports the bottom of the assembly body 630a, the first baffle 241 and the second baffle 242 are used to fix the assembly body 630a in the y-axis direction; the first limiting plate 2411, the second limiting plate 2412, the fourth limiting plate 2421, and the fifth limiting plate 2422 are used to fix the assembly body 630a in the z-axis direction, and the first limiting hole 2413 and the second limiting hole 2423 are used to enable the assembly body 630a to move back and forth along the x-axis direction within a preset range. The third limiting plate 2414 and the sixth limiting plate 2424 are used to limit the maximum rightward movement position of the assembly body 630a along the x-axis, and right side surfaces of the first limiting plate 2411 and the fourth limiting plate 2421 are used to limit the maximum leftward movement position of the assembly body 630a along the x-axis.

The spring 650 is loaded into the accommodating slot 636 from the mounting hole 633, one end of the spring 650 abuts against the first limiting block 246, and the other end of the spring 650 is embedded into the second limiting block 634. In some embodiments, the spring 650 is always in a compressed state, such that the spring 650 applies the pushing force to the assembly body 630a.

FIG. 20 is a schematic assembly diagram of an optical module and a cage according to some embodiments of the present disclosure; and FIG. 21 is a third partial schematic diagram of an optical module according to some embodiments of the present disclosure. FIG. 21 illustrates an assembly form of the assembly portion 630 and the unlocking portion 640 with the lower shell 202 when the unlocking component 600 unlocks the optical module and the cage 106. As shown in FIG. 20 and FIG. 21, when the optical module 200 is fixedly connected to the cage 106, the locking spring tab 1061 on the cage 106 is clamped onto the clamping component 243, and the locking spring tab 1061 is located above the unlocking portion 640. When it is necessary to release the connection between the optical module 200 and the cage 106, the gripping portion 610 is pulled to enable the unlocking component 600 as a whole to move in the opposite direction of the x-axis, the assembly portion 630 drives the unlocking portion 640 to move, the first unlocking surface 2451 is in contact with the first support body 643 and lifts up the first support body 643 as the unlocking portion 640 moves, and the second unlocking surface 2452 is in contact with the second support body 644 and lifts up the second support body 644 as the unlocking portion 640 moves. The unlocking body 641 is bent, and the first support body 643 and the second support body 644 support the locking spring tab 1061. When the first support body 643 and the second support body 644 are lifted up to a certain extent, the first support body 643 and the second support body 644 directly push up the locking spring tab 1061, thereby releasing the clamping relationship between the locking spring tab 1061 and the clamping component 243, and releasing the connection between the optical module 200 and the cage 106.

FIG. 22 is a first schematic structural diagram of a shielding sheet according to some embodiments of the present disclosure; and FIG. 23 is a second schematic structural diagram of a shielding sheet according to some embodiments of the present disclosure. As shown in FIGS. 22 and 23, the shielding sheet 700 includes a shielding sheet body 710, a first pressing portion 720, and a second pressing portion 730; the first pressing portion 720 and the second pressing portion 730 are respectively connected to the top of the shielding sheet body 710. There is a gap between the first pressing portion 720 and the second pressing portion 730. The shielding sheet 700 is assembled at the optical port of the optical module 200, where the shielding sheet body 710 is configured to connect the optical emission component 400 and the optical reception component 500, the upper shell 201 is in pressing contact with the first pressing portion 720 and the second pressing portion 730 to fix the shielding sheet 700, such that the shielding sheet 700 electromagnetically shields the optical port of the optical module 200, to reduce ingress and egress of electromagnetic radiation through the optical port of the optical module 200.

The shielding sheet body 710 is provided with a first through hole 711 and a second through hole 712, and an elastic bend 713 is provided on a side of the shielding sheet body 710. For example, a plurality of elastic bends 713 are respectively provided at the top, left edge, and right edge of the shielding sheet body 710. The first through hole 711 is configured to implement the assembly connection of the first optical fiber adapter 410, and the second through hole 712 is configured to implement the assembly connection of the second optical fiber adapter 510. The elastic bend 713 and the first pressing portion 720 are located on the same side of the shielding sheet body 710.

The first pressing spring tab 721 is provided on the first pressing portion 720, where the first pressing spring tab 721 is raised in a direction away from the shielding sheet body 710; the first pressing spring tab 721 is configured to increase the pressing elasticity of the first pressing portion 720, thereby facilitating the application of force by the upper shell 201 onto the first pressing portion 720. The second pressing spring tab 731 is provided on the second pressing portion 730, where the second pressing spring tab 731 is raised in a direction away from the shielding sheet body 710; the second pressing spring tab 731 is configured to increase the pressing elasticity of the second pressing portion 730, thereby facilitating the application of force by the upper shell 201 onto the second pressing portion 730.

In some embodiments, a middle seam 714 is formed between the first through hole 711 and the second through hole 712, where the middle seam 714 is provided with a first bend 715 and a second bend 716. The first bend 715 and the second bend 716 are located on a same side of the shielding sheet body 710 as the elastic bend 713.

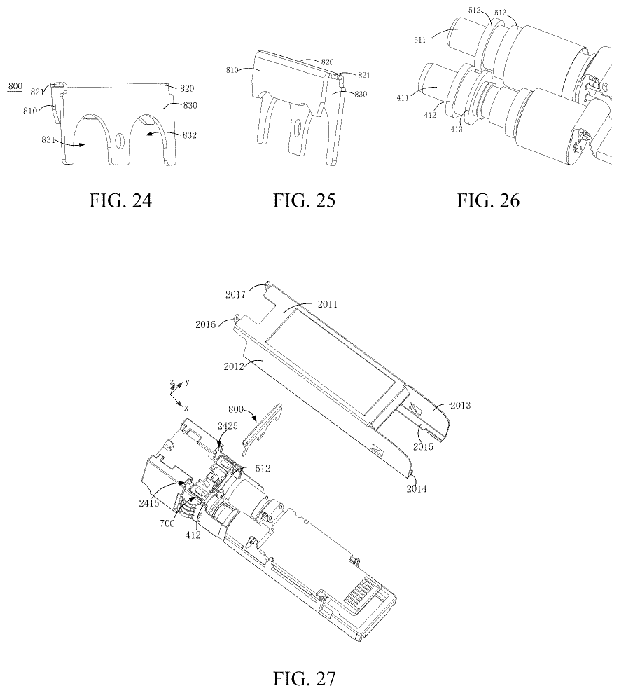

FIG. 24 is a first schematic structural diagram of a fixing sheet according to some embodiments of the present disclosure; and FIG. 25 is a second schematic structural diagram of a fixing sheet according to some embodiments of the present disclosure. As shown in FIG. 24 and FIG. 25, the fixing sheet 800 includes a first fixing portion 810, a bridging portion 820, and a second fixing portion 830, where one end of the bridging portion 820 is connected to a top of the first fixing portion 810, and the other end of the bridging portion 820 is connected to a top of the second fixing portion 830. A second surface of the first fixing portion 810 faces a first surface of the second fixing portion 830, a first surface of the first fixing portion 810 faces away from the second fixing portion 830, and a second surface of the second fixing portion 830 faces away from the first fixing portion 810. In some embodiments, the first fixing portion 810 and the second fixing portion 830 are parallel or approximately parallel, and a third gap is formed between the first fixing portion 810 and the second fixing portion 830. The first fixing portion 810 and the second fixing portion 830 are configured to implement pressing fixation of the first optical fiber adapter 410 and the second optical fiber adapter 510, and the upper shell 201 is in pressing contact with the bridging portion 820. Opposing forces are applied to the first fixing portion 810 and the second fixing portion 830, such that the first fixing portion 810 and the second fixing portion 830 can be brought closer together, reducing a third gap; and the first fixing portion 810 and the second fixing portion 830 generate reaction forces away from each other.

In some embodiments, the second fixing portion 830 is provided with a first assembly notch 831 and a second assembly notch 832, the first assembly notch 831 is configured to implement the assembly connection of the first optical fiber adapter 410, and the second assembly notch 832 is configured to implement the assembly connection of the second optical fiber adapter 510.

In some embodiments, the dimension of the first fixing portion 810 is smaller than the dimension of the second fixing portion 830, which facilitates saving the material of the fixing sheet 800 on the basis of ensuring the strength requirement for the fixing sheet 800 to implement assembly connection of the first optical fiber adapter 410 and the second optical fiber adapter 510, and also facilitates assembly indication. In some embodiments, support portions 821 are respectively provided at both side edges of the bridging portion 820, and the lower shell 202 is in supporting connection with the support portions 821.

FIG. 26 is a schematic diagram of an internal structure of an optical module according to some embodiments of the present disclosure. As shown in FIG. 26, the first optical fiber adapter 410 includes a first optical fiber adapter body 411, and a first stop boss 412 and a second stop boss 413 that are provided on the first optical fiber adapter body 411, where a first gap is formed between the first stop boss 412 and the second stop boss 413. The second optical fiber adapter 420 includes a second optical fiber adapter body 511 and a third stop boss 512 and a fourth stop boss 513 provided on the second optical fiber adapter body 511, where a fourth gap is formed between the third stop boss 512 and the fourth stop boss 513.

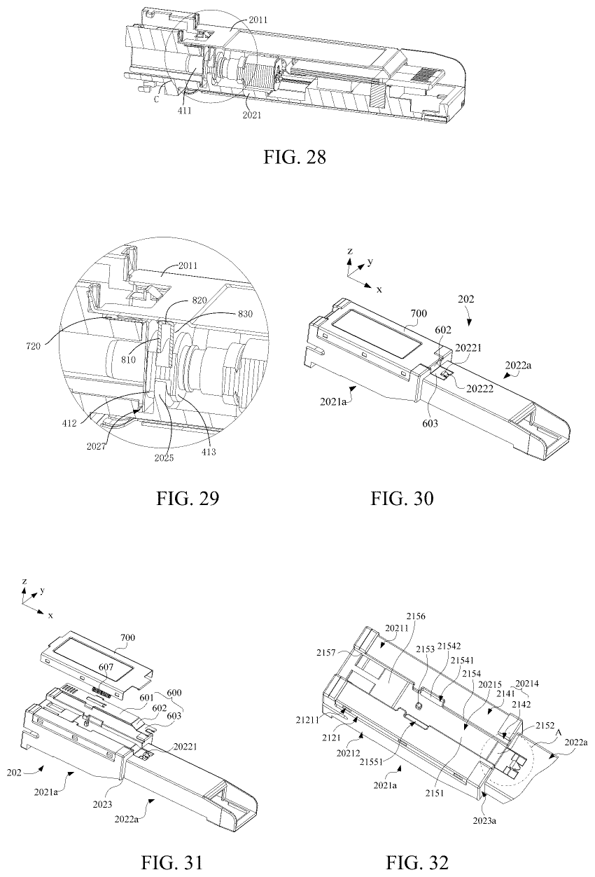

FIG. 27 is an exploded schematic diagram of another optical module according to some embodiments of the present disclosure; FIG. 28 is a cross-sectional view of an optical module according to some embodiments of the present disclosure; and FIG. 28 is a partial enlarged view at P in FIG. 27. As shown in FIG. 27 to FIG. 29, both sides of the shielding sheet 700 are located within the assembly slot 2027, the first optical fiber adapter body 411 is embedded into the first through hole 711, and the second optical fiber adapter body 511 is embedded into the second through hole 712. The elastic bends 713 at left and right side edges of the shielding sheet body 710 press against the side wall of the assembly slot 2027, such that the side surface of the shielding sheet body 710 abuts against the side surfaces of the first stop boss 412 and the third stop boss 512, increasing a pressing contact force among the shielding sheet body 710 and the first stop boss 412 and the third stop boss 512. Furthermore, when the upper shell 201 is mounted onto the lower shell 202 in the direction opposite to the x-axis, the upper shell 201 presses the elastic bends 713 at the top of the shielding sheet body 710, the first pressing portion 720, and the second pressing portion 730, such that the shielding sheet body 710 is in sufficient contact with the first stop boss 412, the third stop boss 512, the upper shell 201, and the lower shell 202, ensuring the shielding effect of the shielding sheet 700.

In some embodiments, the upper shell 201 further includes a third upper side plate 2014 and a fourth upper side plate 2015, a side edge of the third upper side plate 2014 is connected to a lower part of the first upper side plate 2012b, a side edge of the fourth upper side plate 2015 is connected to a lower part of the second upper side plate 2013b, and the third upper side plate 2014 and the fourth upper side plate 2015 are located below the cover plate 2011. When the upper shell 201 is in assembly connection with the lower shell 202, the third upper side plate 2014 and the fourth upper side plate 2015 are in contact with the bottom surface of the bottom plate 2021.

In some embodiments, one end of the cover plate 2011 is provided with a first connecting base 2016 and a second connecting base 2017, the lower shell 202 is provided with a first mounting slot 2415 and a second mounting slot 2425, the first connecting base 2016 is connected to the first mounting slot 2415 by a screw, and the second connecting base 2017 is connected to the second mounting slot 2425 by a screw. For example, an outer end of the first baffle plate 241 and an outer end of the third limiting plate 2414 are provided with the first mounting slot 2415, and an outer end of the second baffle plate 242 and an outer end of the sixth limiting plate 2424 are provided with the second mounting slot 2425.

The first support boss 2025 supports the first optical fiber adapter body 411, and the second support boss 2026 supports the second optical fiber adapter body 511; the first assembly notch 831 is in assembly connection with the first optical fiber adapter body 411, the second assembly notch 832 is in assembly connection with the second optical fiber adapter body 511, the first fixing portion 810 presses the first optical fiber adapter body 411 and the second optical fiber adapter body 511, and the second fixing portion 830 presses the first optical fiber adapter body 411 and the second optical fiber adapter body 511. In some embodiments, the first surface of the first fixing portion 810 is in pressing contact with the side surfaces of the first stop boss 412 and the third stop boss 512, and the second surface of the second fixing portion 830 is in pressing contact with the second stop boss 413 and the fourth stop boss 513, such that the fixing sheet 800 is embedded within the first gap and the second gap, more securely fixing the first optical fiber adapter 410 and the second optical fiber adapter 510, and preventing the first optical fiber adapter 410 and the second optical fiber adapter 510 from shaking or moving within the shell.

FIG. 30 is a schematic structural diagram of cooperation between an unlocking component and a lower shell in an optical module according to an embodiment of the present disclosure; and FIG. 31 is an exploded schematic structural diagram of cooperation between an unlocking component and a lower shell in an optical module according to an embodiment of the present disclosure. Referring to FIG. 30 and FIG. 31, to facilitate mounting the optical transceiver component and the circuit board and to improve the compactness of the optical module structure, in some examples of the embodiments of the present disclosure, the lower shell 202 includes: a first wall surface 2021a and a second wall surface 2022a. The second wall surface 2022a is connected to one end of the first wall surface 2021a and is recessed relative to the first wall surface 2021a. In the embodiments of the present disclosure, the locking portion 20221 (in some examples, also referred to as a clamping component) may be provided on the second wall surface 2022a.

In some examples, it may also be understood that the first wall surface 2021a protrudes outward relative to the second wall surface 2022a, that is, one end of the lower shell 202 is thicker than the other end thereof; thus, the optical transceiver component can be provided at a thicker end thereof, for example, on the inner side of the first wall surface 2021a, while the circuit board is thinner and occupies less space, and can be provided on the inner side of the second wall surface 2022a; thus, the circuit board in the optical module has a compact structure within the shell; when the circuit board is connected to the host computer, the second wall surface 2022a may be inserted into the host computer, thereby occupying relatively less space in the host computer.

In some optional examples of the embodiments of the present disclosure, the first wall surface 2021a and the second wall surface 2022a may be integrally formed, for example, by integral casting. The locking portion 20221 may be a protruding portion on the second wall surface 2022a, and in some examples, the locking portion 20221 and the second wall surface 2022a may also be integrally formed. As an optional example, a side of the locking portion 20221 facing away from the first wall surface 2021a (that is, when the optical module is inserted into the host computer, the locking portion 20221 faces one side of the host computer) may be an inclined wall 20222, which facilitates the locking structure on the host computer to pass over the locking portion 20221 and to be clamped onto one side of the locking portion 20221 facing the first wall surface 2021a, improving the smoothness of inserting the optical module into the host computer.

In some examples of the embodiments of the present disclosure, the unlocking component 600 may be movably provided on the lower shell 202 along the length direction thereof (for example, the direction indicated by the x-axis in FIG. 6), and the unlocking component 600 extends from the first wall surface 2021a to the second wall surface 2022a. In some examples, the unlocking component 600 may be a sheet metal component, that is, the unlocking component 600 may also be made of metal material. In the embodiments of the present disclosure, the unlocking component 600 includes a body 601 (in some examples, the connecting portion may include the body 601), an ejector member 602 (in some examples, the assembly portion may include the ejector member 602), and a force applying member 603 (in some examples, the unlocking portion may include the force applying member 603).

In some examples, the body 601 may be provided on the first wall surface 2021a. In some optional examples, a limiting slot may be provided in the first wall surface 2021a along a length direction, and the body 601 is provided within the limiting slot and moves along the limiting slot. In other examples, a limiting rib may also be provided on the first wall surface 2021a along the length direction, and two limiting ribs may be provided, and spaced apart along the width direction of the lower shell 202 (for example, a direction indicated by the y-axis in FIG. 6); and the body 601 may be provided in the gap between the two limiting ribs and move along the slot defined by the two limiting ribs.

In some examples of the embodiments of the present disclosure, the ejector member 602 is connected to one end of the body 601 facing the second wall surface 2022a, and the ejector member 602 is inclined relative to the body 601 toward the second wall surface 2022a. The ejector member 602 may extend from an end of the body 601 toward the second wall surface 2022a and extends along a height direction of the lower shell 202 (for example, a negative direction indicated by the z-axis as shown in FIG. 6), such that the ejector member 602 is inclined relative to the body 601. It can be understood that in some examples of the embodiments of the present disclosure, the unlocking component 600 may be a sheet metal component. Thus, in some examples, the ejector member 602 may be formed by bending the end of the unlocking component 600 facing the second wall surface 2022a, that is, the ejector member 602 and the body 601 may be of an integral structure. This facilitates manufacturing the unlocking component 600 and saves the manufacturing cost of the unlocking component 600.

In some examples, the body 601, the ejector member 602, and the force applying member 603 are integrally formed, where the force applying member 603 may be formed by bending one end of the ejector member 602 facing the second wall surface 2022a. In other words, in the embodiments of the present disclosure, the body 601 and the force applying member 603 may be two parallel parts, and the ejector member 602 is an inclined wall surface connected between the body 601 and the force applying member 603.

To limit the unlocking component 600 on the lower shell 202, the optical module provided in the embodiments of the present disclosure further includes an outer cover plate 700 (in some examples, the assembly mechanism may include the outer cover plate 700), the outer cover plate 700 covers the first wall surface 2021a and is located on the side of the unlocking component 600 facing away from the lower shell 202; for example, the outer cover plate 700 may cover the lower side wall of the lower shell 202.

In some embodiments of the present disclosure, a movable gap for the unlocking component 600 to move is provided between the outer cover plate 700 and the lower shell 202. In some examples, the movable gap may be a distance between the outer cover plate 700 and the bottom wall of the limiting slot, that is, the unlocking component 600 moves between the bottom wall of the limiting slot and the inner wall of the outer cover plate 700.

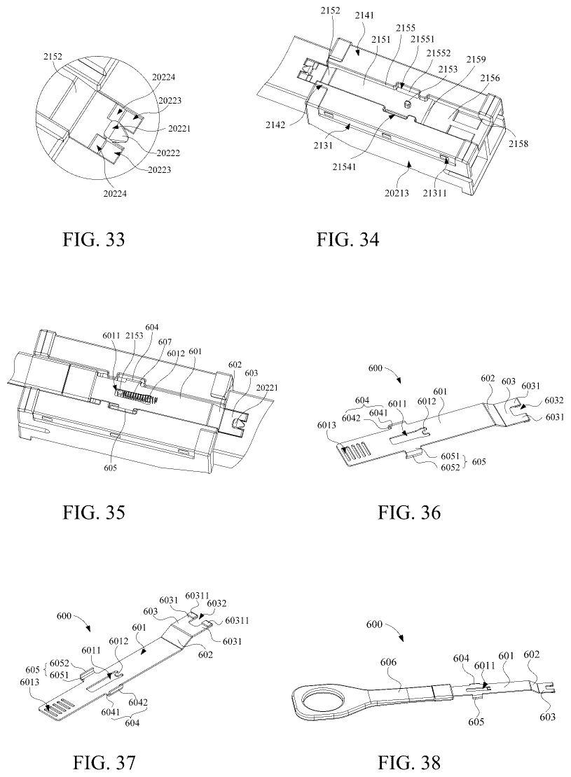

FIG. 32 is a schematic structural diagram of a lower shell in an optical module according to an embodiment of the present disclosure; FIG. 33 is a partial enlarged view at A in FIG. 32; FIG. 34 is another schematic structural diagram of a lower shell in an optical module according to an embodiment of the present disclosure; and FIG. 35 is a schematic structural diagram of cooperation between a lower shell and an unlocking component in an optical module according to an embodiment of the present disclosure. Referring to FIG. 32 to 35, in some examples of the embodiments of the present disclosure, the lower shell 202 further includes a third wall surface 2023a, the third wall surface 2023a is connected between the first wall surface 2021a and the second wall surface 2022a, and the third wall surface 2023a is configured to abut against the shell of the host computer. In some embodiments, the third wall surface 2023a may be a stepped surface between the first wall surface 2021a and the second wall surface 2022a.

In some examples, the first wall surface 2021a includes a first bottom plate 20211, a first side plate 20212, and a second side plate 20213, the first side plate 20212 and the second side plate 20213 are oppositely arranged on both sides of the first bottom plate 20211. In some embodiments of the present disclosure, the outer surface of the first bottom plate 20211 is provided with a first recessed portion 20214 and a second recessed portion 20215, the second recessed portion 20215 is recessed relative to the first recessed portion 20214, the second recessed portion 20215 penetrates to the third wall surface 2023a, and the unlocking component is provided within the second recessed portion 20215. In some examples, along the width direction of the first bottom plate 20211, the first recessed portion 20214 may be located in the middle of the first recessed portion 20214, and the second recessed portion 20215 is in communication with the first recessed portion 20214. In some embodiments of the present disclosure, the unlocking component is provided within the second recessed portion 20215, that is, in the embodiments of the present disclosure, the unlocking component is limited by the second recessed portion 20215. The width of the second recessed portion 20215 may be adapted to the width of the unlocking component, for example, the width of the second recessed portion 20215 may be equal to or approximate to the width of the unlocking component. In some examples of the embodiments of the present disclosure, the body 601 may be located within the second recessed portion 20215.

In some embodiments, the first recessed portion 20214 includes a first sub-recessed portion 2141 and a second sub-recessed portion 2142, the first sub-recessed portion 2141 is in communication with the second recessed portion 20215, the second sub-recessed portion 2142 extends to the third wall surface 2023a, and the second sub-recessed portion 2142 is in communication with the first sub-recessed portion 2141, the second recessed portion 20215, and the third wall surface 2023a. In other words, the shape of the first recessed portion 20214 may be in a “convex” shape, where the second sub-recessed portion 2142 is located between the first sub-recessed portion 2141 and the second wall surface 2022a.

In some examples of the embodiments of the present disclosure, the second recessed portion 20215 has a first bottom wall surface 2151 and an ejector wall surface 2152; the first bottom wall surface 2151 protrudes relative to the second wall surface 2022a; that is, there is still a certain height difference between the first bottom wall surface 2151 and the second wall surface 2022a. The ejector wall surface 2152 is connected between the first bottom wall surface 2151 and the second wall surface 2022a, and the ejector wall surface 2152 is inclined. The inclination manner of the ejector wall surface 2152 may be the same as or similar to that of the ejector member 602. In some specific examples, the ejector wall surface 2152 may be formed by chamfering part of the third wall surface 2023a between the first wall surface 2021a and the second wall surface 2022a (for example, cutting off a right-angled edge formed after the second recessed portion 20215 penetrates to the third wall surface 2023a), thereby forming the ejector wall surface 2152.

Alternatively, in some examples, it may be understood that a slope is formed between the first bottom wall surface 2151 and the second wall surface 2022a, and a transition is made between the first bottom wall surface 2151 and the second bottom wall surface 2156 via the slope.

In some optional examples, the ejector wall surface 2152 may be a straight wall surface; and in other optional examples, the ejector wall surface 2152 may also be an arc-shaped wall surface. It can be understood that when the ejector wall surface 2152 is the arc-shaped wall surface, the arc-shaped wall surface may be an outwardly convex arc-shaped surface. In the embodiments of the present disclosure, the ejector wall surface 2152 is taken as the straight wall surface for illustration.

In some examples, a first angle is formed between the ejector wall surface 2152 and the second wall surface 2022a, and a second angle is formed between the ejector member 602 and the second wall surface 2022a; the first angle is greater than the second angle, such that when the unlocking component 600 moves toward the first wall surface 2021a, one end of the ejector member 602 facing the second wall surface 2022a abuts against the ejector wall surface 2152.

In some optional examples, the first angle may be 150°-160°, for example, the first angle may be 150°, 155°, or 160°. The second angle may be 135°-150°, for example, the first angle may be 135°, 140°, 145°, or 150°.

It should be noted that the numerical values and ranges involved in the embodiments of the present disclosure are approximate values and may have a certain range of errors due to manufacturing processes. these errors can be deemed negligible by those skilled in the art.

In the embodiments of the present disclosure, the first angle between the ejector wall surface 2152 and the second wall surface 2022a is set to be greater than the second angle between the ejector member 602 and the second wall surface 2022a; thus, when the unlocking component 600 moves toward the first wall surface 2021a, only the end of the ejector member 602 facing one side of the lower shell 202 is in contact with the ejector wall surface 2152. In other words, line-to-surface contact is made between the ejector member 602 and the ejector wall surface 2152, which can effectively avoid movement resistance and jitter caused by unevenness of the ejector wall surface 2152 or the ejector member 602 during the movement of the unlocking component, improving the stability of unlocking the optical module. In some examples of the embodiments of the present disclosure, a limiting post 2153 is provided on the first bottom wall surface 2151, where the limiting post 2153 protrudes from the first bottom wall surface 2151. An accommodating through hole 6011 is provided in the unlocking component, and the limiting post 2153 passes through the accommodating through hole 6011 and is located at one end of the accommodating through hole 6011 facing away from the second wall surface 2022a. One end of the accommodating through hole 6011 facing the second wall surface 2022a is provided with a positioning post 6012. In some embodiments of the present disclosure, a reset member 607 is provided inside the accommodating through hole 6011, one end of the reset member 607 is connected to the positioning post 6012, and the other end thereof is connected to the limiting post 2153. When the unlocking component moves away from the second wall surface 2022a, the reset member 607 provides a reset force toward the second wall surface 2022a for the unlocking component, such that when the external force on the unlocking component disappears, the reset member 607 drives the unlocking component to move toward the second wall surface 2022a.

The accommodating through hole 6011 may be formed by punching or slotting the sheet metal component. In some examples of the embodiments of the present disclosure, the reset member 607 may be an elastic component such as a spring or a sponge column. One end of the elastic component abuts against the limiting post 2153, the elastic component extends along the extension direction of the accommodating through hole 6011, and the other end of the elastic component is connected to the positioning post 6012. Thus, when the unlocking component moves toward the first wall surface 2021a, the reset member 607 is compressed, thereby storing energy; when the external force on the unlocking component disappears, the stored energy of the reset member 607 is released, thereby pushing the unlocking component to move toward the second wall surface 2022a.

In some examples, the reset member 607 may also be two same-polarity magnets facing each other, where one magnet is provided on the limiting post 2153 and the other magnet is provided on the positioning post 6012. When the unlocking component moves toward the first wall surface 2021a, a distance between the two same-polarity magnets facing each other decreases, increasing a repulsive force. When the external force on the unlocking component disappears, the repulsive force between the two magnets is released, thereby pushing the unlocking component to move toward the second wall surface 2022a.

In the embodiments of the present disclosure, an accommodating through hole 6011 is provided in the unlocking component and a limiting post 2153 is provided on the first bottom wall surface 2151, the limiting post 2153 passes through the accommodating through hole 6011 and is located at the end of the accommodating through hole 6011 facing away from the second wall surface 2022a. Thus, when the reset member 607 is provided, the reset member 607 can be accommodated within the accommodating through hole 6011, thereby reducing the space required for the reset member 607 and facilitating miniaturizing the optical module. Additionally, the limiting post 2153 is provided at one end of the accommodating through hole 6011 facing away from the second wall surface 2022a, and the a positioning post 6012 is provided at one end of the accommodating through hole 6011 facing the second wall surface 2022a, one end of the reset member 607 only needs to be sleeved around the periphery of the positioning post 6012, and the other end of the reset member 607 abuts against the limiting post 2153, which facilitates mounting the reset member 607 and improves the assembly efficiency of the optical module.

In other examples of the embodiments of the present disclosure, the second recessed portion 20215 further includes a first limiting wall surface 2154 and a second limiting wall surface 2155, and the first limiting wall surface 2154 and the second limiting wall surface 2155 are oppositely arranged on both sides of the first bottom wall surface 2151 along the width direction. The first limiting wall surface 2154 is recessed to form a first limiting slot 21541, and the first sub-bottom wall surface 21542 of the first limiting slot 21541 is recessed relative to the first bottom wall surface 2151. The second limiting wall surface 2155 is recessed to form a second limiting slot 21551, and the second sub-bottom wall surface 21552 of the second limiting slot 21551 is recessed relative to the first bottom wall surface 2151. The first limiting slot 21541 and the second limiting slot 21551 are located in both sides of the limiting post 2153. The body 601 is limited between the first limiting wall surface and the second limiting wall surface.

The first limiting slot 21541 and the second limiting slot 21551 may be oppositely arranged, where a width between side walls of the first limiting slot 21541 and the second limiting slot 21551 is greater than a width between the first limiting wall surface 2154 and the second limiting wall surface 2155. As an optional example, the width between the first limiting wall surface 2154 and the second limiting wall surface 2155 may be adapted to the width of the body 601. Of course, in some examples, the body 601, the ejector member 602, and the force applying member 603 may have a same width to facilitate the movement of the unlocking component 600 within the second recessed portion 20215.

In some optional examples of the embodiments of the present disclosure, the outer surface of the first side plate 20212 is provided with a third recessed portion 2121, the surface of the second side plate 20213 is provided with a fourth recessed portion 2131, the third recessed portion 2121 is recessed to form a plurality of first clamping slots 21211 arranged side by side, and the fourth recessed portion 2131 is recessed to form a plurality of second clamping slots 21311 arranged side by side. The third recessed portion 2121 is in communication with the first recessed portion 20214, and the fourth recessed portion 2131 is also in communication with the first recessed portion 20214.

In some embodiments of the present disclosure, the first clamping slot 21211 may be formed by inward stamping the side wall of the third recessed portion 2121, and the first clamping slot 21211 may be provided in two, three, four, etc. The number of first clamping slots 21211 is not limited in the embodiments of the present disclosure. The provision of the second clamping slot 21311 may be the same as or similar to that of the first clamping slot 21211, and this will not be repeated herein. In some examples, the second clamping slot 21311 may be symmetrically arranged with the first clamping slot 21211, which can reduce the positioning process when the first clamping slot 21211 and the second clamping slot 21311 are provided, improving processing efficiency.

In other optional examples of the embodiments of the present disclosure, the second recessed portion 20215 further includes a second bottom wall surface 2156, a third limiting wall surface 2157, and a fourth limiting wall surface 2158. The second bottom wall surface 2156 is located at one end of the first bottom wall surface 2151 facing away from the second wall surface 2022a, and the second bottom wall surface 2156 is recessed relative to the first bottom wall surface 2151. The third limiting wall surface 2157 and the fourth limiting wall surface 2158 are located on both sides of the second bottom wall surface 2156 along the width direction of the second bottom wall surface 2156. The third limiting wall surface 2157 is recessed relative to the first limiting wall surface 2154, and the fourth limiting wall surface 2158 is recessed relative to the second limiting wall surface 2155. In other words, there is a certain height difference between the second bottom wall surface 2156 and the first bottom wall surface 2151, and the width between the third limiting wall surface 2157 and the fourth limiting wall surface 2158 is greater than the width between the first limiting wall surface 2154 and the second limiting wall surface 2155.

In some examples, a transition inclined surface 2159 is provided between the second bottom wall surface 2156 and the first bottom wall surface 2151. In other words, the transition inclined surface 2159 is not perpendicular to either the first bottom wall surface 2151 or the second bottom wall surface 2156. Thus, the influence of the height difference between the first bottom wall surface 2151 and the second bottom wall surface 2156 on the movement of the overmolded handle can be reduced, effectively improving the smoothness of the unlocking component moving within the second recessed portion 20215.

To ensure that when the unlocking component is in the reset state, that is, when the optical module and the host computer are in the locked state, the force applying member 603 is located between the second wall surface 2022a and the locking spring tab of the host computer, and the overall dimension of the optical module is also reduced; according to some embodiments of the present disclosure, along the width direction of the lower shell 202, sunken slots 20223 are provided in both sides of the locking portion 20221. The sunken slots 20223 are recessed relative to the second wall surface 2022a, and the side wall of the sunken slot 20223 facing the first wall surface 2021a is a slope wall surface 20224. In some examples, when the unlocking component 600 is in the reset state, the force applying member 603 may descend into the sunken slot 20223.

The sunken slots 20223 are provided in both sides of the locking portion 20221, and the sunken slots 20223 are recessed relative to the second wall surface 2022a; when the unlocking component is in the reset state, the fourth bent portion descends into the sunken slot 20223, such that the force applying member 603 is integrally fitted against the second wall surface 2022a, reducing the gap between the force applying member 603 and the second wall surface 2022a, consequently reducing the gap between the locking spring tab of the host computer and the second wall surface 2022a, and enhancing the stability of locking between the optical module and the host computer.

In some embodiments of the present disclosure, the slope wall surface 20224 is not perpendicular to either the second wall surface 2022a or the bottom wall of the sunken slot 20223. Thus, the slope wall surface 20224 is formed on one side of the sunken slot 20223 facing the first wall surface 2021a. When the unlocking component 600 moves toward the first wall surface 2021a, the force applying member 603 moves outward from the sunken slot 20223 along the slope wall surface 20224, which can reduce the movement resistance of the force applying member 603 and improve the moving smoothness of the unlocking component 600.

In some examples, the inclined wall surface may be a straight inclined surface; or in other examples, the slope wall surface 20224 may also be an outwardly convex arc-shaped wall surface. The embodiments of the present disclosure do not limit the type of inclined wall surface.

FIG. 36 is a schematic structural diagram of an unlocking component in an optical module according to an embodiment of the present disclosure; and FIG. 37 is another schematic structural diagram of an unlocking component in an optical module according to an embodiment of the present disclosure. To prevent the unlocking component 600 from being pulled out of the movable gap between the lower shell and the outer cover plate under the external force, as shown in FIG. 35 to FIG. 37, in the embodiments of the present disclosure, the unlocking component 600 further includes: a first limiting support arm 604 and a second limiting support arm 605.

The first limiting support arm 604 protrudes from the body 601 and is located on one side of the accommodating through hole 6011. The first limiting support arm 604 includes a first limiting extension arm 6041 and a first limiting bending arm 6042. The first limiting extension arm 6041 extends to the first limiting slot along a width direction of the body 601, and the first limiting bending arm 6042 is bent toward the first sub-bottom wall surface.

In some embodiments of the present disclosure, the dimension of the first limiting support arm 604 along the length direction of the body 601 is less than the dimension of the first limiting slot along the length direction of the second recessed portion, such that the first limiting support arm 604 can move within the first limiting slot along the length direction.

In some embodiments of the present disclosure, the first limiting support arm 604 is provided on one side of the accommodating through hole 6011, such that the first limiting support arm 604 can widen the body 601 on one side of the accommodating through hole 6011, enhancing the strength of the body 601.

In some examples of the embodiments of the present disclosure, part of the first limiting support arm 604 may be bent toward the lower shell 202, thereby forming the first limiting extension arm 6041 and the first limiting bending arm 6042. Thus, the dimension of the first limiting support arm 604 in the thickness direction of the body 601 can be increased. When the unlocking component 600 is limited, the first limiting bending arm 6042 can block the side wall of the first limiting slot facing away from the second wall surface, such that the dimension of the first limiting support arm 604 in the thickness direction of the body 601 is greater than the gap between the first sub-recessed portion and the outer cover plate, preventing the unlocking component 600 from being pulled over. Additionally, the dimension of the first limiting support arm 604 increases in the thickness direction of the body 601, such that the force-bearing area of the first limiting support arm 604 increases in the thickness direction of the body 601 when the unlocking component 600 is limited, improving the stability of the body 601 in the thickness direction. When the body 601 swings in the thickness direction, the first limiting bending arm 6042 can abut against the first sub-bottom wall surface, thereby improving the stability of unlocking of the unlocking component 600.

It can be understood that, in the embodiments of the present disclosure, the second limiting support arm 605 protrudes from the body 601 and is located on the other side of the accommodating through hole 6011. The second limiting support arm 605 includes a second limiting extension arm 6051 and a second limiting bending arm 6052. The second limiting extension arm 6051 extends to the second limiting slot along the width direction of the body 601, and the second limiting bending arm 6052 is bent toward the second sub-bottom wall surface. In the embodiments of the present disclosure, the provision of the second limiting support arm 605 may be the same as or similar to that of the first limiting support arm 604. For details, reference may be made to the detailed description of the first limiting support arm 604. This will not be repeated herein.

Additionally, in the embodiments of the present disclosure, the first limiting support arm 604 and the second limiting support arm 605 may be symmetrically arranged with respect to the accommodating through hole 6011. Thus, the first limiting support arm 604 and the second limiting support arm 605 that are symmetrically arranged can provide stable limitation for the unlocking component 600, preventing the unlocking component 600 from shaking within the second recessed portion.

In some embodiments of the present disclosure, when the unlocking component 600 moves toward the first wall surface 2021a to a second preset position, the first limiting support arm 604 abuts against the wall surface on one side of the first limiting slot facing away from the second wall surface, and the second limiting support arm 605 abuts against the wall surface on one side of the second limiting slot facing away from the second wall surface, thereby limiting the movement stroke of the unlocking component 600. Thus, excessive movement of the unlocking component 600 within the second recessed portion can be avoided, causing fatigue of the reset member 607, thereby effectively improving the service life of the reset member 607, that is, increasing the effective unlocking times of the unlocking component 600.

In some examples of the embodiments of the present disclosure, the force applying member 603 has two unlocking support arms 6031 extending along the second wall surface. The two unlocking support arms 6031 are arranged side by side along the width direction of the lower shell, and an avoidance notch 6032 is provided between the two unlocking support arms 6031 and is configured to avoid the locking portion. When the optical module and the host computer are in the locked state, the locking portion passes through the avoidance notch 6032, and the two unlocking support arms 6031 are located on both sides of the locking portion.

In some examples, the force applying member 603 has a fourth bent portion 60311, the fourth bent portion 60311 is bent from one end of the force applying member 603 facing away from the body 601 toward the second wall surface, and the fourth bent portion 60311 is fitted against one side of the force applying member 603 facing the second wall surface. In some examples, the fourth bent portion 60311 may be formed by bending part of the unlocking support arm 6031 toward the second wall surface. In some embodiments of the present disclosure, the fourth bent portion 60311 is provided, such that the strength of the force applying member 603 can be improved, ensuring that the force applying member 603 does not bend or deform during the unlocking process, and guaranteeing the effectiveness of the unlocking component 600 for unlocking the optical module. When the unlocking component 600 is in the reset state, the fourth bent portion 60311 may descend into the sunken slot.

FIG. 38 is yet another schematic structural diagram of an unlocking component in an optical module according to an embodiment of the present disclosure. Referring to FIG. 38, in the embodiments of the present disclosure, the unlocking component 600 further includes an overmolded handle 606, one end of the overmolded handle 606 covers one end of the body 601 facing away from the second wall surface, the other end of the overmolded handle 606 extends to the outside of the second recessed portion, and the overmolded handle 606 is limited between the third limiting wall surface and the fourth limiting wall surface.

It can be understood that, in the embodiments of the present disclosure, part of the overmolded handle 606 may be limited between the third limiting wall surface and the fourth limiting wall surface. The part of the overmolded handle 606 extends to one side of the first wall surface facing away from the second wall surface. When the optical module needs to be pulled out or extracted from the host computer, the overmolded handle 606 can be pulled, thereby causing the overmolded handle 606 to drive the body 601 of the unlocking component, the ejector member 602, and the force applying member 603 to move toward the direction of the first wall surface.

In some embodiments of the present disclosure, since the overmolded handle 606 covers one end of the body 601 facing away from the second wall surface, the dimension of the overmolded handle 606 is slightly larger than that of the body 601; the width between the third limiting wall surface and the fourth limiting wall surface is set to be greater than the width between the first limiting wall surface and the second limiting wall surface, such that the overmolded handle 606 can be fitted with a gap between the third limiting wall surface and the fourth limiting wall surface, reducing a friction force on the overmolded handle 606 and improving the moving smoothness of the unlocking component 600 within the second recessed portion during unlocking.

Since the second bottom wall surface is recessed relative to the first bottom wall surface, the second bottom wall surface is relatively thin during manufacturing, making it difficult to manufacture. To avoid formation of large through holes at the second bottom wall surface and prevent the unlocking component 600 from unsmooth movement caused by a fact that the overmolded handle 606 enters the lower shell and then interferes with the lower shell, in some examples of the embodiments of the present disclosure, the lower shell is provided with a fiber adapter mounting structure, where the fiber adapter mounting structure is located on one side of the second bottom wall surface facing the first bottom wall surface, such that the side of the second bottom wall surface facing the first bottom wall surface serves as a closed bottom wall surface.

In other words, in some embodiments of the present disclosure, part of the second bottom wall surface can be thickened by the fiber adapter mounting structure inside the lower shell. When the second bottom wall surface is recessed relative to the first bottom wall surface, part of the second bottom wall surface with the fiber adapter mounting structure forms the closed bottom wall surface; thus, the opening area of the through hole formed in the second bottom wall surface can be reduced, avoiding interference between the overmolded handle 606 and the lower shell, and improving the moving smoothness of the unlocking component 600 within the second recessed portion.

To facilitate the connection between an external optical fiber (for example, the optical connector of the external optical fiber) and the fiber adapter of the optical port, in some examples of the embodiments of the present disclosure, the overmolded handle 606 is made of a soft material. For example, the overmolded handle 606 may be made of silicone, a soft plastic, or a soft rubber material. Thus, when the optical connector of the external optical fiber is inserted into the fiber adapter, the overmolded handle 606 can be bent, thereby facilitating the connection between the fiber adapter and the external optical fiber connector.

As an optional example, one end of the overmolded handle 606 extending to the lower shell facing away from the host computer may be provided with a pull ring. The pull ring may be a circular hole, an elliptical hole, or another irregular hole structure. This is not limited in the present disclosure.

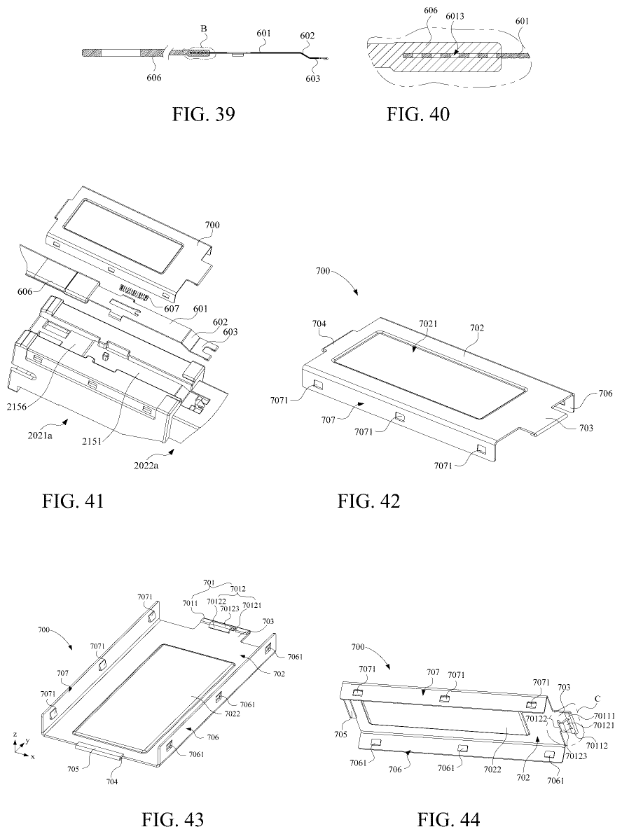

FIG. 39 is a cross-sectional view of an unlocking component in an optical module according to an embodiment of the present disclosure; FIG. 40 is a partial enlarged view at B in FIG. 39; and FIG. 41 is an exploded schematic structural diagram of cooperation among a lower shell, an unlocking component, and an outer cover plate in an optical module according to an embodiment of the present disclosure. Referring to FIG. 39 to FIG. 41, to enhance the connection strength between the overmolded handle 606 and the body 601, increase the force-bearing area of the overmolded handle 606, change the force direction of the overmolded handle 606, and avoid the overmolded handle 606 from detaching or breaking off from the body 601, in some embodiments of the present disclosure, multiple slots 6013 are provided at one end of the body 601 facing away from the second wall surface, where the slots 6013 extend along the width direction of the body 601 and are arranged along the length direction of the body 601. In some embodiments of the present disclosure, the slots 6013 may be through holes, and in some examples, the slots 6013 may also be grooves. In some embodiments of the present disclosure, the slots 6013 are taken as through holes for illustration. Part of the overmolded handle 606 is embedded into the slot 6013. In specific arrangement, the overmolding material in a molten (liquid) state may be injected into a mold with the body 601 placed therein. The liquid overmolding material is filled into the slot 6013, and portions of the overmolded handle on both sides of the body 601 are connected as an integrated component through the overmolding material filled in the slot 6013. Thus, after the overmolded handle 606 is connected to the body 601, the force-bearing area and strength of the overmolded handle 606 are increased, which can effectively prevent the overmolded handle 606 from being pulled apart. Moreover, an acting force between the overmolded handle 606 and the body 601 is converted from a surface friction to a tensile force inside the slot 6013, thereby enhancing the acting force of the overmolded handle 606 on the body 601 and preventing the overmolded handle 606 from detaching from the body 601.

In some embodiments of the present disclosure, the thickness of the portion of the overmolded handle 606 covering the body 601 is greater than the thickness of one end of the overmolded handle 606 facing away from the second wall surface. Thus, on the one hand, the strength at the connection between the overmolded handle 606 and the body 601 can be enhanced; on the other hand, the material of the overmolded handle 606 can be saved, thereby reducing manufacturing costs.

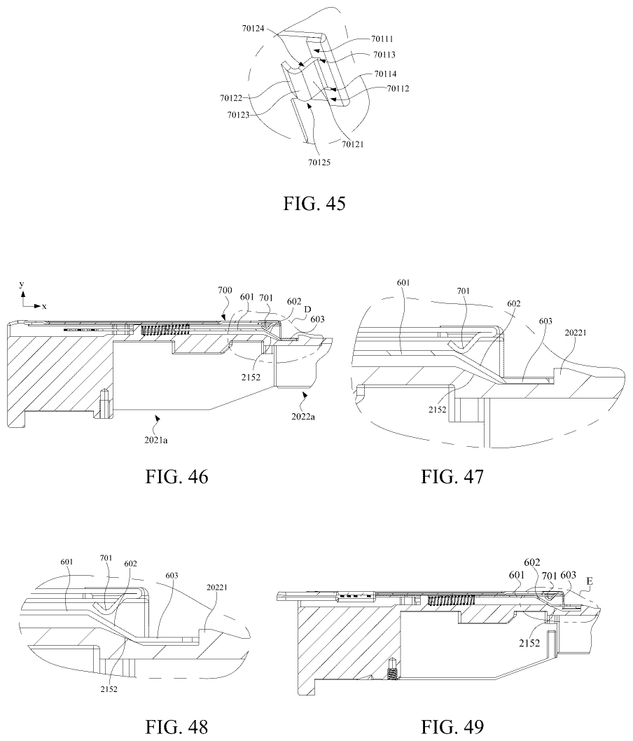

FIG. 42 is a schematic structural diagram of an outer cover plate in an optical module according to an embodiment of the present disclosure; FIG. 43 is another structural schematic diagram of an outer cover plate in an optical module provided according to an embodiment of the present disclosure; FIG. 44 is yet another schematic structural diagram of an outer cover plate in an optical module according to an embodiment of the present disclosure; and FIG. 45 is a partial enlarged view at C in FIG. 44. Referring to FIG. 41 to FIG. 45, the outer cover plate 700 includes: a first protruding portion 701, a cover plate body 702, and a first extension portion 703; where the first protruding portion 701 includes: a first bent portion 7011 and a second bent portion 7012.

In some examples, the outer cover plate 700 may be made of the sheet metal component, where the cover plate body 702 may cover the first wall surface 2021a and be located on one side of the unlocking component facing away from the lower shell 202.

The first extension portion 703 may extend from one end of the cover plate body 702 toward the second wall surface; for example, the first extension portion 703 may be provided at one end of the cover plate body 702 facing the second wall surface. In some examples, the first extension portion 703 and the cover plate body 702 may be integrally formed; for example, the sheet metal component may be cut to form the first extension portion 703. The first bent portion 7011 may be formed by bending one end of the first extension portion 703 facing the second wall surface (namely, one end facing away from the cover plate body 702) toward the lower shell 202 (which can also generally be understood as bending toward the inner side of the cover plate body 702); and in some embodiments of the present disclosure, the first bent portion 7011 is fitted against the inner wall surface of the first extension portion 703. Thus, the space occupied by the first bent portion 7011 can be reduced, facilitating the provision of the second bent portion 7012.

In some embodiments of the present disclosure, the second bent portion 7012 is bent from the first bent portion 7011 toward the lower shell 202, and the second bent portion 7012 may serve as the first protruding portion 701.

In other words, in some embodiments of the present disclosure, the first protruding portion 701 and the outer cover plate 700 may be an integral structure, that is, the first protruding portion 701 is formed by cutting and bending the sheet metal component. Thus, since the first protruding portion 701 is formed by bending the sheet metal component, the first protruding portion 701 has a certain elasticity, which can improve the reset smoothness of the unlocking component.

In the embodiment of the present disclosure, the cover plate body 702, the first extension portion 703, the first bent portion 7011, and the second bent portion 7012 are formed by cutting and bending the sheet metal component, and are configured to push against the unlocking component during reset, thereby facilitating forming the first protruding portion 701, and effectively saving the manufacturing cost of the first protruding portion 701.

In some examples of embodiments of the present disclosure, the second bent portion 7012 includes: a first sub-bent section 70121 and a second sub-bent section 70122. The first sub-bent section 70121 is bent from the first bent portion 7011 toward the lower shell 202. In other words, in the embodiment of the present disclosure, after the first bent portion 7011 is bent and fitted against the inner wall surface of the first extension portion 703, an end of the first bent portion 7011 continues to be bent in the direction toward the lower shell 202, thereby forming the first sub-bent section 70121. In the embodiment of the present disclosure, the second sub-bent section 70122 is bent from the first sub-bent section 70121 facing away from the lower shell 202, that is, a tail end of the first sub-bent section 70121 faces the lower shell, and a head end of the second sub-bent section 70122 also faces the lower shell, while a tail end of the second sub-bent section faces an inner wall surface of the outer cover plate 700; thus, an arc-shaped bent portion 70123 is formed at the connection of the first sub-bent section 70121 and the second sub-bent section 70122, and abuts against the ejector member when the unlocking component moves toward the second wall surface 2022a.

In some embodiments of the present disclosure, the second bent portion 7012 is configured as two sub-bent sections, where the first sub-bent section 70121 is bent toward the lower shell, and the second sub-bent section 70122 is bent away from the lower shell; thus, the arc-shaped bent portion 70123 is formed at the connection of the first sub-bent section 70121 and the second sub-bent section 70122; the arc-shaped bent portion 70123 pushes against the ejector member, such that the contact area between the first protruding portion 701 and the ejector member is smoother. This effectively prevents the ejector member from being scratched, improves the reset smoothness of the unlocking component and prevents the unlocking component from being jammed.

In some examples of embodiments of the present disclosure, the width of the first extension portion 703 is less than that of the cover plate body 702, and the width of the second bent portion 7012 is less than that of the first bent portion 7011. In other words, in some embodiments of the present disclosure, when the first extension portion 703 is formed at one end of the cover plate body 702 facing the second wall surface, the sheet metal component may be cut to form the first extension portion 703, such that the width of the first extension portion 703 is less than that of the cover plate body 702. This facilitates bending the first extension portion 703 to form the first bent portion 7011, and reduces the stress during the bending of the first extension portion 703. Additionally, when the first bent portion 7011 is bent to form the second bent portion 7012, the side of the first bent portion 7011 may be further cut, such that the width of the second bent portion 7012 is less than that of the first bent portion 7011; thus, the stress during the bending of the second bent portion 7012 can be reduced.

Additionally, when the outer cover plate 700 is mounted on the first wall surface, the cover plate body 702 is embedded in the first sub-recessed portion, and the outer wall surface of the cover plate body 702 is flush with the first wall surface; the first extension portion 703 is embedded in the second sub-recessed portion, and the outer wall surface of the first extension portion 703 is flush with the first wall surface; and the second bent portion 7012 may be embedded in the second recessed portion. The side wall surface of the first extension portion 703 may be in contact with the side wall surface of the second sub-recessed portion, such that the second sub-recessed portion can be configured to limit the first extension portion 703.

As an optional example, the width of the second bent portion 7012 may be slightly less than the width of the second recessed portion, such that when the outer cover plate 700 is mounted on the first wall surface, the second bent portion 7012 is embedded in the second recessed portion and fits with the side wall surface of the second recessed portion with a gap, facilitating mounting the outer cover plate 700 and improving the mounting efficiency of the outer cover plate 700.

In some embodiments of the present disclosure, a first recessed portion is provided on the first wall surface and the first recessed portion is configured to include a first sub-recessed portion and a second sub-recessed portion, the cover plate body 702 can be embedded in the first sub-recessed portion, and the first extension portion 703 can be embedded in the second sub-recessed portion, such that the surface of the outer cover plate 700 is flush with the first wall surface, and the overall flatness of the outer surface of the optical module is kept. In some embodiments of the present disclosure, the second bent portion 7012 has the first side wall surface 70124 and the second side wall surface 70125 that are opposite in the width direction. Referring to FIG. 20, the first bent portion 7011 has a third side wall surface 70111 and a fourth side wall surface 70112; a first notch 70113 is provided between the third side wall surface 70111 and the first side wall surface 70124, and a second notch 70114 is provided between the fourth side wall surface 70112 and the second side wall surface 70125. The first notch 70113 and the second notch 70114 are configured to release the bending stress between the second bent portion 7012 and the first bent portion 7011.

In some examples, after the side edges of both sides of the first bent portion 7011 are cut, the first notch 70113 may be formed by further cutting the first side wall surface 701244 of the second bent portion 7012 toward the first bent portion 7011, where the forming method of the second notch 70114 may be the same or similar to that of the first notch 70113. This will not be repeated herein.

In the embodiments of the present disclosure, the width of the first extension portion 703 is set to be less than that of the cover plate body 702, the width of the second bent portion 7012 is set to be less than that of the first bent portion 7011, and the first notch 70113 is provided between the first side wall surface 70124 of the second bent portion 7012 and the third side wall surface 70111 of the first bent portion 7011, while the second notch 70114 is provided between the second side wall surface 70125 and the fourth side wall surface 70112; thus, when the second bent portion 7012 is bent and formed, the first notch 70113 and the second notch 70114 can release the stress generated by bending the second bent portion 7012, facilitating bending and forming the second bent portion 7012, and effectively protecting the first bent portion 7011 from being torn by the stress generated during the bending of the second bent portion 7012. This facilitates forming the first bent portion 7011 and the second bent portion 7012, ensuring the structural integrity of the outer cover plate 700.

In some examples of the embodiments of the present disclosure, the outer cover plate 700 further includes a second extension portion 704 and a third bent portion 705. The second extension portion 704 is located at one end of the cover plate body 702 facing away from the second wall surface, extends away from the second wall surface, and has a width less than that of the cover plate body 702. The second extension portion 704 is limited between the third limiting wall surface and the fourth limiting wall surface. The third bent portion 705 is bent from one end of the second extension portion 704 facing away from the second wall surface toward the lower shell, and the third bent portion 705 is fitted against the inner wall surface of the second extension portion 704. The width of the third bent portion 705 is greater than the width of the second extension portion 704, such that one end of the third bent portion 705 is in contact with the inner wall surface of the cover plate body 702. It should be noted that the width of the third bent portion 705 and the width of the second extension portion 704 may refer to the dimensions along the length direction of the lower shell. In some embodiments of the present disclosure, the width of the third bent portion 705 is set to be greater than the width of the second extension portion 704, which facilitates bending and forming the third bent portion 705, improves the convenience of manufacturing, and enhances the yield rate of the optical module products.

In some examples, the length of the second extension portion 704 may be slightly less than the width between the third limiting wall surface and the fourth limiting wall surface. This facilitates inserting the second extension portion 704 between the third limiting wall surface and the fourth limiting wall surface, and provides positional limitation for the installation of the outer cover plate 700, for example, limiting the outer cover plate 700 in the width direction of the lower shell.

Additionally, in some embodiments of the present disclosure, the second extension portion 704 may cover one side of the overmolded handle facing away from the lower shell, thereby providing positional limitation for the overmolded handle. In other words, in the embodiments of the present disclosure, the second extension portion 704 can also play a certain limiting role for the overmolded handle in the direction facing away from the lower shell.

Furthermore, in some embodiments of the present disclosure, the third bent portion 705 is formed by bending one end of the second extension portion 704, such that an arc-shaped bend is formed at the end of the second extension portion 704 facing away from the second wall surface. This can prevent burrs or rough edges from forming at the end of the second extension portion 704. The end of the second extension portion 704 is arc-shaped, which can prevent scratches to other components. In addition, when an external optical fiber connector is assembled, the overmolded handle is bent toward the second extension portion 704, which can also prevent the overmolded handle from being scratched and can effectively extend the service life of the overmolded handle.

In other examples of the embodiments of the present disclosure, the outer wall surface of the cover plate body 702 is recessed to form a recessed slot 7021 that is configured to accommodate a label. A depth of the recessed slot 7021 is greater than a thickness of the label. In the embodiments of the present disclosure, the recessed slot 7021 may be formed by stamping the cover plate body 702. In some examples, the recess slot 7021 may also be formed by cold rolling. This is not limited in the present disclosure. In some embodiments of the present disclosure, the label may be affixed within the recessed slot 7021, and typically the thickness of the label is 0.2 mm. In some embodiments of the present disclosure, the depth of the recessed slot 7021 may be 0.4 mm to 0.5 mm. Thus, the label is recessed within the recessed slot 7021, which can prevent the label from being detached during transportation, transfer, or use of the optical module, providing protection for the label.

In some examples of the embodiments of the present disclosure, the inner wall surface of the cover plate body 702 protrudes corresponding to the recessed slot 7021 to form a second protruding portion 7022, and a protrusion height of the second protruding portion 7022 is greater than a thickness of the third bent portion 705. It can be understood that in some embodiments of the present disclosure, when the recessed slot 7021 is formed by stamping the cover plate body 702, the second protruding portion 7022 is formed on an opposite side of the recessed slot 7021. Thus, the second protruding portion 7022 can enhance the strength of the cover plate body 702. When the unlocking component moves toward the first wall surface, the unlocking component simultaneously moves away from the lower shell (namely, toward the outer cover plate 700) due to the provision of the ejector member. The unlocking component abuts against the inner wall of the outer cover plate 700 when moving to an unlocking position. In the embodiments of the present disclosure, the second protruding portion 7022 is formed on the inner wall of the outer cover plate 700, the second protruding portion 7022 abuts against the unlocking component, which can prevent the outer cover plate 700 from deforming by a fact that the unlocking component pushes against the outer cover plate.

In some examples, the outer cover plate 700 further includes a third side plate 706 and a fourth side plate 707. An inner surface of the third side plate 706 protrudes to form a plurality of first buckles 7061 arranged side by side, and an inner surface of the fourth side plate 707 protrudes to form a plurality of second buckles 7071 arranged side by side. The third side plate 706 is embedded in the third recessed portion, and the first buckles 7061 are engaged in the first clamping slot. The fourth side plate 707 is embedded in the fourth recessed portion, and the second buckles 7071 are engaged in the second clamping slot.

In some embodiments of the present disclosure, the first clamping slot may be formed by inward stamping a side wall of the third recessed portion, and the first clamping slot may be provided in two, three, four, and the like. The present disclosure does not limit the number of first clamping slots. The provision of the second clamping slot may be the same as or similar to that of the first clamping slot, and this will not be repeated herein. In some examples, the second clamping slot may be symmetrically arranged with the first clamping slot, which can reduce the positioning process when the first clamping slot and the second clamping slot are provided, improving processing efficiency.

Accordingly, the first buckles 7061 may also be formed by stamping the third side plate 706, and the number of first buckles 7061 may be the same as the number of first clamping slots. In addition, the provision of the second buckles 7071 may also be the same as or similar to that of the first buckles 7061. This will not be repeated herein.

In some embodiments of the present disclosure, when the outer cover plate 700 is assembled, the third side plate 706 may be inserted into the third recessed portion, the fourth side plate 707 may be inserted into the fourth recessed portion, and the first buckles 7061 may be engaged in the first clamping slot, while the second buckles 7071 may be engaged in the second clamping slot, thereby improving the assembly efficiency of the outer cover plate 700.

In some examples, the wall surface of the third side plate 706 is in contact with the wall surface of the third recessed portion, and the wall surface of the fourth side plate 707 is in contact with the wall surface of the fourth recessed portion, thereby providing positional limitation for the outer cover plate 700 and improving the installation stability of the outer cover plate 700.

In other examples, the thickness of the third side plate 706 is the same as or similar to the depth of the third recessed portion, such that when the third side plate 706 is inserted into the third recessed portion, the outer wall surface of the third side plate 706 is flush with the outer wall surface of the first side plate. Similarly, the thickness of the fourth side plate 707 is the same as or similar to the depth of the fourth recessed portion, such that when the fourth side plate 707 is inserted into the fourth recessed portion, the outer wall surface of the fourth side plate 707 is flush with the outer wall surface of the second side plate, thereby improving the flatness of the surface of the optical module.

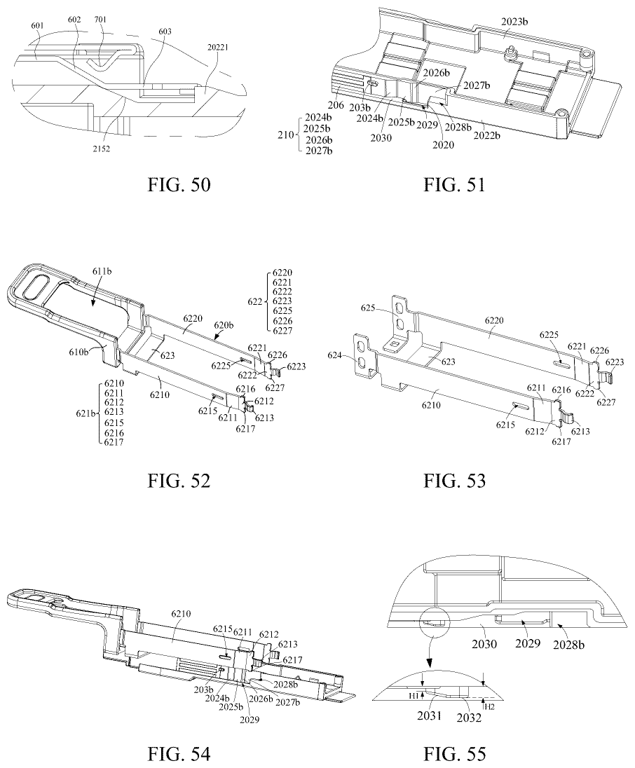

FIG. 46 is a cross-sectional view of cooperation between an unlocking component and a lower shell in an optical module according to an embodiment of the present disclosure; FIG. 47 is a partial enlarged view at D in FIG. 46; FIG. 48 is a partial enlarged view when an unlocking component moves to a preset position in an optical module according to an embodiment of the present disclosure; FIG. 49 is another cross-sectional view of cooperation between an unlocking component and a lower shell in an optical module according to an embodiment of the present disclosure; and FIG. 50 is a partial enlarged view at E in FIG. 49. Referring to FIG. 46 to FIG. 50, in some examples of embodiments of the present disclosure, when the optical module needs to be pulled out or extracted from the host computer, the unlocking component may move toward the direction of the first wall surface 2021a. For example, referring to FIG. 46, the unlocking component 600 may move along the negative direction of the x-axis in FIG. 46, and in this case, the ejector member 602 moves from the second wall surface 2022a toward the first wall surface 2021a. In other words, when the optical module is inserted into the host computer and the optical module and the host computer are in a locked state, the ejector member 602 may be located at the second wall surface 2022a, or part of the ejector member 602 may be located at the second wall surface 2022a. When the unlocking component 600 is moved toward the direction of the first wall surface 2021a, the ejector member 602 is moved from the second wall surface 2022a toward the first wall surface 2021a. In some examples, the ejector member 602 may be entirely moved to the first wall surface 2021a, or may be partially moved to the first wall surface 2021a.

In some embodiments of the present disclosure, the first wall surface 2021a protrudes from the second wall surface 2022a. When the ejector member 602 moves from the second wall surface 2022a toward the first wall surface 2021a, a step (for example, the ejector wall surface 2152 as described in detail in the foregoing embodiments of the present disclosure) formed between the first wall surface 2021a and the second wall surface 2022a abuts against the surface of the ejector member 602 facing the lower shell 202. Thus, the ejector member 602 is subjected to a force exerted by the ejector member 602, thereby raising the height of the ejector member 602. In this case, the entire unlocking component 6 is driven by the ejector member 602 to move away from the lower shell 202. For example, referring to FIG. 46, the entire unlocking component 600 moves in the direction indicated by the positive direction of the y-axis in FIG. 46. For example, the unlocking component moves from the state shown in FIG. 46 to the state shown in FIG. 50.

In some embodiments of the present disclosure, the force applying member 603 is connected to one end of the ejector member 602 facing the locking portion. In some embodiments of the present disclosure, the force applying member 603 may be parallel or approximately parallel to the second wall surface 2022a. It can be understood that when the unlocking component moves toward the first wall surface 2021a, due to the interaction between the ejector member 602 and the ejector wall surface 2152 between the first wall surface 2021a and the second wall surface 2022a, the entire unlocking component is driven by the ejector member 602 to move away from the lower shell 202. In this case, the force applying member 603 moves away from the second wall surface 2022a, thereby pushing the locking spring tab on the cage of the host computer away from the locking portion 20221 to unlock the optical module from the host computer.

In some optional examples of embodiments of the present disclosure, due to the provision of the ejector member 602, when the unlocking component 600 moves toward the first wall surface 2021a, the unlocking component 600 is integrally pushed by the ejector member 602 and moves away from the lower shell. To ensure that when the optical module is inserted into the host computer, the force applying member 603 is located between the locking spring tab of the host computer and the second wall surface 2022a. In some embodiments of the present disclosure, a first protruding portion 701 is provided on one side of the outer cover plate 700 facing the ejector member 602. When the unlocking component 600 moves toward the second wall surface to s first preset position (for example, along a position shown in FIG. 48), the first protruding portion 701 is in contact with the ejector member 602, such that the unlocking component 600 moves toward the lower shell, and when the unlocking component 600 is in the reset state, the first protruding portion 701 is in interference fit with the unlocking component 600.

In other words, in some embodiments of the present disclosure, after the unlocking component 600 unlocks the optical module from the host computer, during the process in which the unlocking component 600 moves toward the second wall surface 2022a to reset, the unlocking component 600 moves along the length direction of the first wall surface 2021a or the second wall surface 2022a. When the unlocking component 600 moves to the first preset position, the ejector member 602 is in contact with the first protruding portion 701. Since the ejector member 602 is inclined, the force exerted by the first protruding portion 701 on the ejector member 602 can be decomposed into a force vertically directed toward the lower shell 202 and a force along the length direction of the lower shell 202. In this case, under the action of the resetting force, the unlocking component 600 continues to move along the length direction of the lower shell 202, and the force exerted by the first protruding portion 701 on the ejector member 602 pushes the entire unlocking component 600 toward the lower shell 202, such that the force applying member 603 is fitted against the second wall surface 2022a.

In some examples, the first protruding portion 701 may be a rib, a ridge, a spring tab, or the like provided on the inner wall of the outer cover plate 700. The first protruding portion 701 may extend along the width direction of the outer cover plate 700. The length of the first protruding portion 701 may match the width of the unlocking component. For example, the length of the first protruding portion 701 may be the same as, approximate to, or similar to the width of the unlocking component.

In some possible examples, when the unlocking component is in the reset state, the first protruding portion 701 may abut against a top end of the ejector member, wherein the top end of the ejector member faces away from the body 601, and the body 601 is connected to a bottom end of the ejector member. Thus, when the unlocking component is in the reset state, the first protruding portion 701 and the unlocking component may be in an interference fit state, such that the force applying member 603 is completely fitted against the second wall surface.

For the optical module provided in the embodiments of the present disclosure, an accommodating cavity is formed by covering the upper shell and the lower shell, and the circuit board and the optical transceiver component are provided within the accommodating cavity, thereby facilitating the provision of the circuit board and the optical transceiver component and improving the installation and assembly efficiency of the optical module. The first wall surface and the second wall surface are provided on the lower shell, the second wall surface is recessed relative to the first wall surface, and the locking portion is provided on the second wall surface. Thus, when the optical module is inserted into the host computer, the locking portion on the second wall surface establishes a locking relationship with the outside, for example, locking with a locking structure on the cage of the host computer. In the embodiments of the present disclosure, the body of the unlocking component is provided on the first wall surface, the ejector member of the unlocking component is inclined relative to the body, and the force applying member is provided at one end of the ejector member facing the locking portion. Thus, when the optical module is pulled out from the host computer, the unlocking component may be moved toward the first wall surface, the ejector member moves from the second wall surface to the first wall surface, and pushes against the unlocking component as a whole away from the lower shell, such that the force applying member pushes the locking structure on the cage of the host computer away from the locking portion, to unlock the locking portion. In addition, an outer cover plate is provided on the first wall surface, and the outer cover plate covers one side of the unlocking component facing away from the lower shell. Thus, the outer cover plate limits the unlocking component on the lower shell and moves along the length direction of the lower shell. A movable gap for the unlocking component is reserved between the outer cover plate and the lower shell, facilitating movement of the ejector member from the second wall surface to the first wall surface when the unlocking component moves toward the first wall surface, thereby pushing the entire unlocking component away from the lower shell, and facilitating applying a force on the locking structure of the cage of the host computer by the force applying member. In the embodiments of the present disclosure, the first protruding portion is provided on one side of the outer cover plate facing the ejector member. During the process in which the unlocking component moves toward the second wall surface to reset, the first protrusion selectively abuts against the ejector member. Thus, the first protruding portion applies a force on the ejector member toward the lower shell, such that the unlocking component moves toward the lower shell while resetting toward the second wall surface, and during the process in which the unlocking component is reset from the first preset position, the force applying member can be fitted against the second wall surface for movement, facilitating inserting the force applying member under the locking structure of the cage of the host computer, facilitating normal resetting of the unlocking component, and ensuring smooth unlocking during the next unlocking operation, thereby improving the smoothness and stability of unlocking by the unlocking component.

In some examples of embodiments of the present disclosure, when the unlocking component moves toward the first wall surface to a first preset position (for example, referring to FIG. 22, the first preset position may be a position where the ejector member 602 begins to contact the ejector wall surface 2152), the ejector member 602 is separated from the first protruding portion 701. When the unlocking component continues to move toward the first wall surface, a gap is formed between the ejector member 602 and the first protruding portion 701. In other words, in some embodiments of the present disclosure, when the unlocking component moves toward the first wall surface to the first preset position, the force between the first protruding portion 701 and the ejector member 602 is zero. After the unlocking component continues to move by a certain distance to reach an unlocking position, the force applying member 603 completely unlocks the optical module from the host computer.

When the unlocking component moves toward the second wall surface to the first preset position, the first protruding portion 701 is in contact with the ejector member 602, such that the unlocking component 600 moves toward the lower shell. When the unlocking component is in the reset state, a vertical distance between the first protruding portion 701 and the second wall surface is less than a vertical distance between the surface of the body 601 facing away from the second wall surface and the second wall surface.

In other words, when the unlocking component 600 is in the reset state, at least one of the first protruding portion 701 and the unlocking component may undergo a certain deformation; for example, the first protruding portion 701 facing away from the lower shell may have a certain deformation. In some examples, since the unlocking component is supported by sheet metals, the unlocking component may also undergo a certain deformation; or in other examples, both the first protruding portion 701 and the unlocking component may undergo a certain deformation.

In embodiments of the present disclosure, the ejector member 602 is configured to be separated from the first protruding portion 701 when the unlocking component moves toward the first wall surface to the first preset position, and the first protruding portion 701 is in contact with the ejector member 602 when the unlocking component moves toward the second wall surface to the first preset position, such that the unlocking component moves toward the lower shell, and when the unlocking component is in the reset state, the vertical distance between the first protruding portion 701 and the second wall surface is less than the vertical distance between the surface of the body 601 facing away from one side of the second wall surface and the second wall surface. Thus, during the process in which the optical module and the host computer are in the locked state or the unlocking component is in the reset state, the unlocking component 600 can be subjected to a pressing force that is toward the lower shell and provided by the first protruding portion 701, such that the unlocking component is fitted against the lower shell, facilitating locking stability of the optical module and the host computer.

FIG. 51 is a first partial structural diagram of a lower shell in an optical module according to some embodiments of the present disclosure; FIG. 52 is a structural diagram of an unlocking component in an optical module according to some embodiments of the present disclosure; and FIG. 53 is a first structural diagram of an unlocker in an optical module according to some embodiments of the present disclosure. As shown in FIG. 51, FIG. 52, and FIG. 53, in order to form an enclosing cavity with the upper shell 201 and the lower shell 202, the lower shell 202 may include a first lower side plate 2022b. The first lower side plate 2022b is located on one side of the lower shell 202, and the bottom of the first lower side plate 2022b is connected to the lower base plate 2021b.

The lower shell 202 may include a second lower side plate 2023b. The second lower side plate 2023b is arranged symmetrically with the first lower side plate 2022b. The second lower side plate 2023b, the first lower side plate 2022b, and the lower base plate 2021b form a U-shaped lower shell.

In some embodiments, referring to FIG. 51, the first recessed area 210 may be provided on the first lower side plate 2022b. The first recessed area 210 is recessed toward the inner cavity of the enclosing cavity, such that the first recessed area 210 is recessed relative to the first lower side plate 2022b.

A first locking slot 2028b may be provided in the first lower side plate 2022b. The first locking slot 2028b is recessed inward into the first lower side plate 2022b, and the first locking slot 2028b is in communication with the first recessed area 210.

In some embodiments, the unlocking component 600 may include an unlocker 620b. The unlocker 620b is mounted on an outer side of the lower shell 202, where one end of the unlocker 620b is embedded in the first recessed area 210 and the first locking slot 2028b on the first lower side plate 2022b.

After one end of the unlocker 620b is embedded in the first recessed area 210 and the first locking slot 2028b, one end of the unlocker 620b is recessed relative to the first lower side plate 2022b, facilitating inserting the locking tab of the cage 106 into the recessed area of the unlocker 620b, thereby fixing the optical module 200 and the cage 106 via the locking tab.

Referring to FIG. 52 and FIG. 53, the unlocking component 600 may include a handle 610b (in some examples, the gripping portion may include the handle 610b). The handle 610b is connected to the unlocker 620b. An operator may grasp the handle 610b to push the unlocking component 600 inward, thereby inserting the optical module 200 into the cage 106 and implementing locking between the optical module 200 and the cage 106.

Alternatively, an operator may grasp the handle 610b to pull the unlocking component 600 outward, thereby pulling out the optical module 200 from the cage 106 and implementing unlocking between the optical module 200 and the cage 106.

In some embodiments, a gripping hole 611b may be formed in the handle 610b (in some examples, the hole may also be referred to as a through hole 611). The gripping hole 611b passes through the handle 610b, and the operator may grasp the gripping hole 611b to push the unlocker 620b inward, or grasp the gripping hole 611b to pull the unlocker 620b outward.

To implement the installation of the unlocker 620b and the lower shell 202, the unlocker 620b may include a first unlocking arm 621b. The first unlocking arm 621b is connected to the handle 610b, and the first unlocking arm 621b is mounted on the first lower side plate 2022b.

The unlocker 620b may include a second unlocking arm 622. The second unlocking arm 622 is connected to the handle 610b, and the second unlocking arm 622 is mounted on the second lower side plate 2023b of the lower shell 202, such that the first unlocking arm 621b and the second unlocking arm 622 are arranged symmetrically, and the first unlocking arm 621b and the second unlocking arm 622 are mounted on the outer side of the lower shell 202.

The unlocker 620b may include a connecting arm 623. One end of the connecting arm 623 is connected to the first unlocking arm 621b, and the other end of the connecting arm 623 is connected to the second unlocking arm 622.

In some embodiments, the first unlocking arm 621b and the second unlocking arm 622 are connected via the connecting arm 623, such that the first unlocking arm 621b, the second unlocking arm 622, and the connecting arm 623 form a U-shaped unlocker.

In some embodiments, the connecting arm 623 is connected to an outer side surface of the lower base plate 2021b to position the lower shell 202 within the U-shaped unlocker, such that the unlocker 620b is located on the outer side of the lower shell 202.

Referring to FIG. 53, the unlocker 620b may include a first connecting portion 624. The first connecting portion 624 is located at one end of the first unlocking arm 621b, where the first connecting portion 624 is inserted into the handle 610b to implement the connection between the first unlocking arm 621b and the handle 610b.

The unlocker 620b may include a second connecting portion 625. The second connecting portion 625 is located at one end of the second unlocking arm 622, where the second connecting portion 625 is inserted into the handle 610b to implement the connection between the second unlocking arm 622 and the handle 610b.

In some embodiments, the first connecting portion 624 and the second connecting portion 625 may be symmetrically arranged, where the first connecting portion 624 may be a planar connecting portion. Mounting holes may be formed in the planar connecting portion, where the first connecting portion 624 is connected to the handle 610b via screws and the mounting holes.

In some embodiments, the first connecting portion 624 and the second connecting portion 625 may be symmetrically arranged, where the first connecting portion 624 may be an L-shaped connecting portion, increasing the connection area between the first unlocking arm 621b and the handle 610b, thereby improving the connection stability between the first unlocking arm 621b and the handle 610b.

The first unlocking arm 621b and the second unlocking arm 622 have a same structure, where the first unlocking arm 621b and the second unlocking arm 622 are symmetrically arranged on both sides of the lower shell 202, such that when a force is applied to the unlocker 620b, the force can be evenly distributed on the first unlocking arm 621b and the second unlocking arm 622.

In some embodiments, the first unlocking arm 621b may include a first support arm 6210. One end of the first support arm 6210 is connected to the first connecting portion 624, where the first support arm 6210 is mounted on an outer side of the first lower side plate 2022b.

The first unlocking arm 621b may include a first inclined surface 6211. One end (a left end as shown in FIG. 7) of the first inclined surface 6211 is fixedly connected to the first support arm 6210.

The first unlocking arm 621b may include a second inclined surface 6212. One end (a left end as shown in FIG. 7) of the second inclined surface 6212 is fixedly connected to one end (a right end as shown in FIG. 53) of the first inclined surface 6211.

The first unlocking arm 621b may include a first locking hook 6213. The first locking hook 6213 is located at one end of the second inclined surface 6212 away from the first inclined surface 6211 (the right end as shown in FIG. 53).

In some embodiments, the first inclined surface 6211 is inclined toward the direction of the inner cavity of the enclosing cavity, such that the first inclined surface 6211 is inclined from outside to inside.

The second inclined surface 6212 is inclined toward the direction of the first lower side plate 2022b, such that the second inclined surface 6212 is inclined from inside to outside.

In some embodiments, when the first inclined surface 6211 is inclined from outside to inside and the second inclined surface 6212 is inclined from inside to outside, the first inclined surface 6211 and the second inclined surface 6212 form a first groove, where the first groove is a V-shaped groove.

In some embodiments, the first inclined surface 6211 may also be a curved surface, the second inclined surface 6212 may also be a curved surface, and the first inclined surface 6211 and the second inclined surface 6212 may form a U-shaped groove.

In some embodiments, the central axis of the first locking hook 6213 coincides with the central axis of the second inclined surface 6212, such that there is a first distance between a top surface of the first locking hook 6213 and a top surface of the second inclined surface 6212, and a second distance between a bottom surface of the first locking hook 6213 and a bottom surface of the second inclined surface 6212, where the first distance and the second distance are the same.

When the first unlocking arm 621b is mounted on the first lower side plate 2022b, the first inclined surface 6211 and the second inclined surface 6212 are located within the first recessed area 210 of the first lower side plate 2022b, and the first locking hook 6213 is embedded in the first locking slot 2028b of the first lower side plate 2022b, thereby implementing the connection between the first unlocking arm 621b and the first lower side plate 2022b.

In some embodiments, referring to FIG. 51, the first recessed area 210 may include a first side surface 2024b. One side of the first side surface 2024b is connected to the first lower side plate 2022b, where the first side surface 2024b is inclined toward the direction of the inner cavity of the enclosing cavity, such that the first side surface 2024b is inclined from outside to inside.

The first recessed area 210 may include a second side surface 2025b. One side of the second side surface 2025b is connected to the other side of the first side surface 2024b, where the second side surface 2025b is inclined toward the direction of the first lower side plate 2022b, such that the second side surface 2025b is inclined from inside to outside.

The first recessed area 210 may include a third side surface 2026b. One side of the third side surface 2026b is connected to the other side of the second side surface 2025b, where the third side surface 2026b is inclined toward the direction of the inner cavity of the enclosing cavity, such that the third side surface 2026b is inclined from outside to inside.

The first recessed area 210 may include a fourth side surface 2027b. The fourth side surface 2027b is connected to the other side of the third side surface 2026b, where the fourth side surface 2027b is arranged along the length direction of the first lower side plate 2022b, such that the fourth side surface 2027b is parallel to the outer side surface of the first lower side plate 2022b, and the fourth side surface 2027b is recessed relative to the outer side surface of the first lower side plate 2022b.

In some embodiments, the first side surface 2024b is inclined from outside to inside, the second side surface 2025b is inclined from inside to outside, the third side surface 2026b is inclined from outside to inside, and the fourth side surface 2027b is arranged in parallel, such that the first side surface 2024b, the second side surface 2025b, the third side surface 2026b, and the fourth side surface 2027b form the first recessed area 210 that is recessed inward.

The first recessed area 210 may include a first bearing surface 2030. One end of the second side surface 2025b facing the first lower side plate 2022b is recessed relative to an outer side surface of the first lower side plate 2022b, such that the first bearing surface 2030 is exposed on the first lower side plate 2022b, and an outer edge of the first bearing surface 2030 is flush with the outer side surface of the first lower side plate 2022b.

In some embodiments, the first bearing surface 2030 is recessed relative to a mounting surface of the first locking slot 2028b, that is, the mounting surface of the first locking slot 2028b is located above the first bearing surface 2030, and the first bearing surface 2030 and the mounting surface of the first locking slot 2028b form a stepped surface.

In some embodiments, a first connecting surface 2020 may be provided on the first lower side plate 2022b. The first connecting surface 2020 is perpendicular to the lower base plate 2021b, where one end of the first connecting surface 2020 is connected to the mounting surface of the first locking slot 2028b, and the other end of the first connecting surface 2020 is connected to the first bearing surface 2030.

In some embodiments, there is a gap between the connection of the third side surface 2026b and the fourth side surface 2027b and the first connecting surface 2020, such that the first unlocking arm 621b can be limited by the first connecting surface 2020.

In some embodiments, when the first unlocking arm 621b is mounted on the first lower side plate 2022b, a bottom surface of the first unlocking arm 621b is mounted on the first bearing surface 2030, such that the first unlocking arm 621b is supported by the first bearing surface 2030.

The first inclined surface 6211 is embedded in the recessed area among the first side surface 2024b, the second side surface 2025b, and the third side surface 2026b, and the second inclined surface 6212 is embedded in a gap between the third side surface 2026b and the first connecting surface 2020, such that a right end of the second inclined surface 6212 abuts against the first connecting surface 2020, and the first connecting surface 2020 is configured to limit the second inclined surface 6212 in a left-right direction.

Similarly, referring to FIG. 53, the second unlocking arm 622 may include a second support arm 6220. One end of the second support arm 6220 is connected to the second connecting portion 625, where the second support arm 6220 is mounted on an outer side of the second lower side plate 2023b.

The second unlocking arm 622 may include a third inclined surface 6221. One end (a left end as shown in FIG. 53) of the third inclined surface 6221 is fixedly connected to the second support arm 6220.

The second unlocking arm 622 may include a fourth inclined surface 6222. One end (the left end as shown in FIG. 53) of the fourth inclined surface 6222 is fixedly connected to one end (the right end as shown in FIG. 53) of the third inclined surface 6221.

The second unlocking arm 622 may include a second locking hook 6223. The second locking hook 6223 is located at one end of the fourth inclined surface 6222 away from the third inclined surface 6221 (the right end as shown in FIG. 53).

In some embodiments, the third inclined surface 6221 is inclined toward the direction of the inner cavity of the enclosing cavity, such that the third inclined surface 6221 is inclined from outside to inside.

The fourth inclined surface 6222 is inclined toward the direction of the second lower side plate 2023b, such that the fourth inclined surface 6222 is inclined from inside to outside.

In some embodiments, when the third inclined surface 6221 is inclined from outside to inside and the fourth inclined surface 6222 is inclined from inside to outside, the third inclined surface 6221 and the fourth inclined surface 6222 form a second groove, where the second groove is a V-shaped groove.

In some embodiments, the third inclined surface 6221 may also be a curved surface, the fourth inclined surface 6222 may also be a curved surface, and the third inclined surface 6221 and the fourth inclined surface 6222 may form a U-shaped groove.

When the second unlocking arm 622 is mounted on the second lower side plate 2023b, the second unlocking arm 622 is mounted on the bearing surface of the second lower side plate 2023b, the third inclined surface 6221 and the fourth inclined surface 6222 are located within a third recessed area of the second lower side plate 2023b, and the second locking hook 6223 is embedded in the second locking slot of the second lower side plate 2023b, thereby implementing the connection between the second unlocking arm 622 and the second lower side plate 2023b.

FIG. 54 is an exploded assembly diagram of a lower shell and an unlocking component in an optical module according to some embodiments of the present disclosure. As shown in FIG. 54, the first unlocking arm 621b is mounted on the outer side of the first lower side plate 2022b, the second unlocking arm 622 is mounted on the outer side of the second lower side plate 2023b, the first inclined surface 6211 and the second inclined surface 6212 are embedded in the first recessed area 210, and the third inclined surface 6221 and the fourth inclined surface 6222 are embedded in the third recessed area, such that the first groove formed by the first inclined surface 6211 and the second inclined surface 6212 is recessed relative to the first lower side plate 2022b, and the second groove formed by the third inclined surface 6221 and the fourth inclined surface 6222 is recessed relative to the second lower side plate 2023b.

After the optical module 200 is assembled, when the optical module 200 is inserted into the cage 106 of the host computer 100, the locking tabs on the cage 106 are embedded in the first slot and the second groove in the unlocker 620b, such that the first groove and the second groove in the unlocker 620b abut against the locking tabs, thereby implementing locking of the optical module 200 and the host computer 100 and preventing abnormal disengagement of the optical module 200.

In some embodiments, when the unlocker 620b is mounted on an outer side of the side plate of the lower shell 202, the unlocker 620b may be fixedly connected to the side plate. When the optical module 200 and the host computer 100 are unlocked, the operator holds the handle 610b and applies force outward, and the unlocker 620b moves outward under force. In this case, the inclined surface on the unlocker 620b that is inclined from inside to outside can push up the locking tabs on the cage 106, such that the unlocker 620b is disengaged from the locking tabs.

Since a right end of the unlocker 620b is embedded in the recessed area of the lower side plate and the locking slot, the unlocker 620b is fixedly connected to the lower shell 202. Thus, when the operator applies force outward, the unlocker 620b drives the lower shell 202 to move outward, thereby pulling out the optical module 200 from the host computer 100 and unlocking the optical module 200 from the host computer 100.

In some embodiments, when the unlocker 620b is mounted on the outer side of the side plate of the lower shell 202, the unlocker 620b may be non-fixedly connected to the side plate, and the unlocker 620b may move back and forth within a certain range on the side plate. When the unlocker 620b moves back and forth, the locking tabs are pushed up, and then the lower shell 202 is driven to move, thereby pulling out the optical module 200 from the cage 106.

In some embodiments, referring to FIG. 51, in order to enable the unlocker 620b to move back and forth within a certain range on the lower shell 202, a first limiting slot 2029 may be formed in the first bearing surface 2030. The first limiting slot 2029 is recessed relative to the first bearing surface 2030, and an opening is formed in one side of the first limiting slot 2029 facing away from the lower base plate 2021b.

The first limiting slot 2029 is arranged along the length direction of the lower shell 202, extends from the first connecting surface 2020 to the outer side of the second side surface 2025b, and a limiting length of the first limiting slot 2029 is an unlocking stroke dimension of the unlocker 620b. The first limiting slot 2029 is configured to limit the movement of the first unlocking arm 621b.

Referring to FIG. 53, a first protrusion 6217 may be provided on the second inclined surface 6212. The first protrusion 6217 is located in the direction of the second inclined surface 6212 facing the lower base plate 2021b, and the first protrusion 6217 protrudes from the bottom surface of the second inclined surface 6212.

When the first unlocking arm 621b is located on the outer side of the first lower side plate 2022b, the first protrusion 6217 is embedded in the first limiting slot 2029. When the optical module 200 is unlocked and the unlocker 620b moves leftward under force, the first protrusion 6217 moves leftward along the first limiting slot 2029, and in this case, the lower shell 202 does not move.

Similarly, a third limiting slot may be formed in a bearing surface of the second lower side plate 2023b. The third limiting slot is recessed relative to the bearing surface of the second lower side plate 2023b, and the third limiting slot is configured to limit the movement of the second unlocking arm 622.

Referring to FIG. 53, a third protrusion 6227 may be provided on the fourth inclined surface 6222. The third protrusion 6227 is located in a direction of the fourth inclined surface 6222 facing the lower base plate 2021b, and the third protrusion 6227 protrudes from a bottom surface of the fourth inclined surface 6222.

When the second unlocking arm 622 is located on the outer side of the second lower side plate 2023b, the third protrusion 6227 is embedded in the third limiting slot. When the optical module 200 is unlocked and the unlocker 620b moves leftward under force, the third protrusion 6227 moves leftward along the third limiting slot, and in this case, the lower shell 202 does not move.

In some embodiments, referring to FIG. 51, a first limiting protrusion 203b may be provided on the first lower side plate 2022b. The first limiting protrusion 203b protrudes outward from the first lower side plate 2022b, where the first limiting protrusion 203b is close to the first recessed area 210, and the first limiting protrusion 203b enables the unlocker 620b to drive the lower shell 202 to move.

Referring to FIG. 53, a first limiting hole 6215 can be formed in the first support arm 6210. The first limiting hole 6215 is located at one end of the first support arm 6210 away from the first connecting portion 624, where the first limiting hole 6215 is arranged along the length direction (left-right direction) of the first support arm 6210.

In some embodiments, the first limiting protrusion 203b is embedded in the first limiting hole 6215 to mount the first support arm 6210 on the first lower side plate 2022b, and the first limiting protrusion 203b is configured to restrict the outward disengagement of the first unlocking arm 621b, thereby ensuring the connection between the first unlocking arm 621b and the first lower side plate 2022b.

In some embodiments, the first limiting hole 6215 has a preset length in a length direction, where the preset length can be the unlocking stroke dimension of the unlocker 620b, and the first limiting hole 6215 is configured to restrict the movement of the first support arm 6210.

In some embodiments, a limiting hole can be provided in the first lower side plate 2022b. The limiting hole is recessed inward into the first lower side plate 2022b, where the limiting hole is close to the first recessed area 210.

A limiting protrusion can be formed on the first support arm 6210. The limiting protrusion is located on an inner side surface of the first support arm 6210 facing the first lower side plate 2022b, where the limiting protrusion protrudes into an inner cavity of the lower shell 202.

When the first unlocking arm 621b is mounted on the outer side of the first lower side plate 2022b, the limiting protrusion on the first support arm 6210 is embedded in the limiting hole in the first lower side plate 2022b, where the limiting protrusion is configured to restrict the disengagement of the first unlocking arm 621b, thereby ensuring the connection between the first unlocking arm 621b and the first lower side plate 2022b.

In some embodiments, referring to FIG. 51, a second limiting protrusion can be provided on the second lower side plate 2023b. The second limiting protrusion protrudes outward from the second lower side plate 2023b, where the second limiting protrusion is close to the third recessed area.

Referring to FIG. 53, a second limiting hole 6225 can be formed in the second support arm 6220. The second limiting hole 6225 is located at one end of the second support arm 6220 away from the second connecting portion 625, where the second limiting hole 6225 is arranged along a length direction of the second support arm 6220.

In some embodiments, the second limiting protrusion is embedded in the second limiting hole 6225 to mount the second support arm 6220 on the second lower side plate 2023b, and the second limiting protrusion is configured to restrict the disengagement of the second unlocking arm 622, thereby ensuring the connection between the second unlocking arm 622 and the second lower side plate 2023b.

In some embodiments, the second limiting hole 6225 has a preset length in the length direction, where the preset length can be the unlocking stroke dimension of the unlocker 620b, and the second limiting hole 6225 is configured to restrict the movement of the second support arm 6220.

In some embodiments, a limiting hole can be provided in the second lower side plate 2023b. The limiting hole is recessed inward into the second lower side plate 2023b.

A limiting protrusion can be formed on the second support arm 6220. The limiting protrusion is located on an inner side surface of the second support arm 6220 facing the second lower side plate 2023b, where the limiting protrusion protrudes into the inner cavity of the lower shell 202.

When the second unlocking arm 622 is mounted on the outer side of the second lower side plate 2023b, the limiting protrusion on the second support arm 6220 is embedded in the limiting hole in the second lower side plate 2023b, where the limiting protrusion is configured to restrict the disengagement of the second unlocking arm 622, thereby ensuring the connection between the second unlocking arm 622 and the second lower side plate 2023b.

FIG. 55 is a partial top view of a lower shell in an optical module according to some embodiments of the present disclosure. As shown in FIG. 55, the first limiting protrusion 203b on the first lower side plate 2022b can be a columnar protrusion, where an outer side surface of the first limiting protrusion 203b can be a square surface. When the first limiting protrusion 203b is embedded in the first limiting hole 6215, the first unlocking arm 621b is mounted on the outer side of the first lower side plate 2022b via the first limiting protrusion 203b, which can effectively prevent the first unlocking arm 621b from disengaging from the lower shell 202.

The second limiting protrusion on the second lower side plate 2023b may be a columnar protrusion, where an outer side surface of the second limiting protrusion may be a square surface. The second limiting protrusion is embedded into the second limiting hole 6225, and the second unlocking arm 622 is mounted on the outer side of the second lower side plate 2023b via the second limiting protrusion, which can effectively prevent the second unlocking arm 622 from disengaging from the lower shell 202.

In some embodiments, the thickness of the first limiting protrusion 203b may be equal to the width of the first limiting hole 6215, such that the first limiting protrusion 203b is embedded into the first limiting hole 6215. Thus, the first limiting hole 6215 may move left and right along both sides of the first limiting protrusion 203b, and the first unlocking arm 621b can be prevented from disengaging outward from the first lower side plate 2022b via the first limiting protrusion 203b.

The thickness of the second limiting protrusion may be equal to the width of the second limiting hole 6225, such that the second limiting protrusion is embedded into the second limiting hole 6225, and the second limiting hole 6225 may move left and right along both sides of the second limiting protrusion. Thus, the second limiting hole 6225 may move left and right along both sides of the second limiting protrusion, and the second unlocking arm 622 can be prevented from disengaging outward from the second lower side plate 2023b via the second limiting protrusion.

In some embodiments, the first limiting protrusion 203b includes a first end and a second end, where the first end is away from the first recessed area 210, the second end is close to the first recessed area 210, the first end has a first thickness H1, the second end has a second thickness H2, and the first thickness H1 is less than the second thickness H2.

Since the thickness of the first end of the first limiting protrusion 203b is less than that of the second end of the first limiting protrusion, the outer side surface of the first limiting protrusion 203b facing away from the inner cavity of the lower shell 202 has a first outer side surface 2031 and a second outer side surface 2032, where the first outer side surface 2031 is inclined from left to right, and the second outer side surface 2032 is a flat surface.

When the first limiting protrusion 203b is embedded into the first limiting hole 6215, since the dimension of the first end of the first limiting protrusion 203b is relatively small, it is convenient to embed the first limiting protrusion 203b into the first limiting hole 6215. The dimension of the second end of the first limiting protrusion 203b is relatively large, such that when the unlocker 620b moves, the second end of the first limiting protrusion 203b can withstand a pulling force generated during the movement of the unlocker 620b and transmit the pulling force to the lower shell 202, thereby facilitating force bearing.

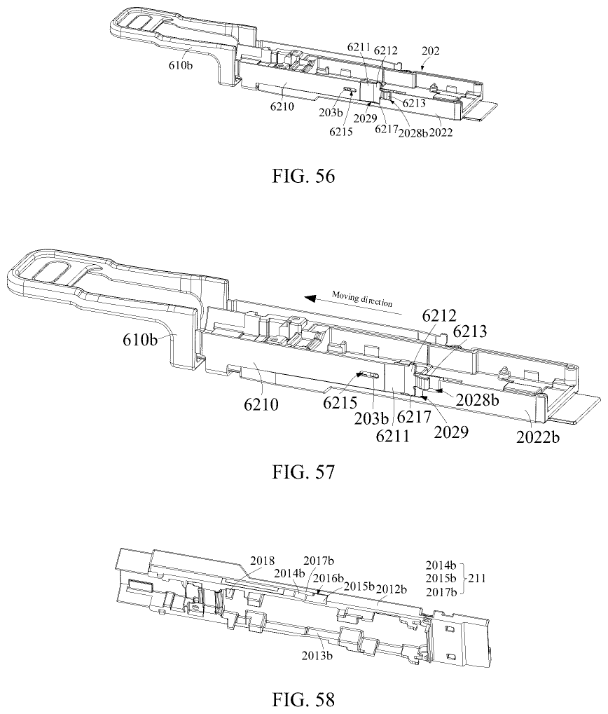

FIG. 56 is a first assembly diagram of a lower shell and an unlocking component in an optical module according to some embodiments of the present disclosure. As shown in FIG. 56, when the unlocker 620b is mounted onto the side plate of the lower shell 202, the first support arm 6210 of the first unlocking arm 621b is located on the outer side of the first lower side plate 2022b. The first limiting protrusion 203b is embedded into the first limiting hole 6215. The first inclined surface 6211 and the second inclined surface 6212 are located inside the first recessed area 210 of the first lower side plate 2022b, and the first protrusion 6217 on the second inclined surface 6212 is located inside the first limiting slot 2029 in the first bearing surface 2030. The first locking hook 6213 is located inside the first locking slot 2028b.

The second support arm 6220 of the second unlocking arm 622 is located on the outer side of the second lower side plate 2023b. The second limiting protrusion is embedded into the second limiting hole 6225. The third inclined surface 6221 and the fourth inclined surface 6222 are located inside the third recessed area of the second lower side plate 2023b, and the third protrusion 6227 on the fourth inclined surface 6222 is located inside the third limiting slot of the second lower side plate 2023b. The second locking hook 6223 is located inside the second locking slot.

In this case, the first end of the first limiting protrusion 203b is close to a left end of the first limiting slot 2029, and the right end of the second inclined surface 6212 abuts against the first connecting surface 2020. A first end of the second limiting protrusion is close to a left end of the third limiting slot, and a right end of the fourth inclined surface 6222 abuts against the second connecting surface of the second lower side plate 2023b, thereby implementing the connection between the unlocker 620b and the lower shell 202.

FIG. 57 is a first diagram of an unlocking process of a lower shell and an unlocking component in an optical module according to some embodiments of the present disclosure. As shown in FIG. 57, when the optical module 200 is unlocked, the operator holds the handle 610b and pulls the unlocker 620b leftward. The first unlocking arm 621b moves leftward under force, while the lower shell 202 remains stationary. The first limiting hole 6215 moves leftward along a side surface of the first limiting protrusion 203b, the first protrusion 6217 on the second inclined surface 6212 moves leftward within the first limiting slot 2029, and the first locking hook 6213 moves leftward within the first locking slot 2028b, until a right end of the first limiting hole 6215 abuts against the first limiting protrusion 203b.

When the right end of the first limiting hole 6215 abuts against the first limiting protrusion 203b, and the first unlocking arm 621b continues to move leftward, and the first unlocking arm 621b drives the lower shell 202 to move leftward via the first limiting protrusion 203b, such that the lower shell 202 moves leftward.

Similarly, when the operator holds the handle 610b and pulls the unlocker 620b leftward, the second unlocking arm 622 moves leftward under force, the lower shell 202 remains stationary, the second limiting hole 6225 moves leftward along a side surface of the second limiting protrusion, the third protrusion 6227 on the fourth inclined surface 6222 moves leftward within the third limiting slot, and the second locking hook 6223 moves leftward within the second locking slot, until a right end of the second limiting hole 6225 abuts against the second limiting protrusion.

When the right end of the second limiting hole 6225 abuts against the second limiting protrusion, the second unlocking arm 622 continues to move leftward, and the second unlocking arm 622 drives the lower shell 202 to move leftward via the second limiting protrusion, such that the lower shell 202 moves leftward.

In some embodiments, the unlocker 620b may be non-fixedly connected to the shell via the limiting protrusion and the limiting hole, such that the unlocker 620b can move left and right within a certain range on the outer side of the shell, thereby implementing the locking and flexible plugging/unplugging of the optical module 200.

The unlocker 620b may be non-fixedly connected to the shell via another structure, as long as the unlocker 620b can move left and right within a certain range on the outer side of the shell, all of which fall within the protection scope of the embodiments of the present disclosure.

In some embodiments, the unlocker 620b may be mounted on the lower side plate of the lower shell 202, and when the optical module 200 is unlocked, the unlocker 620b drives the lower shell 202 to move leftward.

In some embodiments, the unlocker 620b may be mounted on the lower side plate of the lower shell 202 and the upper side plate of the upper shell 201, and when the optical module 200 is unlocked, the unlocker 620b drives the lower shell 202 and the upper shell 201 to move leftward, so as to unlock the optical module 200.

FIG. 58 is a structural diagram of an upper shell in an optical module according to some embodiments of the present disclosure. As shown in FIG. 58, the upper shell 201 may include a first upper side plate 2012b. The first upper side plate 2012b is located on one side of the upper shell 201, and the bottom surface of the first upper side plate 2012b covers the top surface of the first lower side plate 2022b.

A second recessed area 211 may be formed on the first upper side plate 2012b. The second recessed area 211 is recessed relative to the first upper side plate 2012b, and is located above the first recessed area 210. The first recessed area 210 and the second recessed area 211 form a recessed area on the shell.

The second recessed area 211 may include a fifth side surface 2014b. One side of the fifth side surface 2014b is connected to the first upper side plate 2012b, and the fifth side surface 2014b is inclined toward the direction of the inner cavity of the enclosing cavity, that is, the fifth side surface 2014b is inclined from outside to inside.

The second recessed area 211 may include a sixth side surface 2015b. One side of the sixth side surface 2015b is connected to the other side of the fifth side surface 2014b, and the sixth side surface 2015b is arranged along a length direction of the first upper side plate 2012b, that is, the sixth side surface 2015b is arranged horizontally.

The second recessed area 211 may include a second bearing surface 2017b. The second bearing surface 2017b is connected to top surfaces of the fifth side surface 2014b and the sixth side surface 2015b, extends from the fifth side surface 2014b and the sixth side surface 2015b to an outer side surface of the first upper side plate 2012b, and an outer edge of the second bearing surface 2017b is flush with the outer side surface of the first upper side plate 2012b.

In some embodiments, a second limiting slot 2016b may be formed in the second bearing surface 2017b. The second limiting slot 2016b is recessed relative to the second bearing surface 2017b, and an opening is formed in one side of the second limiting slot 2016b facing the lower shell 202.

In some embodiments, referring to FIG. 53, a second protrusion 6216 may be provided on the second inclined surface 6212. The second protrusion 6216 is located in the direction of the second inclined surface 6212 facing the upper shell 201, and protrudes from the top surface of the second inclined surface 6212.

The second protrusion 6216 may be embedded into the second limiting slot 2016b, such that the first unlocking arm 621b moves on an outer side of the first upper side plate 2012b via the second protrusion 6216.

Similarly, the upper shell 201 may include the second upper side plate 2013b. The second upper side plate 2013b is located on the other side of the upper shell 201, and a bottom surface of the second upper side plate 2013b covers a top surface of the second lower side plate 2023b.

A fourth recessed area may be formed on the second upper side plate 2013b. The fourth recessed area is recessed in the second upper side plate 2013b, and is located above the third recessed area on the second lower side plate 2023b. The fourth recessed area and the third recessed area form a recessed area on the shell.

The fourth recessed area may include a fourth bearing surface. An outer edge of the fourth bearing surface is flush with an outer side surface of the second upper side plate 2013b. A fourth limiting slot may be formed in the fourth bearing surface. The fourth limiting slot is recessed relative to the fourth bearing surface, and an opening is formed on one side of the fourth limiting slot facing the lower shell 202.

In some embodiments, referring to FIG. 53, a fourth protrusion 6226 may be provided on the fourth inclined surface 6222. The fourth protrusion 6226 is located in the direction of the fourth inclined surface 6222 facing the upper shell 201, and protrudes from a top surface of the fourth inclined surface 6222.

The fourth protrusion 6226 may be embedded into the fourth limiting slot at will, so that the second unlocking arm 622 moves on an outer side of the second upper side plate 2013b via the fourth protrusion 6226.

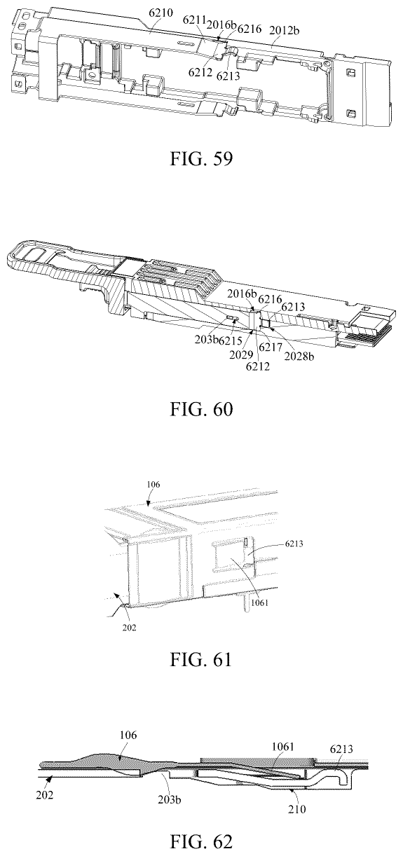

FIG. 59 is a structural assembly diagram of an upper shell and an unlocking component in an optical module according to some embodiments of the present disclosure; and FIG. 60 is a first cross-sectional assembly view of an upper shell, a lower shell, and an unlocking component in an optical module according to some embodiments of the present disclosure. As shown in FIG. 59 and FIG. 60, when the first unlocking arm 621b is located on the outer side of the first upper side plate 2012b, the first inclined surface 6211 and the second inclined surface 6212 are located in the second recessed area 211, the top surface of the first locking hook 6213 is connected to the bottom surface of the first upper side plate 2012b, and the second protrusion 6216 is embedded into the second limiting slot 2016b, thereby implementing the connection between the first unlocking arm 621b and the first upper side plate 2012b.

When the second unlocking arm 622 is located on the outer side of the second upper side plate 2013b, the third inclined surface and the fourth inclined surface are located in the fourth recessed area, a top surface of the second locking hook 6223 is connected to the bottom surface of the second upper side plate 2013b, and the fourth protrusion 6226 is embedded into the fourth limiting slot, thereby implementing the connection between the second unlocking arm 622 and the second upper side plate 2013b.

Thus, after the upper shell 201 covers the lower shell 202, the unlocker 620b is located on outer sides of the upper shell 201 and the lower shell 202, the first unlocking arm 621b is located on outer sides of the first upper side plate 2012b and the first lower side plate 2022b, and the first unlocking arm 621b is non-fixedly connected to the first upper side plate 2012b and the first lower side plate 2022b. The second unlocking arm 622 is located on outer sides of the second upper side plate 2013b and the second lower side plate 2023b, and the second unlocking arm 622 is non-fixedly connected to the second upper side plate 2013b and the second lower side plate 2023b.

When the optical module 200 is unlocked and the unlocker 620b moves leftward under force, the first protrusion 6217 moves leftward along the first limiting slot 2029, the second protrusion 6216 moves leftward along the second limiting slot 2016b, the third protrusion 6227 moves leftward along the third limiting slot, the fourth protrusion 6226 moves leftward along the fourth limiting slot, the first limiting hole 6215 moves leftward along the first limiting protrusion 203b, and the second limiting hole 6225 moves leftward along the second limiting protrusion. In this case, the upper shell 201 and the lower shell 202 do not move.

When the unlocker 620b continues to move leftward under force, such that the right end of the first limiting hole 6215 abuts against a right end of the first limiting protrusion 203b, and the right end of the second limiting hole 6225 abuts against a right end of the second limiting protrusion. In this case, the unlocker 620b transmits the force to the upper shell 201 and the lower shell 202, such that the unlocker 620b drives the upper shell 201 and the lower shell 202 to move leftward.

In some embodiments, the length of the first limiting slot 2029 may be equal to the length of the second limiting slot 2016b, and the lengths of the first limiting slot 2029 and the second limiting slot 2016b may be equal to the length of the first limiting hole 6215.

The lengths of the first limiting slot 2029 and the second limiting slot 2016b may be equal, and the lengths of the first limiting slot 2029 and the second limiting slot 2016b may be greater than the length of the first limiting hole 6215.

FIG. 61 is a partial assembly diagram of an optical module and a cage of a host computer according to some embodiments of the present disclosure; and FIG. 62 is a cross-sectional assembly view of a lower shell, an unlocking component, and a cage of a host computer in an optical module according to some embodiments of the present disclosure. As shown in FIG. 61 and FIG. 62, the upper shell 201 covers the lower shell 202, and the unlocker 620b is mounted on the outer sides of the upper shell 201 and the lower shell 202, thereby completing the assembly of the optical module 200. After the optical module 200 is assembled, the optical module 200 is inserted into the cage 106 of the host computer 100.

Since one end of the unlocker 620b is inclined inward, the first inclined surface 6211 and the second inclined surface 6212 on the first unlocking arm 621b form the first groove, and the third inclined surface 6221 and the fourth inclined surface 6222 on the second unlocking arm 622 form the second groove. When the optical module 200 is inserted into the cage 106, the locking tabs 1061 on the cage 106 are embedded into the first groove and the second groove.

In some embodiments, when the optical module 200 is pulled in a static environment, the locking tab 1061 of the cage 106 is inserted into the unlocker 620b, the locking tab 1061 abuts against the unlocker 620b, which prevents the optical module 200 from disengaging from the cage 106, implementing the locking of the optical module 200 and the cage 106.

When the optical module 200 needs to be pulled out, the operator grips the handle 610b and pulls outward, causing the unlocker 620b to move left under force, while the upper shell 201 and the lower shell 202 remain stationary. Since the second inclined surface 6212 and the fourth inclined surface 6222 abut against the locking tab 1061, and the second inclined surface 6212 and the fourth inclined surface 6222 are inclined outward from the inside, when the unlocker 620b moves leftward, the second inclined surface 6212 and the fourth inclined surface 6222 gradually push up the locking tab 1061 during the leftward movement, until the locking tab 1061 is disengaged from the first groove and the second groove on the unlocker 620b.

When the locking tab 1061 is disengaged from the first groove on the unlocker 620b, the right end of the first limiting hole 6215 on the unlocker 620b contacts the first limiting protrusion 203b, and the right end of the second limiting hole 6225 contacts the second limiting protrusion. As the unlocker 620b moves left, the outward pulling force is transmitted to the upper shell 201 and the lower shell 202. At this time, the upper shell 201, the lower shell 202, and the unlocker 620b move left together, and finally, under the action of the outward pulling force, the optical module 200 is unlocked and disengaged from the cage 106.

Since the unlocker 620b moves a certain distance to the left, the unlocker 620b transmits the outward pulling force to the shell through the limiting protrusion on the shell, causing the unlocker 620b and the shell to move left together. However, after the optical module 200 is unlocked, the unlocker 620b does not reset. When the optical module 200 is inserted into the host computer 100 again, the movement stroke of the unlocker 620b is relatively long.

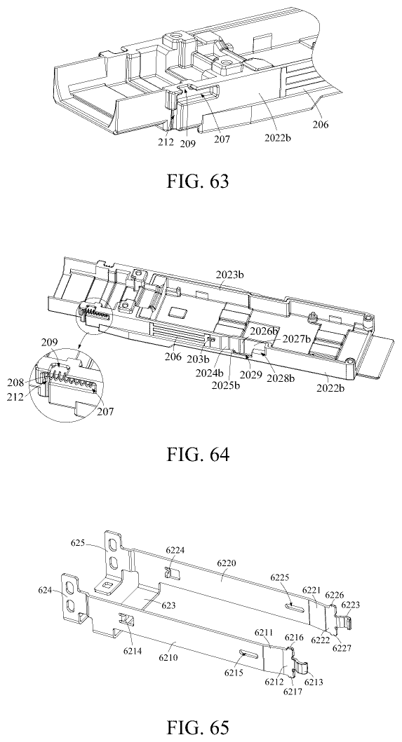

FIG. 63 is a second partial structural diagram of a lower shell in an optical module according to some embodiments of the present disclosure; and FIG. 64 is a structural diagram of a lower shell in an optical module according to some embodiments of the present disclosure. As shown in FIG. 63 and FIG. 64, a first spring slot 207 may be formed in the first lower side plate 2022b. The first spring slot 207 is located on one side of the first lower side plate 2022b away from the first locking slot 2028b, and an opening is formed in one side of the first spring slot 207 facing away from the inner cavity.

A first spring 208 may be mounted within the first spring slot 207. One end of the first spring 208 is fixedly mounted on an inner wall of the first spring slot 207, and the other end of the first spring 208 is movably mounted within the first spring slot 207.

Similarly, a second spring slot may be formed in the second lower side plate 2023b. The second spring slot is located on one side of the second lower side plate 2023b away from the second locking slot, and an opening is formed in one side of the second spring slot facing away from the inner cavity.

A second spring may be mounted within the second spring slot. One end of the second spring is fixedly mounted on an inner wall of the second spring slot, and the other end of the second spring is movably mounted within the second spring slot.

In some embodiments, a first positioning notch 209 may be formed in the first spring slot 207. The first positioning notch 209 is located on one side of the first spring slot 207 facing the upper shell 201, and the first positioning notch 209 is connected to the first spring slot 207.

Referring to FIG. 58, a first positioning post 2018 may be provided on the upper shell 201. The first positioning post 2018 is located on an inner side surface of the cover plate 2011 facing the lower shell 202, is close to the first upper side plate 2012b, and protrudes from the cover plate 2011.

Similarly, a second positioning notch may be formed in the second spring slot. The second positioning notch is located on one side of the second spring slot facing the upper shell 201, and the second positioning notch is connected to the second spring slot.

A second positioning post may be provided on the upper shell 201. The second positioning post is located on an inner side surface of the cover plate 2011 facing the lower shell 202, is close to the second upper side plate 2013b, and protrudes from the cover plate 2011.

When the upper shell 201 covers the lower shell 202, the first positioning post 2018 is inserted into the first positioning notch 209, and the second positioning post is inserted into the second positioning notch, thereby implementing positional connection between the upper shell 201 and the lower shell 202.

In some embodiments, when positional connection is made between the upper shell 201 and the lower shell 202, the positioning posts and the positioning notches are not limited to the above design; as long as the upper shell 201 and the lower shell 202 can be located, all such designs fall within the scope of protection of the embodiments of the present disclosure.

FIG. 65 is a second structural diagram of an unlocker in an optical module according to some embodiments of the present disclosure. As shown in FIG. 65, a first spring hook 6214 may be provided on the first unlocking arm 621b. The first spring hook 6214 is located at the connection of the first support arm 6210 and the handle 610b, and the first spring hook 6214 protrudes toward the inner cavity of the lower shell 202.

In some embodiments, the first spring hook 6214 may be formed by stamping the outer side surface of the first support arm 6210 stamped inward. A right end of the first spring hook 6214 protrudes toward the inner cavity of the lower shell 202, and a left end of the first spring hook 6214 is fixedly connected to the first support arm 6210.

Similarly, a second spring hook 6224 may be provided on the second unlocking arm 622. The second spring hook 6224 is located at the connection of the second support arm 6220 and the handle 610b, and the second spring hook 6224 protrudes toward the inner cavity of the lower shell 202.

The second spring hook 6224 may be formed by stamping the outer side surface of the second support arm 6210 inward. A right end of the second spring hook 6224 protrudes toward the inner cavity of the lower shell 202, and a left end of the second spring hook 6224 is fixedly connected to the second support arm 6220.

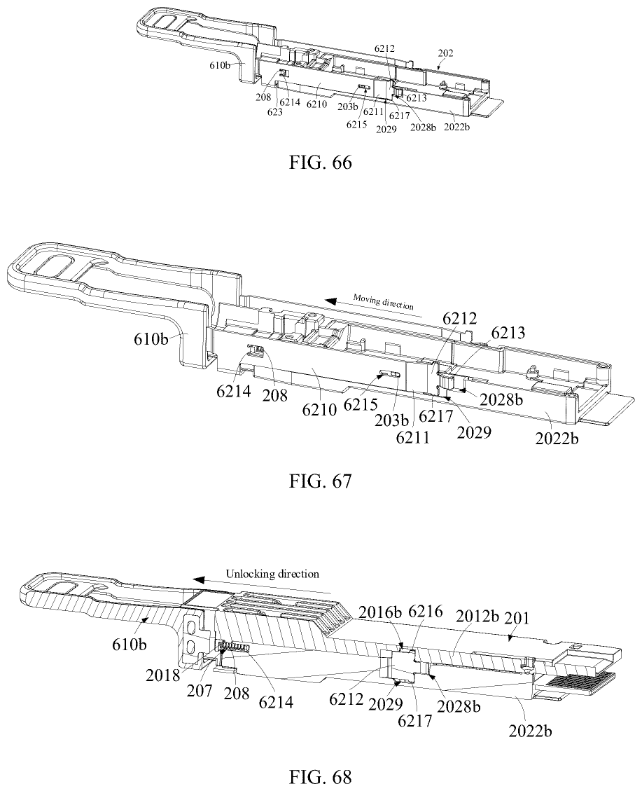

FIG. 66 is a second assembly diagram of a lower shell and an unlocking component in an optical module according to some embodiments of the present disclosure; FIG. 67 is a second diagram of an unlocking process of a lower shell and an unlocking component in an optical module according to some embodiments of the present disclosure; and FIG. 68 is a second cross-sectional assembly view of an upper shell, a lower shell, and an unlocking component in an optical module according to some embodiments of the present disclosure. As shown in FIG. 66, FIG. 67, and FIG. 68, when the unlocker 620b is mounted on outer sides of the two lower side plates of the lower shell 202, the first spring hook 6214 extends to the first spring slot 207, and the first spring hook 6214 is in cooperative connection with the first spring 208. The second spring hook 6224 extends to the second spring slot, and the second spring hook 6224 is in cooperative connection with the second spring.

When the optical module 200 is locked with the cage 106, the first spring 208 and the second spring are in normal states. When the optical module 200 is unlocked from the cage 106, the unlocker 620b moves leftward under force. In this case, the first spring hook 6214 compresses the first spring 208 during movement, and the second spring hook 6224 compresses the second spring during movement.

When the unlocker 620b moves leftward, the unlocker 620b gradually pushes up the locking tab 1061 on the cage 106 until the limiting hole in the unlocker 620b abuts against the limiting protrusion on the shell. The unlocker 620b then transmits the outward pulling force to the shell, driving the shell to move leftward. In this case, the first spring 208 and the second spring are no longer compressed.

After the optical module 200 is pulled out from the cage 106, since the first spring 208 and the second spring are in a compressed state, when no outward pulling force is applied to the unlocker 620b, the unlocker 620b resets under the force of the springs, facilitating reinserting the optical module 200 into the cage 106.

In some embodiments, when the upper shell 201 covers the lower shell 202 and the unlocker 620b is mounted on the outer sides of the upper shell 201 and the lower shell 202, a gap may exist between a right end of the handle 610b and a left end of the lower shell 202, and a left end of the unlocking arm protrudes from the left end of the lower shell 202, thereby positioning the handle 610b via the unlocker 620b.

In some embodiments, a first positioning groove 212 may be formed in the first lower side plate 2022b. The first positioning groove 212 is recessed relative to the first lower side plate 2022b, is connected to the first spring slot 207, and extends from the first spring slot 207 to the lower base plate 2021b.

When the unlocker 620b is mounted on the outer side of the lower shell 202, the handle 610b may be located via the first positioning groove 212, facilitating the positional assembly of the handle 610b and the lower shell 202.

In some embodiments, when the outer wall of the shell and the unlocking component 600 are made of relatively hard metal materials, direct contact between hard materials constitutes hard contact. Thus, a gap will be generated between the outer wall of the shell and the unlocking component 600 during hard contact, such that electromagnetic waves radiated from the optical port of the optical module can propagate along the gap.

To prevent the electromagnetic waves from radiating and transmitting along the gap between the outer wall of the shell and the unlocking component 600, referring to FIG. 63, the first shielding portion 206 may be provided on the first lower side plate 2022b. The first shielding portion 206 is located between the first spring slot 207 and the first limiting protrusion 203b, and extends from the upper portion of the first lower side plate 2022b to the lower portion thereof.

The first unlocking arm 621b covers the first shielding portion 206, and the first lower side plate 2022b and the first unlocking arm 621b are electrically connected via the first shielding portion 206. The first shielding portion 206 is configured to seal the gap between the first lower side plate 2022b and the first unlocking arm 621b.

Similarly, a second shielding portion may be provided on the second lower side plate 2023b. The second shielding portion is located between the second spring slot and the second limiting protrusion, and extends from the upper portion of the second lower side plate 2023b to the lower portion thereof.

The second unlocking arm 622 covers the second shielding portion, and the second lower side plate 2023b and the second unlocking arm 622 are electrically connected via the second shielding portion. The second shielding portion is configured to seal the gap between the second lower side plate 2023b and the second unlocking arm 622.

In some embodiments, the first shielding portion 206 and the second shielding portion may be conductive pads, or may be rib protrusions on the lower side plate of the lower shell 202.

The conductive pad is provided at a contact position between the outer wall of the shell and the unlocking component 600. The conductive pad is relatively softer than the outer wall of the shell and the unlocking component 600; and the outer wall of the shell and the unlocking component 600 can be electrically connected via the conductive pad; and a gap between the outer wall of the shell and the unlocking component 600 can be sealed by the conductive pad.

For the optical module provided by the embodiments of the present disclosure, the conductive pad is provided on the side plate of the shell, and the side plate and the unlocking component 600 are electrically connected via the conductive pad, avoiding the formation of a gap between the side plate and the unlocking component 600, and further preventing electromagnetic waves from radiating and propagating through the gap between the side wall of the shell and the unlocking component, thereby improving the electromagnetic shielding performance of the optical module.

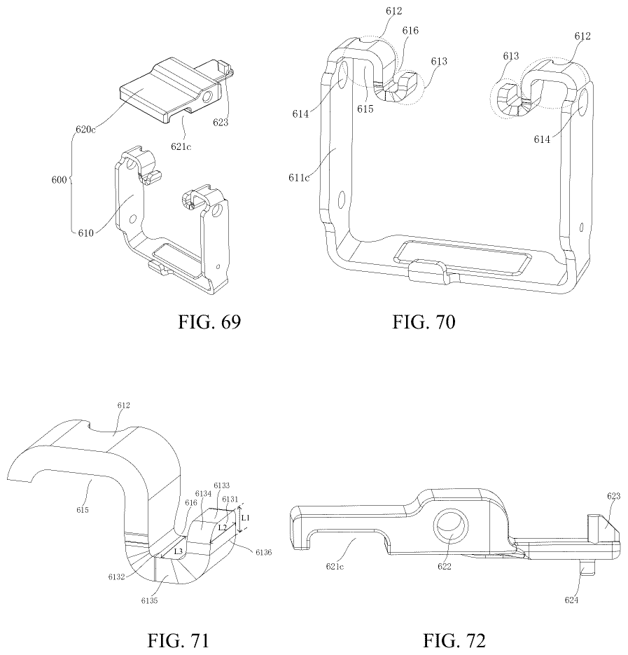

FIG. 69 is an exploded view of an unlocking component according to some embodiments. Referring to FIG. 69, in some embodiments, the unlocking component 600 includes an unlocking handle 610 (in some examples, which is also referred to as a gripping portion) and an unlocker 620c. A mating slot 621c is recessed from a bottom surface toward a top surface at one end of the unlocker 620c, and a clamping component 623 is formed on a surface at the other end thereof. When the optical module is in a locked state, that is, when the optical module is connected to the host computer, the unlocking handle 610 is in a stationary state. The stationary state means that the unlocking handle 610 is in a naturally hanging state, and the naturally hanging state means that the plane where the unlocking handle 610 is located faces downward, while the unlocker 620c is in a horizontal state, and the clamping component 623 is engaged with the cage of the host computer, thereby locking the optical module within the host computer. When the optical module needs to be unlocked, the unlocking handle 610 is pulled upward. During the upward pulling process, one end where the clamping component 623 is located gradually descends until the clamping component 623 is disengaged from the cage of the host computer, thereby unlocking the optical module from the host computer.

FIG. 70 is a structural diagram of an unlocking handle according to some embodiments; and FIG. 71 is a partial structural diagram of an unlocking handle according to some embodiments. As shown in FIG. 70 and FIG. 71, in some embodiments, the unlocking handle 610 includes a body structure 611c. When the unlocking handle 610 is pulled upward, the unlocking handle 610 can be pulled by pulling the body structure 611c. For example, the body structure 611c is a U-shaped structure.

A first bent portion 612 and a second bent portion 613 that are connected to each other are respectively formed at one tail end of the body structure 611c. Similarly, the first bent portion 612 and the second bent portion 613 that are connected to each other are respectively formed at the other tail end of the body structure 611c. For example, both the first bent portion 612 and the second bent portion 613 are a curved structure, such as both being an L-shaped structure. The first bent portion 612 wraps around the limiting portion 2021c, thereby limiting the unlocking handle 610 onto the lower shell 202.

The second bent portion 613 at one end is not connected to the second bent portion 613 at the other end. The first bent portion 612 and the second bent portion 613 at one end are connected end to end, with a smooth transition between the first bent portion and the second bent portion.

The first groove 615 is formed between the first bent portion 612 and the body structure 611c, and the second groove 616 is formed between the first bent portion 612 and the second bent portion 613. The orientations of the first groove 615 and the second groove 616 are different. For example, the first groove 615 faces the direction of the lower shell 202 and wraps around the limiting portion 2021c, while the second groove 616 faces the direction of the upper shell 201.

The limiting hole 614 is formed in one side of the body structure 611c close to the first bent portion 612, and the limiting hole 614 is embedded on a surface of the limiting post 2022c. An opening formed between the first bent portion 612 and the body structure 611c wraps around a surface of the limiting portion 2021c, thereby limiting the unlocking handle 610 onto the lower shell 202. In some embodiments, when the unlocking handle 610 is pulled upward, the unlocking handle 610 rotates with the limiting post 2022c as a fulcrum, thereby driving the unlocker 620c to rotate.

In some embodiments, the second bent portion 613 includes a first connecting portion 6131 and a second connecting portion 6132 that are connected in a bent manner. For example, the first connecting portion 6131 and the second connecting portion 6132 are not connected in a straight line, but rather in a bent configuration, and the first connecting portion 6131 is arranged in a warped manner relative to the second connecting portion 6132. A connecting surface 6136 is formed at a position where the first connecting portion 6131 and the second connecting portion 6132 are connected.

In some embodiments, the surface of the first connecting portion 6131 includes a first plane 6133, and the surface of the second connecting portion 6132 includes a second plane 6135. When the unlocking handle 610 is in the stationary state, the first plane 6133 is in contact with a surface of the mating slot 621c. When the unlocking handle 610 is pulled upward, the second bent portion 613 flips within the mating slot 621c until the second plane 6135 is in contact with the surface of the mating slot 621c. During the flipping process, the second bent portion gradually flips from a state where the first plane 6133 is in contact with the surface of the mating slot 621c to a state where the second plane 6135 is in contact with the surface of the mating slot 621c. In order to ensure that the clamping component 623 is completely disengaged from the cage of the host computer, one end where the mating slot 621c is located must have a sufficient lifted height. A distance from the second plane 6135 to an opposite side thereof is defined as a first distance that is labeled as L3 in FIG. 71. The distance from the first plane 6133 to the connecting surface 6136 between the first connecting portion 6131 and the second connecting portion 6132 is defined as a second distance that is labeled as L1 in FIG. 71. The first distance L3 is greater than the second distance L1, such that the flipping trajectory during the flipping process exhibits a height change. The unlocker 620c also presents a height change, such that the end where the mating slot 621c is located is lifted up, ensuring that the end where the mating slot 621c is located has the sufficient lifted height for the clamping component 623 to descend enough to disengage from the cage of the host computer. For example, the end where the mating slot 621c is located has a lower height at the beginning of flipping than at the end of flipping, while the end where the clamping component 623 is located has a higher height at the beginning of flipping than at the end of flipping. In other words, the end where the mating slot 621c is located is lifted up, and the end where the clamping component 623 is located descends, until the clamping component 623 is completely disengaged from the host computer, thus successfully implementing unlocking.

A first distance L3 is greater than a second distance L1, such that the first connecting portion 6131 presents an approximately rectangular shape. For example, when the unlocking handle 610 is in the stationary state, the dimension of the first connecting portion 6131 along the length direction of the lower shell 202 is greater than the dimension thereof along the width direction of the lower shell 202. When the first connecting portion 6131 presents the approximately rectangular shape, a flipping trajectory during the flipping process exhibits a height change, such that the end where the mating slot 621c is located is lifted up and the end where the clamping component 623 is located descends.

In some embodiments, in order to disengage the clamping component 623 from the cage of the host computer, during the process in which the second bent portion gradually flips from the state where the first plane 6133 is in contact with the surface of the mating slot 621c to the state where the second plane 6135 is in contact with the surface of the mating slot 621c, a height at which the second plane 6135 is in contact with the surface of the mating slot 621c is greater than a height at which the first plane 6133 is in contact with the surface of the mating groove 621c. For example, a distance from the center of the limiting post 2022c to the second plane 6135 when the second plane 6135 is in contact with the surface of the mating slot 621c is greater than a distance from the center of the limiting post 2022c to the first plane 6133 when the second plane 6135 is in contact with the surface of the mating slot 621c. The distance difference between these two states is the height change exhibited during the flipping process of the second bent portion 613, and the height change is generated by the flipping trajectory of the second bent portion 613. This height change enables the end where the mating slot 621c is located to be lifted up and the end where the clamping component 623 is located to descend, and the descending height is sufficient for the clamping component 623 to disengage from the cage of the host computer.

In some embodiments, the surface of the first connecting portion 6131 includes the first plane 6133 and an arc segment 6134, and the surface of the second connecting portion 6132 includes a second plane 6135. The first plane 6133 and the second plane 6135 are connected via the arc segment 6134. When the optical module is in the locked state, the first plane 6133 is located on the top surface of the first connecting portion 6131, the arc segment 6134 is located on the side surface of the first connecting portion 6131, and the second plane 6135 is located on the side surface of the second connecting portion 6132. When the unlocking handle 610 is pulled upward, the second bent portion 613 flips within the mating slot 621c. During the flipping process, the arc segment 6134 is kept tangential movement with the surface of the mating slot 621c. This tangential movement between the arc segment and the surface of the mating slot can reduce the flipping friction of the second bent portion 613, thereby improving the unlocking smoothness.

The first plane 6133, the arc segment 6134, and the second plane 6135 are connected to form a contact surface. As the unlocking handle 610 rotates, different parts of the contact surface are in contact with the unlocker 620c. Similarly, this ensures that the clamping component 623 is completely disengaged from the host computer, where a distance from the second plane 6135 to an opposite side thereof is a first distance, the first distance is labeled as L3 in FIG. 71, a distance from the first plane 6133 to the connecting surface between the first connecting portion 6131 and the second connecting portion 6132 is a second distance, the second distance is labeled as L1 in FIG. 71, and the first distance is greater than the second distance. This causes the flipping trajectory to exhibit a height change during the flipping process, and accordingly the unlocker 620c also exhibits a height change. For example, the end where the mating slot 621c is located has a lower height at the beginning of flipping than at the end of flipping, while the end where the clamping component 623 is located has a higher height at the beginning of flipping than at the end of flipping. In other words, the end where the mating slot 621c is located is lifted up, and the end where the clamping component 623 is located descends, until the clamping component 623 is completely disengaged from the host computer, successfully implementing unlocking.

The first distance L3 is greater than the second distance L1, and the distance from the arc segment 6134 to the opposite side thereof is a third distance L2. The third distance L2 is between the first distance L3 and the second distance L1, such that the first connecting portion 6131 presents the approximately rectangular shape. For example, when the unlocking handle 610 is in the stationary state, the dimension of the first connecting portion 6131 along the length direction of the lower shell 202 is greater than the dimension thereof along the width direction of the lower shell 202. When the first connecting portion 6131 is in the approximately rectangular shape, during the rotation of the unlocking handle 610, the dimensions along the unlocking path change, and the height in the later stage of unlocking is greater than that in the early stage of unlocking, thereby lifting up the end where the mating slot 621c is located and descending the end where the clamping component 623 is located to implement unlocking.

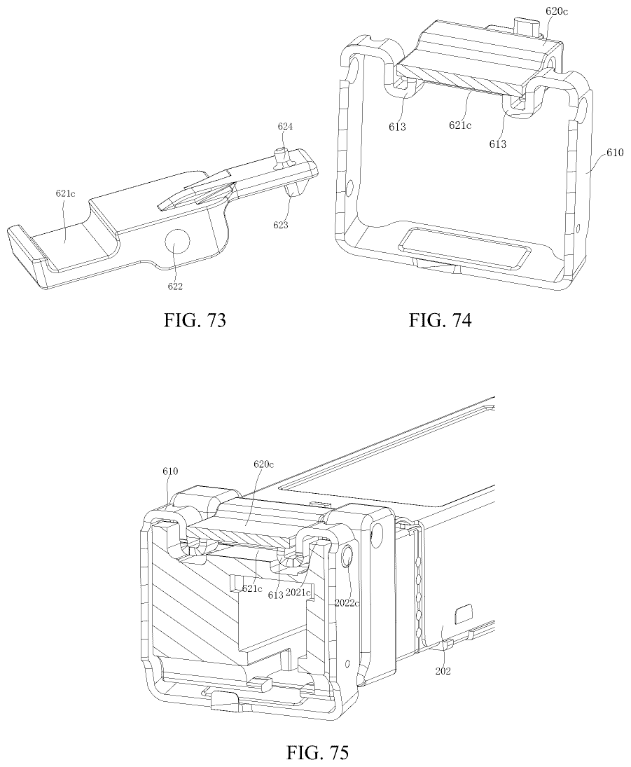

FIG. 72 is a first structural diagram of an unlocker according to some embodiments; and FIG. 73 is a second structural diagram of an unlocker according to some embodiments. As shown in FIG. 72 and FIG. 73, in some embodiments, the bottom surface of one end of the unlocker 620c close to the optical port is recessed toward the top surface to form the mating slot 621c. The mating slot 621c covers the surfaces of the second bent portions 613 at both ends, and ends of the second bent portions 613 extend to the mating slot 621c. The clamping component 623 is formed at the other end of the unlocker 620c. A through hole 622 is formed in an intermediate structure of the unlocker 620c, the through hole 622 passes through the connecting shaft 2024c and can rotate around the connecting shaft 2024c. When the unlocking handle 610 is pulled upward, the unlocker 620c is driven to rotate around the connecting shaft 2024c, thereby causing the end where the clamping component is located 623 to descend until the clamping component 623 is pulled out from the cage of the host computer to unlock the optical module. In this case, the connecting shaft 2024c is located on the lower shell 202. The connecting shaft 2024c serves as a rotating shaft, and the lower shell 202 provides a pivot for the rotation of the unlocker 620c. For example, the rotating shaft may be provided inside the unlocker 620c. Correspondingly, through holes are formed in both sides of the lower shell 202 to embed the rotating shaft, that is, the unlocker 620c itself is configured with an integrated rotating shaft.

A protrusion 624 is formed on one side of the unlocker 620c opposite to the clamping component 623. A spring 2025c is provided on one side of the connecting shaft 2024c in the lower shell 202. The protrusion 624 is connected to the spring 2025c, thereby connecting the unlocker 620c and the spring 2025c together. When the optical module needs to be unlocked, the end where the clamping component 623 is located presses the spring 2025c downward to descend. Upon completion of unlocking, the unlocker 620c is reset by the resilient force of the spring 2025c. Meanwhile, the spring 2025c can also provide some cushioning during the descending process.

FIG. 74 is a cross-sectional view of an unlocking component according to some embodiments. As shown in FIG. 74, in some embodiments, the second bent portions 613 on both sides extend from a bottom into both sides of the mating slot 621c, and the unlocker 620c covers the surfaces of the second bent portions 613 on both sides. For example, one side of the mating slot 621c covers the surface of the second bent portion 613 on one side, and the other side thereof covers the surface of the second bent portion 613 on the other side.

When the unlocking handle 610 is pulled upward, the second bent portions 613 on both sides rotate and flip within the mating slot 621c, thereby lifting up one end of the unlocker 620c where the mating slot 621c is located and descending the end where the clamping component 623 is located to unlock the optical module. Since the second bent portions 613 on both sides need to rotate and flip within the mating slot 621c, there are certain preset requirements for the dimensions of the mating slot 621c. For example, a dimension of the mating slot 621c along the width direction of the lower shell 202 is greater than a distance between the second bent portions 613 on both sides, and a dimension of the mating slot 621c along the length direction of the lower shell 202 is greater than a length of the second bent portion 613, thereby providing sufficient space for the second bent portion 613 to rotate and flip within the mating slot 621c.

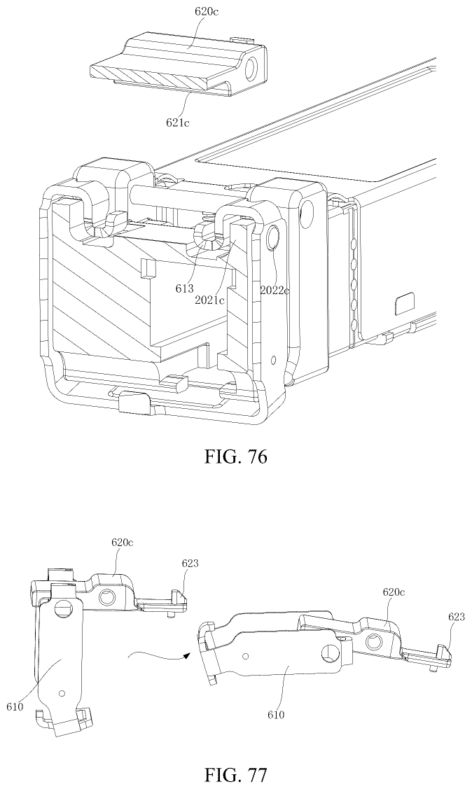

FIG. 75 is a cross-sectional view of an optical module according to some embodiments; and FIG. 76 is an exploded cross-sectional view of an optical module according to some embodiments. As shown in FIG. 75 and FIG. 76, in some embodiments, the limiting hole 614 of the unlocking handle 610 is embedded into the surface of the limiting post 2022c, and then the first bent portion 612 wraps downward around the limiting portion 2021c, thereby limiting the unlocking handle 610 to the lower shell 202. The second bent portion 613 supports the unlocker 620c upward, such that when the unlocking handle 610 is pulled, the second bent portion 613 flips to drive the rotation of the unlocker 620c, lifting up the end of the unlocker 620c where the mating slot 621c is located and descending the end where the clamping component 623 is located to unlock the optical module. For example, the unlocking handle 610 rotates around the limiting post 2022c as a fulcrum when pulled. To prevent the unlocking handle 610 from slipping out of the limiting post 2022c during rotation, a distance between outer walls of the limiting posts 2022c on both sides is greater than a distance between outer walls of the body structure 611c on both sides, such that the outer walls of the limiting posts 2022c protrude relative to the outer walls of the body structure 611c, preventing the unlocking handle 610 from slipping out of the limiting post 2022c.

As shown in FIG. 75 and FIG. 76, when the optical module is in the locked state, the unlocking handle 610 is in a naturally hanging state. In this case, the unlocker 620c covers surfaces of the first planes 6133 on both sides. For example, the mating slot 621c covers the surfaces of the first planes 6133 on both sides, and the surface of the mating slot 621c is in contact with the first plane 6133.

In some embodiments, when the unlocking handle 610 in FIG. 75 and FIG. 76 is pulled upward, during the pulling process, the arc segment 6134 is kept tangential to the surface of the mating slot 621c. Taking a tangent point formed by tangency as the fulcrum, the second bent portion 613 is rotated. During the rotation process, the second bent portion 613 gradually flips from the state where the first plane 6133 is in contact with the surface of the mating slot 621c to the state where the second plane 6135 is in contact with the surface of the mating slot 621c. The flipping movement of the second bent portion 613 along the flipping trajectory enables the end of the unlocker 620c where the mating slot 621c is located to be lifted up and the end of the unlocker where the clamping component 623 is located to descend, thereby unlocking the optical module.

During the unlocking process disclosed herein, when the unlocking handle 610 is pulled upward, the second bent portion 613 is driven to flip the contact surface within the mating slot 621c. A height difference generated by flipping enables the end where the clamping component 623 is located to descend, thereby unlocking the optical module. During the flipping process of the second bent portion 613 to implement unlocking, the arc segment 6134 is kept tangential to the surface of the mating slot 621c, thereby reducing friction during the flipping process, making the force transmission more coherent, further increasing the unlocking smoothness, and improving the unlocking experience.

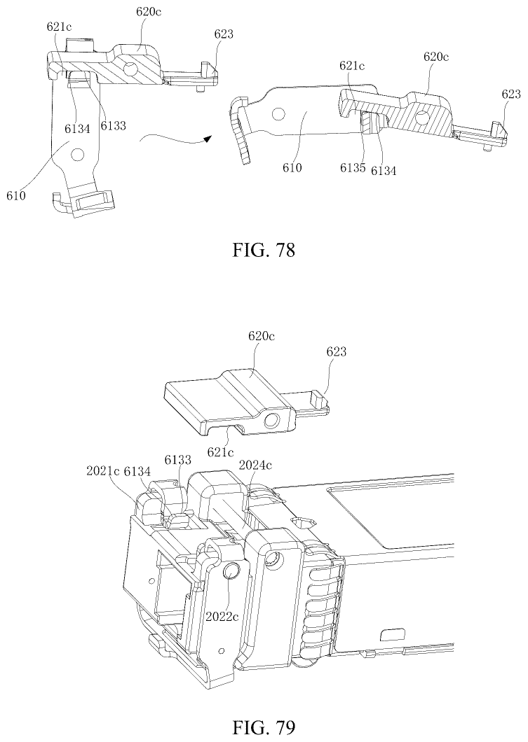

FIG. 77 is a schematic diagram of an unlocking principle of an unlocking component according to some embodiments; and FIG. 78 is a cross-sectional view of an unlocking principle of an unlocking component according to some embodiments. As shown in FIG. 77 and FIG. 78, the left and right sides of the arrow respectively correspond to the states when the optical module is in the locked state and the unlocked state. The unlocking handle 610 is pulled upward from the position thereof on the left side of the arrow, and during the pulling process, the state is gradually changed to that on the right side of the arrow. From the state on the right side of the arrow, it can be seen that in this case, the end of the unlocker 620c where the mating slot 621c is located is lifted up, and the end of the unlocker where the clamping component 623 is located descends, thereby unlocking the optical module.

The left side of the arrow corresponds to the optical module being in the locked state. In this case, the first plane 6133 of the second bent portion 613 is in contact with the surface of the mating slot 621c, and the unlocker 620c is in the horizontal state. When the optical module needs to be unlocked, the unlocking handle 610 is pulled upward. During the pulling process, the second bent portion 613 flips within the mating slot 621c. For example, the arc segment 6134 is kept tangential to the surface of the mating slot 621c. Taking a tangent point formed by tangency as the fulcrum, the second bent portion 613 is rotated. The unlocker 620c presents an inclined state, and the second bent portion gradually flips from the state where the first plane 6133 is in contact with the surface of the mating slot 621c to a state where the arc segment 6134 is in contact with the surface of the mating slot 621c, and then continues to rotate and flip until the second plane 6135 is in contact with the surface of the mating slot 621c. During these changes, the end of the unlocker 620c where the mating slot 621c is located is gradually lifted up, and the end of the unlocker where the clamping component 623 is located gradually descends. The descending height is sufficient for the clamping component 623 to disengage from the cage of the host computer, thereby unlocking the optical module. It can be seen that during the flipping process of the second bent portion 613 to implement unlocking, the arc segment 6134 is kept tangential to the surface of the mating slot 621c, thereby reducing friction during the flipping process, making the force transmission more coherent, and increasing the unlocking smoothness and improving the unlocking experience.

FIG. 79 is a structural diagram of an optical module in a locked state according to some embodiments. As shown in FIG. 79, in some embodiments, when the optical module is in the locked state, the unlocker 620c covers the surface of the first plane 6133. When the unlocking handle 610 is pulled upward from a current position thereof, the arc segment 6134 is kept tangential to the surface of the mating slot 621c. The second bent portion rotates and flips with the tangent point as the fulcrum until the second plane 6135 is in contact with the surface of the mating slot 621c. The height change exhibited during this process is generated by the flipping movement of the second bent portion 613 along the flipping trajectory thereof. This height change enables the end where the mating slot 621c is located to be lifted up and the end where the clamping component 623 is located to descend, and the descending height is sufficient for the clamping component 623 to disengage from the cage of the host computer.

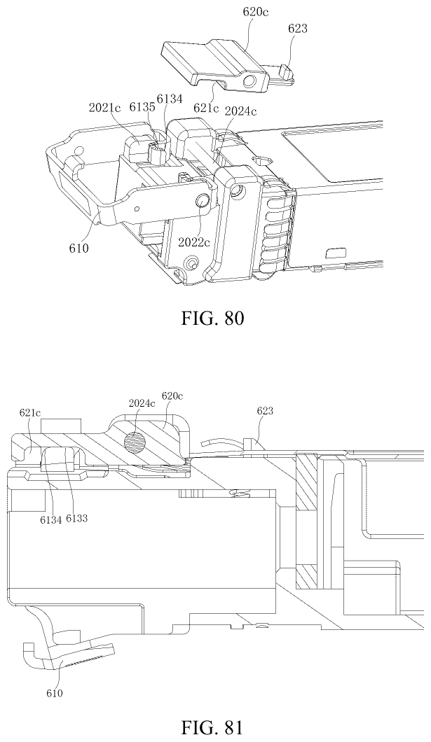

FIG. 80 is a structural diagram of an optical module in an unlocked state according to some embodiments. As shown in FIG. 81, in some embodiments, when the optical module is in the unlocked state, the second plane 6135 is in contact with the surface of the mating slot 621c. A distance from the first plane 6133 to an opposite side thereof is less than a distance from the second plane 6135 to an opposite side thereof. Therefore, during the process in which the second bent portion gradually flips from the state where the first plane 6133 is in contact with the surface of the mating slot 621c to the state where the second plane 6135 is in contact with the surface of the mating slot 621c, the height change ensures that the descending height of the clamping component 623 is sufficient for the clamping component to disengage from the cage of the host computer, successfully implementing unlocking.

FIG. 81 is a first diagram of an unlocking process of an unlocking component according to some embodiments. As shown in FIG. 181, in some embodiments, when the optical module is in the locked state, the unlocker 620c covers the surface of the first plane 6133, and the surface of the mating slot 621c is in contact with the first plane 6133. The unlocker 620c is in the horizontal state.

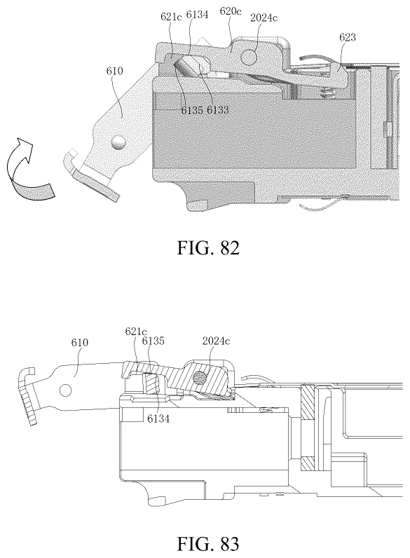

FIG. 82 is a second diagram of the unlocking process of an unlocking component according to some embodiments. As shown in FIG. 82, in some embodiments, when the unlocking handle 610 is gradually pulled upward from a current position thereof in FIG. 81, the unlocker 620c is driven to rotate along the connecting shaft 2024c, and the unlocker 620c begins to present an inclined state. For example, the second bent portion gradually flips from the state where the first plane 6133 is in contact with the surface of the mating slot 621c to the state where the arc segment 6134 is in contact with the surface of the mating slot 621c. This state still cannot cause the clamping component 623 to disengage from the cage of the host computer.

FIG. 83 is a third diagram of the unlocking process of an unlocking component according to some embodiments. As shown in FIG. 83, in some embodiments, when the unlocking handle 610 continues to be gradually pulled upward from a current position thereof as shown in FIG. 82, the unlocking handle 610 continues to drive the unlocker 620c to rotate along the connecting shaft 2024c. During this process, the arc segment 6134 remains tangent to the surface of the mating slot 621c, and the second bent portion continues to rotate and flip with the tangent point as the fulcrum until the second plane 6135 is in contact with the surface of the mating slot 621c. The height change exhibited during the rotation and flipping process is generated by the flipping movement of the second bent portion 613 along the flipping trajectory thereof. This height change enables the end where the mating slot 621c is located to be lifted up and the end where the clamping component 623 is located to descend, and the descending height is sufficient for the clamping component 623 to disengage from the cage of the host computer.

According to the unlocking component disclosed herein, when the unlocking handle is in the naturally hanging state, a plane where the unlocker is located is parallel to the surface of the upper shell, and a first plane is in contact with the surface of the mating slot. In this case, the unlocker is engaged into the cage of the host computer, thereby establishing a connection between the optical module and the host computer. When the unlocking handle is pulled upward, the second bent portion of the unlocking handle flips within the mating slot until the second plane is in contact with the surface of the mating slot. Since the distance between the second plane and the opposite side of the second plane is greater than the distance between the second plane and the connecting surface, there is a height change along the flipping trajectory. For example, the mating slot has a higher height at the end of flipping than at the beginning of flipping, and the flipping movement of the second bent portion along the flipping trajectory enables the end of the unlocker where the mating slot is located to be lifted up and the end of the unlocker where the clamping component is located to descend until the clamping component is disengaged from the cage of the host computer, thereby releasing the connection between the optical module and the host computer and unlocking the optical module. In the present disclosure, the second bent portion is formed at an end of the unlocking handle. The second bent portion flips within the mating slot, and since the distance between the second plane and the opposite side of the second plane is greater than the distance between the second plane and the connecting surface, the second bent portion presents the approximately rectangular shape, resulting in a height change along the flipping trajectory. This causes the end where the clamping component is located to descend until the clamping component is disengaged from the cage of the host computer, successfully implementing unlocking. In the present disclosure, unlocking is implemented by flipping the second bent portion in the approximately rectangular shape and with the height change along the trajectory. Meanwhile, the trajectory during the unlocking process is smooth, thereby enhancing the unlocking smoothness of the optical module and improving the unlocking experience.

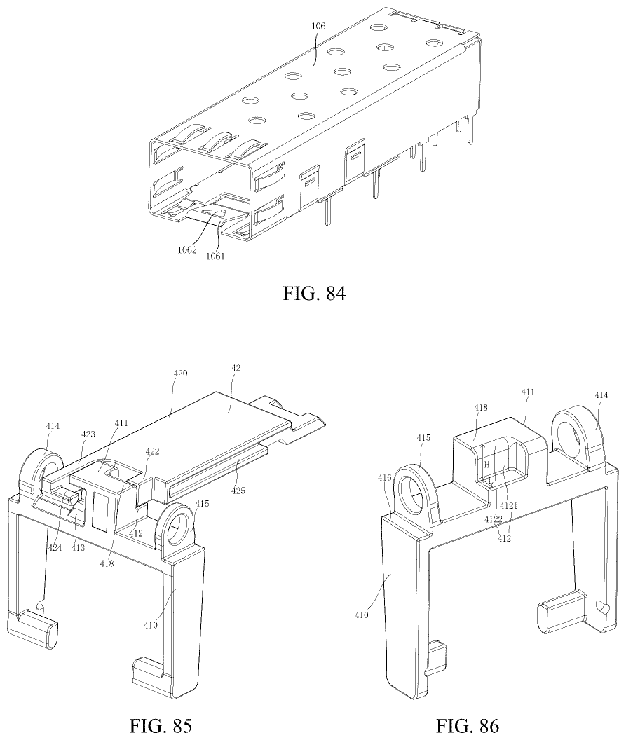

FIG. 84 is a structural diagram of an optical network terminal cage according to some embodiments. As shown in FIG. 84, in some embodiments, the cage of the host computer, such as the cage 106 of the optical network unit 100, has at its port a spring tab 1061 that matches the clamping component of the unlocking component 400. The spring tab 1061 includes a fixed end and a free end, the fixed end is configured to fix the spring tab onto the cage 106, and the free end can move up and down. A surface of the free end is provided with an engaging port 1062 that matches the clamping component 318. When the clamping component 318 is engaged into the engaging port 1062, an electrical port module 300 (in some examples, also referred to as the optical module) is fixed into the host computer, thereby locking the electrical port module 300. When the clamping component 318 is disengaged from the engaging port 1062, the electrical port module 300 is separated from the host computer, thereby unlocking the electrical port module 300.

In some embodiments, when the spring tab 1061 remains relatively stationary, the free end thereof is inclined relative to the fixed end, so the surface of the spring tab 1061 is an inclined plane. Compared to a planar spring tab, the inclined spring tab 1061 is more advantageous for unlocking the electrical port module 300.

When the electrical port module 300 is unlocked, there are various ways to release the engagement between the electrical port module 300 and the host computer. In some embodiments, the cage of the host computer remains relatively fixed and the clamping component 318 descends, causing the electrical port module 300 to actively disengage from the spring tab 1061 and be separated from the host computer. In some embodiments, the clamping component 318 remains relatively fixed, the spring tab 1061 is pushed up, causing the electrical port module 300 to passively disengage from the spring tab 1061 and be separated from the host computer. In the present disclosure, since the clamping component 318 is provided on the surface of the upper shell 310 and not on the surface of the unlocker 420, in some embodiments, the clamping component 318 remains relatively fixed and the spring tab 1061 is pushed up, thereby unlocking the electrical port module 300.

In some embodiments, when the unlocking handle 410 is in the naturally hanging state, the unlocker 420 remains relatively stationary, and there is a certain distance between the unlocker 420 and the clamping component 318. Thus, the unlocker 420 cannot act on the clamping component 318 and the spring tab 1061, nor can the unlocker disengage the clamping component from the spring tab, so the electrical port module 300 remains in the locked state.

In some embodiments, when the electrical port module 300 is unlocked, and when the unlocking handle 410 is pulled upward (that is, in the direction of the upper shell 310), the unlocker 420 can slide along the upper shell 310 toward the clamping component 318 and the spring tab 1061 under the pushing force. The sliding unlocker 420 gradually approaches the clamping component 318 and the spring tab 1061, and then gradually pushes up the spring tab 1061 until the spring tab 1061 is disengaged from the clamping component 318, thereby unlocking the electrical port module 300.

FIG. 85 is a structural diagram of an unlocking component according to some embodiments. As shown in FIG. 85, in some embodiments, the unlocking component 400 includes an unlocking handle 410 and an unlocker 420 that are interconnected. The unlocking handle 410 is rotatably connected to the upper shell 310, and the unlocker 420 is slidably connected to the upper shell 310. When the unlocking handle 410 is pulled upward along the side wall of the upper shell 310, the unlocking handle 410 rotates relative to the upper shell 310. During the rotation of the unlocking handle 410, the unlocker 420 is driven to move along a first guide rail 313 and a second guide rail 314 toward the clamping component 318 and the spring tab 1061. The gradually moving unlocker 420 slowly acts on the spring tab 1061, and slowly pushes up the spring tab 1061 until the spring tab 1061 is disengaged from the clamping component 318, and the clamping component 318 is passively disengaged from the spring tab 1061, thereby unlocking the electrical port module 300.

In some embodiments, to limit the unlocking handle 410 to the side wall of the upper shell 310, a first nesting hole 414 and a second nesting hole 415 are respectively formed in both sides of the surface of the unlocking handle 410. The first nesting hole 414 is nested on a first rotating shaft 315, and the second nesting hole 415 is nested on a second rotating shaft 316, thereby limiting the unlocking handle 410 to the side wall of the upper shell 310, and allowing the unlocking handle to rotate along the first rotating shaft 315 and the second rotating shaft 316.

In some embodiments, the unlocker 420 includes a body structure 421 provided between a first flat plate 311 and a second flat plate 312. To enable the unlocker 420 to be pushed toward the clamping component 318 and the spring tab 1061 when the unlocking handle 410 is rotated, a boss 411 is formed on the surface of the unlocking handle 410, and the boss 411 is located between the first nesting hole 414 and the second nesting hole 415. When the unlocking handle 410 is rotated, the boss 411 rotates accordingly. The boss 411 applies a pushing force to the end surface of the body structure 421 during the rotation, thereby pushing the unlocker 420 to move. This allows the unlocker 420 to gradually approach the clamping component 318 and the spring tab 1061, act on the spring tab 1061, and push up the spring tab 1061, thus unlocking the electrical port module 300. For example, to improve the smoothness of the force applied during the movement of the unlocker 420 during the rotation of the boss 411, a surface of the boss 411 that is in contact with the unlocker 420 is a smooth curved surface, thereby reducing friction between the boss and the unlocker and increasing smoothness.

In some embodiments of the present disclosure, when the boss 411 mates with the body structure 421, whether the surfaces of the boss 411 and the body structure 421 being flush affects the mating performance. Due to machining and assembly tolerances, there is a certain height difference between the surfaces of the boss 411 and the unlocker 420, which affects interaction between the boss and the unlocker. When the contact area between the boss 411 and the unlocker 420 is large, this effect is particularly pronounced. Meanwhile, when the contact area between the boss 411 and the body structure 421 is large, the force is dispersed, which is not conducive to generating an effective unlocking stroke. Therefore, in some embodiments, an end of the body structure 421 facing the unlocking handle 410 extends out of the first support arm 422. To cooperate with the first support arm 422, one surface of the boss 411 is recessed to form a notch 412. As the unlocking handle 410 is rotated, the notch 412 rotates accordingly. The notch 412 presses against the first support arm 422 during the rotation. Under this pressure, the first support arm 422 slides within the notch 412. When the first support arm 422 slips out of the notch 412, the first support arm continues to abut against the side wall 418 connected to the notch 412, causing the first support arm 422 to move toward the clamping component 318, thereby pushing the unlocker 420 to move toward the position of the spring tab 1061 and generating a certain unlocking stroke. The contact area between the first support arm 422 and the notch 412 is relatively smaller than that between the boss 411 and the body structure 421, thereby reducing the impact of non-flush surfaces of the boss 411 and the body structure 421 on their interaction. Meanwhile, the force is focused on a contact surface between the first support arm 422 and the notch 412, making the force more focused and conducive to generating an effective unlocking stroke. Meanwhile, due to the presence of the notch 412, when the electrical port module 300 is in the locked state, the unlocker 420 is closer to the unlocking handle 410 and thus farther from the clamping component 318 and the spring tab 1061. Therefore, the unlocker will not act on the spring tab 1061 or compromise the engagement between the spring tab 1061 and the clamping component 318, such that the electrical port module 300 remains in the locked state.

When the notch 412 is L-shaped, the notch has better openness, such that at the moment when the notch 412 is separated from the first support arm 422, the unlocker 420 can be disengaged from the notch 412 and is no longer restricted by the notch 412.

In some embodiments, to keep the unlocker 420 and the spring tab 1061 at a certain distance when the electrical port module 300 is in the locked state, the electrical port module 300 is unlocked, thereby compromising the current locked state. For example, when the electrical port module 300 is in the locked state, a relatively long distance is kept between the unlocker 420 and the spring tab 1061. To ensure that a relatively long distance is kept between the unlocker 420 and the spring tab 1061 when the electrical port module 300 is in the locked state, the first support arm 422 is relatively short, shortening the relative length of the unlocker 420 when the electrical port module is locked, thereby extending the distance between the unlocker and the spring tab 1061, preventing the unlocker from acting on the spring tab 1061, and keeping the electrical port module in the locked state. Correspondingly, the notch 412 is located on one side of the boss 411 facing the clamping component 318, and the notch 412 is relatively closer to the clamping component 318.

In some embodiments, a sufficient unlocking stroke should be provided when the electrical port module 300 is unlocked, such that the unlocker 420 can fully push up the spring tab 1061, and the spring tab 1061 is completely disengaged from the clamping component 318, successfully implementing unlocking. With the first support arm 422 being a short arm, when the unlocking handle 410 is pulled to a certain height, the notch 412 and the first support arm 422 are offset from each other and no longer in contact with each other, so the first support arm 422 is no longer pressed and the unlocking stroke will no longer be generated. For example, at a certain moment, the first support arm 422 will be disengaged from the notch 412, and the first support arm and the notch are disconnected, so the notch 412 will no longer continue to push the first support arm 422 to generate the unlocking stroke.

In some embodiments, to generate a continuous and sufficient unlocking stroke, one surface of the boss 411 opposite to the surface where the notch 412 is located is recessed to form a groove 413. For example, one surface of the boss 411 is recessed toward the inner direction of the boss 411 to form the notch 412, and the other surface of the boss 411 is also recessed toward the inner direction of the boss 411 to form the groove 413. The groove 413 and the notch 412 are located at diagonal positions of the boss 411, and the groove 413 is farther from the clamping component 318 than the notch 412. The recess directions of the groove 413 and the notch 412 are oppositely arranged, and opening directions thereof are different. For example, the opening of the notch 412 faces one side where the clamping component 318 is located, while the opening of the groove 413 faces away from one side where the clamping component 318 is located. To match the groove 413, a second support arm 423 further extends from an end surface of the body structure 421 facing the unlocking handle 410. For ease of extension, the second support arm 423 extends from the side wall of the body structure 421 and is provided at the side of the body structure 421. Since the slot 413 is farther from the clamping component 318 than the notch 412, that is, the groove 413 is farther from the body structure 412 than the notch 412, the second support arm 423 extends from the side wall of the body structure 421, and the end of the second support arm 423 is bent to form a bent portion 424. The second support arm 423 is relatively long. For example, the second support arm has a predetermined length, such that the bent portion 424 extends beyond the side surface of the boss 411 and reaches the position of the groove 413, thereby extending the bent portion 424 to the groove 413. For example, the second support arm 423 is connected to the bent portion 424 in a bent manner, and the end of the second support arm 423 is bent inward to form the bent portion 424.

The groove 413 is farther from the clamping component 318 than the notch 412, and correspondingly, the bent portion 424 is farther from the clamping component 318 than the first support arm 422. The second support arm 423 extends the bent portion 424 at an end thereof to the position where the groove 413 is located, thereby enabling the groove 413 to interact with the bent portion 424 and the notch 412 to interact with the first support arm 422. Since the notch 412 is closer to the clamping component than the groove 413, the length of the first support arm 422 is relatively shorter than that of the second support arm 423.

As the unlocking handle 410 is rotated, the notch 412 rotates accordingly. The rotating notch 412 applies a pressing force on the first support arm 422, thereby driving the first support arm 422 to move. With the length of the first support arm 422 being relatively short, for example, the length of the first support arm 422 is less than that of the second support arm 423, resulting in the connection between the first support arm 422 and the notch 412 being disengaged due to their relative displacement during the rotation of the notch 412. Likewise, the connection between the first support arm 422 and the side wall 418 is also disengaged due to their relative displacement. In this case, the first support arm 422 is no longer subjected to force, and the unlocker 420 can no longer continue to move. In order to completely push up the spring tab 1061 and fully disengage the spring tab 1061 from the clamping component 318, in the present disclosure, through the cooperation between the groove 413 and the bent portion 424, the bent portion 424 enters the groove 413 with the movement of the first support arm 422, the groove 413 rotates with the unlocking handle, and the inner wall of the groove 413 applies a pressing force on the bent portion 424, such that the second support arm 423 moves toward the clamping component 318. Even if the notch 412 no longer acts on the first support arm 422 to generate the unlocking stroke, the unlocking process can still continue until the spring tab 1061 is completely pushed up and the electrical port module is disengaged from the host computer.

In the present disclosure, the first support arm 422 is subjected to the pressing force from the notch 412 at the very beginning of the rotation of the unlocking handle 410, thereby driving the body structure 421 to move. During the movement of the first support arm 422, the bent portion 424 enters the groove 413. In this case, the bent portion 424 is pressed by the groove 413, driving the second support arm 423 to move. The movement of the second support arm 423 drives the body structure 421 to move. In the present disclosure, through the force applied at the first support arm 422 and the bent portion 424, a continuous unlocking stroke is generated, thereby increasing the unlocking stroke, and successfully implementing unlocking. The first support arm 422 is relatively short in length, and the second support arm 423 is configured to extend laterally past the boss 411. This design allows the first support arm 422 and the second support arm 423 to be arranged in a relatively compact manner, facilitating miniaturization of the dimensions. Meanwhile, the support arms in the locked state are located relatively far from the clamping component 318, keeping a certain distance from the clamping component 318, thereby preventing any actuation of the spring tab that could compromise the locked state. It is assumed that unlocking is implemented solely through the first support arm 422, the first support arm 422 is relatively long, which is not conducive to miniaturization of the dimensions. In addition, a considerable distance between the first support arm and the clamping component 318 cannot be kept. It is assumed that unlocking is implemented solely through the second support arm 423, the second support arm 423 is subjected to force at the very beginning of the rotation of the unlocking handle 410, which is not conducive to generating a longer unlocking stroke. In the present disclosure, a progressive unlocking stroke is generated through the progressive force applied to the relatively short first support arm 422 and the second support arm 423 extending from the side surface, which provides a continuous and sufficient unlocking stroke. The present disclosure features ingenious design, facilitating miniaturization of the dimensions and generating a longer unlocking stroke, thereby implementing complete unlocking. In some embodiments, progressive unlocking can be configured such that the bent portion 424 is subjected to force at the moment when the first support arm 422 ceases to be subjected to force. In some embodiments, the progressive unlocking can also be configured such that the bent portion 424 has begun to be subjected to force before the first support arm 422 ceases to be subjected to force.

The groove 413 may be U-shaped, providing better enclosure to prevent the bent portion 424 from slipping out of the groove 413, increasing the duration of movement of the bent portion 424 within the groove 413, thereby generating a longer unlocking stroke, and completely unlocking the electrical port module 300.

When the electrical port module 300 is in the locked state, the bent portion 424 is not in contact with the groove 413, thereby keeping the electrical port module 300 in the locked state. When the unlocking handle 410 is rotated to a certain height, the bent portion 424 begins to contact the groove 413. As the unlocking handle 410 continues to be rotated, the pressing force between the groove 413 and the bent portion 424 drives the unlocker 420 to move toward the clamping component 318 and the spring tab 1061, thereby increasing the unlocking stroke and providing the continuous and sufficient unlocking stroke until the spring tab 1061 is completely pushed up and the electrical port module is disengaged from the host computer.

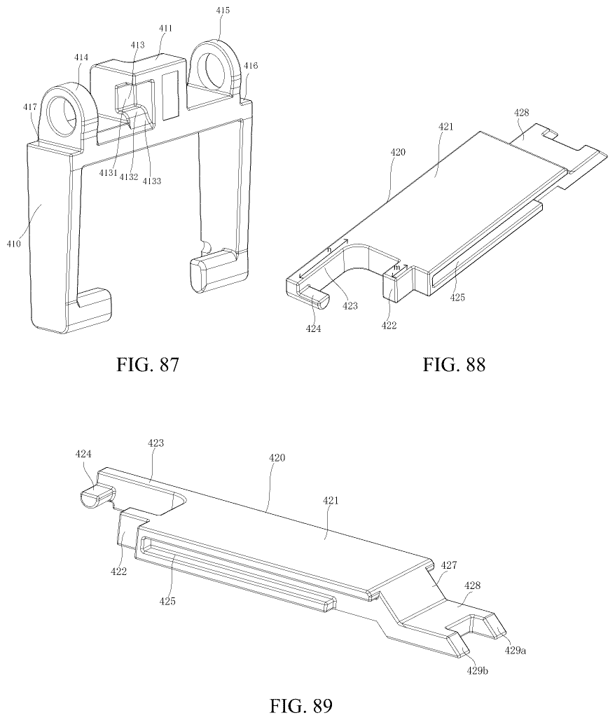

FIG. 86 is a first structural diagram of an unlocking handle according to some embodiments; and FIG. 87 is a second structural diagram of an unlocking handle according to some embodiments. As shown in FIG. 86 and FIG. 87, in some embodiments, the unlocking handle 410 includes a fixed end and a free end. The fixed end is fixed onto the upper shell 310 and is the end of the unlocking handle 410 that is connected to the upper shell 310. The notches 412 and the grooves 413 are respectively formed in both sides of the end. The free end of the unlocking handle 410 is freely arranged relative to the upper shell 310. When the free end is pulled upward, the unlocking handle 410 is rotated along the side wall of the upper shell 310. The boss 411 is located at the fixed end of the unlocking handle 410. The notches 412 and the grooves 413 are respectively provided on two different surfaces of the boss 411. For example, the notches 412 are located farther from the clamping component relative to the grooves 413.

To limit the unlocking handle 410 to the side wall of the upper shell 310, the first nesting hole 414 and the second nesting hole 415 are respectively formed in both sides of the surface of the fixed end of the unlocking handle 410. The first nesting hole 414 is nested on a first rotating shaft 315, and the second nesting hole 415 is nested on a second rotating shaft 316, thereby limiting the unlocking handle 410 to the side wall of the upper shell 310, and allowing the unlocking handle 410 to rotate along the first rotating shaft 315 and the second rotating shaft 316. To avoid interference with some structures, a first avoidance portion 416 is formed on one side of the second nesting hole 415, and a second avoidance portion 417 is formed on one side of the first nesting hole 414.

In some embodiments, to improve the unlocking smoothness, the notch 412 includes a first accommodating cavity 4121 and a first rounded corner 4122. The first accommodating cavity 4121 is configured to accommodate the first support arm 422, and the first rounded corner 4122 is located at the top end of the first accommodating cavity 4121. As the unlocking handle 410 is rotated, the opening of the notch 412 rotates downward. During the rotation, the first rounded corner 4122 is in contact with the first support arm 422, and the inner wall of the notch 412 presses against the first support arm 422. During the pulling process, the first rounded corner 4122 makes tangential contact with the first support arm 422 and pushes the unlocker 420 forward by taking the tangent point of the first rounded corner and the first support arm as the fulcrum. “Pushing the unlocker 420 forward” refers to pushing the unlocker 420 in the direction where the clamping component 318 and the spring tab 1061 are located. When the first rounded corner 4122 is separated from the first support arm 422, the side wall 418 connected to the notch 412 abuts against the first support arm 422 until the side wall 418 is separated from the first support arm. In this case, the first support arm 422 is no longer subjected to force and thus cannot drive the body structure to move. Due to the smooth surface of the first rounded corner 4122, a friction force during the tangential movement between the first rounded corner 4122 and the first support arm 422 is reduced, resulting in smoother movement and a more seamless unlocking process.

In some embodiments, to enhance the unlocking smoothness, the groove 413 includes a second accommodating cavity 4131, a second rounded corner 4132, and a curved surface 4133. As the unlocking handle 410 is rotated, the opening of the groove 413 rotates upward, and the curved surface 4133 comes into contact with the bent portion 424. The curved surface 4133 presses against the bent portion 424, thereby pushing the bent portion 424 to move toward the second rounded corner 4132. As the unlocking handle 410 continues to be rotated, the bent portion 424 comes into contact with the second rounded corner 4132 and performs a tangential movement therewith. Taking the tangent point of the bent portion and the second rounded corner as the fulcrum, the bent portion 424 is moved toward the second accommodating cavity 4131. The second accommodating cavity 4131 presses against the bent portion 424, such that the bent portion 424 pushes the unlocker 420 toward the direction of the clamping component 318 and the spring tab 1061. This process continues until the unlocker 420 completely pushes up the spring tab 1061, fully disengaging the spring tab 1061 from the clamping component 318, thus releasing the engagement between the electrical port module 300 and the host computer and disengaging the electrical port module 300 from the host computer to unlock the electrical port module 300.

In some embodiments, to ensure that the unlocking stroke is generated when the notch 412 presses against the first support arm 422, the dimension of the inner wall of the notch 412 along the height direction of the upper shell 310 is greater than the dimension of the inner wall of the notch 412 along the length direction of the upper shell 310. The dimension of the inner wall of the notch 412 along the height direction of the upper shell 310 corresponds to segment H labeled in FIG. 86, and the dimension of the inner wall of the notch 412 along the length direction of the upper shell 310 corresponds to segment L labeled in FIG. 86. When the length of the segment H is greater than the length of the segment L, the rotation of the notch 412 causes the first support arm 422 to displace, generating a certain unlocking stroke. In some embodiments, the notch 412 is L-shaped and includes a vertical inner wall and a horizontal inner wall. For example, the dimension of the vertical inner wall is greater than that of the horizontal inner wall, thereby facilitating the forward sliding of the first support arm 422.

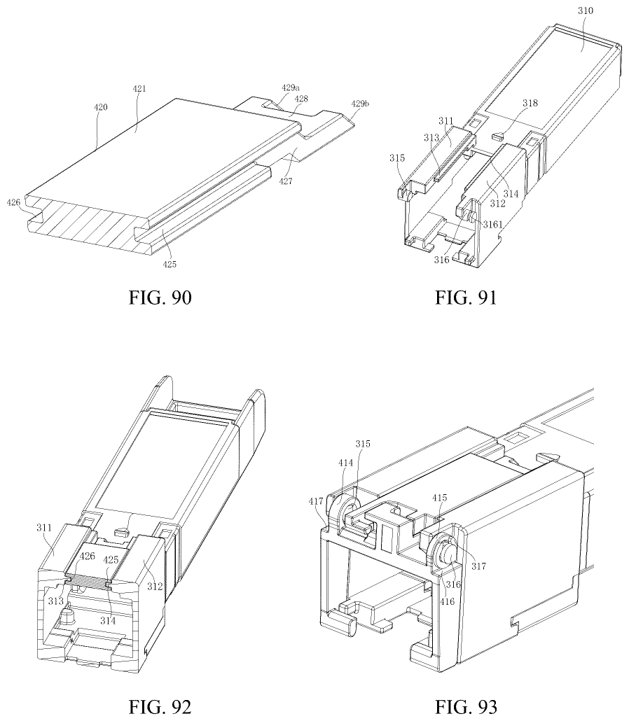

FIG. 88 is a first structural diagram of an unlocker according to some embodiments; FIG. 89 is a second structural diagram of an unlocker according to some embodiments; and FIG. 90 is a cross-sectional structural diagram of an unlocker according to some embodiments. As shown in FIG. 88 to FIG. 90, in some embodiments, the bent portion 424 is a hemispherical support arm, where the top surface of the bent portion 424 is a flat surface and a hemispherical surface is formed downward around the top surface, thereby making the force bearing surface between the bent portion 424 and the groove 413 more concentrated, and avoiding the presence of other force bearing surfaces.

In some embodiments, both the second support arm 423 and the first support arm 422 extend from the end surface of the body structure 421. For example, a relative extension length of the second support arm 423 is greater than that of the first support arm 422. The long extension length of the second support arm 423 ensures that the bent portion 424 can pass over the side surface of the boss 411 and extend to the groove 413. The relative extension length of the second support arm 423 is indicated by segment n in FIG. 9, and the relative extension length of the first support arm 422 is indicated by segment m in FIG. 88. Obviously, the length of the segment n is greater than the length of the segment m. The present disclosure implements a progressive unlocking path through two support arms of different extension lengths, facilitating miniaturization of the dimensions and providing a longer unlocking stroke.

In some embodiments, the extension directions of the first support arm 422 and the bent portion 424 are different. The extension direction of the first support arm 422 is consistent with the length direction of the body structure 421, while the extension direction of the bent portion 424 is consistent with the width direction of the body structure 421.

In some embodiments, the lengths of the first support arm 422 and the second support arm 423 can be designed according to the expected unlocking stroke, thereby achieving the expected unlocking stroke and fully unlocking the electrical port module 300.

In some embodiments, to enable the unlocker 420 to slide along the upper shell 310 and thus move toward the clamping component 318 and the spring tab 1061, a first sliding slot 426 and a second sliding slot 425 are respectively formed in both sides of the body structure 421. As described above, one end surface of the upper shell 310 close to the optical port is disconnected, such that a first flat plate 311 and a second flat plate 312 are formed respectively on both sides. The first flat plate 311 and the second flat plate 312 are arranged opposite each other and are not connected, between which a gap 319 is provided to accommodate the unlocker 420. The first guide rail 313 is formed on the side wall of the first flat plate 311 facing the gap 319, and the second guide rail 314 is formed on the side wall of the second flat plate 312 facing the gap 319. The first sliding slot 426 is slidably connected to the first guide rail 313, and the second sliding slot 425 is slidably connected to the second guide rail 314. Therefore, when the unlocking handle 410 is pulled upward, under the pushing force, the first sliding slot 426 slides along the first guide rail 313 toward the clamping component 318 and the spring tab 1061, and the second sliding slot 425 slides along the second guide rail 314 toward the clamping component 318 and the spring tab 1061, thereby enabling the unlocker 420 to act on the surface of the spring tab 1061 and push up the spring tab 1061, and unlocking the electrical port module 300. For example, the lengths of the first sliding slot 426 and the second sliding slot 425 depend on the unlocking stroke required to unlock the electrical port module 300.

To prevent the electrical port module 300 in the locked state from being unlocked, a certain distance should be kept between the electrical port module 300 and the clamping component 318. Thus, the unlocker 420 should have a preset length. To ensure the unlocking stroke, the first sliding slot 426 and the second sliding slot 425 should also have preset lengths, which limits the length available for the first support arm 422. The end of the first support arm 422 is connected to the surface of the boss 411, so the first support arm 422 is limited between the boss 411 and the body structure 421, resulting in the first support arm 422 having a relatively short set length and thus being defined as a short arm. Meanwhile, to extend the distance between the unlocker 420 and the clamping component 318 when the electrical port module 300 is in the locked state, it is necessary to ensure that the unlocker 420 is located closer to the unlocking handle 410, and the set length of the first support arm 422 cannot be too long. Therefore, from both the mechanical arrangement and the unlocking principle, the length of the first support arm 422 cannot be too long.

In some embodiments, the first support arm 422 and the bent portion 424 are respectively formed on one end of the body structure 421, while a connecting plane 428 is formed on the other end thereof. A first inclined surface 429a and a second inclined surface 429b are respectively formed on two ends of the connecting plane 428. When the electrical port module 300 needs to be unlocked, the unlocking handle 420 is rotated to drive the unlocker 420 to move toward a position where the clamping component 318 and the spring tab 1061 are located. The first inclined surface 429a and the second inclined surface 429b also move toward the position where the clamping component 318 and the spring tab 1061 are located. During movement, the first inclined surface 429a and the second inclined surface 429b are in contact with respectively both sides of the spring tab 1061. The pushing force applied by the unlocking handle 410 acts on the first inclined surface 429a and the second inclined surface 429b. According to the resolution of the force, the pushing force on the first inclined surface 429a and the second inclined surface 429b can be resolved into mutually perpendicular horizontal component force and vertical component force. Under the horizontal component, the unlocker 420 moves forward; under the vertical component, the spring tab 1061 is pushed up. As the unlocking handle 410 is rotated, the unlocker 420 is pushed forward. During the pushing process, the first inclined surface 429a and the second inclined surface 429b are in contact with and act on the spring tab 1061. The contact surfaces between the two inclined surfaces and the spring tab 1061 are gradually lifted up as the unlocker 420 moves forward, so the free end of the spring tab 1061 can be pushed up through the contact surfaces gradually lifted up until the spring tab 1061 is disengaged from the clamping component 318. Meanwhile, for example, the first inclined surface 429a and the second inclined surface 429b are not connected and have a certain gap to avoid the clamping component 318 when the spring tab is disengaged from the clamping component 318.

In some embodiments, the spring tab 1061 is inclined. For example, a height of the free end of the spring tab 1061 is higher than a height of the fixed end of the spring tab 1061. To ensure that the first inclined surface 429a and the second inclined surface 429b come into contact with the spring tab 1061 from a bottom thereof and act on the spring tab 1061, a height of the connecting plane 428 should be lower than a height of the body structure 421, such that the surfaces of the first inclined surface 429a and the second inclined surface 429b are set lower, enabling the first inclined surface 429a and the second inclined surface 429b to contact the spring tab 1061 from the very beginning, and extending the duration of contact of the first inclined surface and the second inclined surface with the spring tab 1061. This ensures that the spring tab 1061 is effectively and fully pushed up until the spring tab 1061 is disengaged from the clamping component 318, thus unlocking the electrical port module 300 from the host computer. To this end, a connecting inclined surface 427 is provided between the body structure 421 and the connecting plane 428. The body structure 421 and the connecting plane 428 are connected through the connecting inclined surface 427, thereby effectively acting on the spring tab 1061. For example, the connecting inclined surface 427 is inclined such that the surface of the body structure 421 is higher than that of the connecting plane 428. The inclination angle of the connecting inclined surface 427 can be determined according to the position of the clamping component 318.

FIG. 91 is a structural diagram of an upper shell according to some embodiments. As shown in FIG. 91, in some embodiments, the first rotating shaft 315 is formed on one side of the first flat plate 311, and a second rotating shaft 316 is formed on one side of the second flat plate 312. Both the first rotating shaft 315 and the second rotating shaft 316 are bent and extend from the side wall of the upper shell 310, and for example, both extend in a same direction, to facilitate nesting of the unlocking handle 410. To limit the unlocking handle 410, a limiting slot 3161 is formed on the second rotating shaft 316, and a limiting structure is provided on the surface of the limiting slot 3161 to limit and fix the unlocking handle 410. For example, the limiting structure may be a limiting plate.

FIG. 92 is a cross-sectional view of an electrical port module according to some embodiments. As shown in FIG. 92, in some embodiments, the body structure 421 of the unlocker 420 is provided between the first flat plate 311 and the second flat plate 312. The first guide rail 313 is formed on the side wall of the first flat plate 311 facing the gap 319, and the second guide rail 314 is formed on the side wall of the second flat plate 312 facing the gap 319. A first sliding slot 426 and a second sliding slot 425 are respectively formed in both sides of the body structure 421. The first sliding slot 426 is slidably connected to the first guide rail 313, and the second sliding slot 425 is slidably connected to the second guide rail 314. Therefore, when the unlocking handle 410 is pulled upward, under the pushing force, the first sliding slot 426 slides along the first guide rail 313 toward the clamping component 318 and the spring tab 1061, and the second sliding slot 425 slides along the second guide rail 314 toward the clamping component 318 and the spring tab 1061, thereby enabling the unlocker 420 to act on the surface of the spring tab 1061 and push up the spring tab 1061, and unlocking the electrical port module 300.

FIG. 93 is a structural diagram of an electrical port module end according to some embodiments. As shown in FIG. 93, in some embodiments, to limit the unlocking handle 410, a limiting slot 3161 is formed in a second rotating shaft 316, and a limiting plate 317 is provided on the surface of the limiting slot 3161 to limit the unlocking handle 410 to the upper shell 310 and prevent the unlocking handle 410 from slipping out of the upper shell 310.

The first avoidance portion 416 is formed on one side of the second nesting hole 415 for avoiding the limiting plate 317; and the second avoidance portion 417 is formed on one side of the first nesting hole 414 for avoiding the side wall of the upper shell 310.

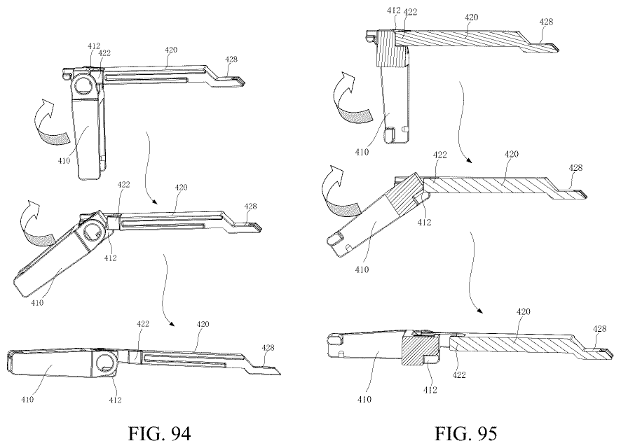

FIG. 94 is a diagram of an unlocking process of an unlocking component according to some embodiments. As shown in FIG. 94, in some embodiments, when the unlocking handle 410 is rotated upward, the unlocking handle 410 pushes the unlocker 420 to move forward so as to approach the clamping component 318 and the spring tab 1061, and the first inclined surface 429a of the unlocker 420 and the second inclined surface 429b of the unlocker are in contact with respectively both sides of the spring tab 1061. During the forward movement of the unlocker 420, the surfaces of the first inclined surface 429a and the second inclined surface 429b gradually act on the spring tab 1061, and the contact surfaces gradually lifted up can push up the free end of the spring tab 1061 until the spring tab 1061 is disengaged from the clamping component 318, thereby unlocking the electrical port module 300. “Forward movement” refers to the movement of the unlocker 420 toward the position where the clamping component 318 is located.

When the unlocking handle 410 is in the naturally hanging state, the electrical port module 300 is inserted into the cage of the host computer. In this case, the distance between the unlocker 420 and the spring tab 1061 is relatively large, so the unlocker cannot act on the spring tab 1061, and the electrical port module 300 is kept in the locked state. When the unlocking handle 410 is pulled to a higher position, the unlocker 420 is in contact with and acts on the spring tab 1061 until the spring tab 1061 is pushed up, thereby unlocking the electrical port module 300.

FIG. 95 is a first schematic diagram of an unlocking principle of an unlocking component according to some embodiments. As shown in FIG. 95, the illustrated process is an interaction process between the notch 412 and the first support arm 422 during the unlocking process when the unlocking handle 410 is pulled. When the unlocking handle 410 is not pulled, the first support arm 422 is provided within the notch 412 to maintain the stability of the unlocker 420. As the unlocking handle 410 is gradually lifted up, the opening of the notch 412 moves downward. During this movement, the first rounded corner 4122 of the notch 412 pushes the first support arm 422 forward, and the notch 412 applies the pressing force on the first support arm 422. Under the pressing force, the first support arm 422 moves forward until the first support arm 422 is disengaged from the notch 412, and then continues to move forward by abutting against the side wall 418. When the first support arm 422 is no longer in contact with the side wall 418, it is no longer pressed and cannot continue to push the first support arm 422 forward. For example, the connection between the notch 412 and the first support arm 422 may be disconnected at a certain moment due to vertical misalignment (when the first arm 422 is located obliquely above the notch 412), thus failing to continuously push the unlocker 420 forward.

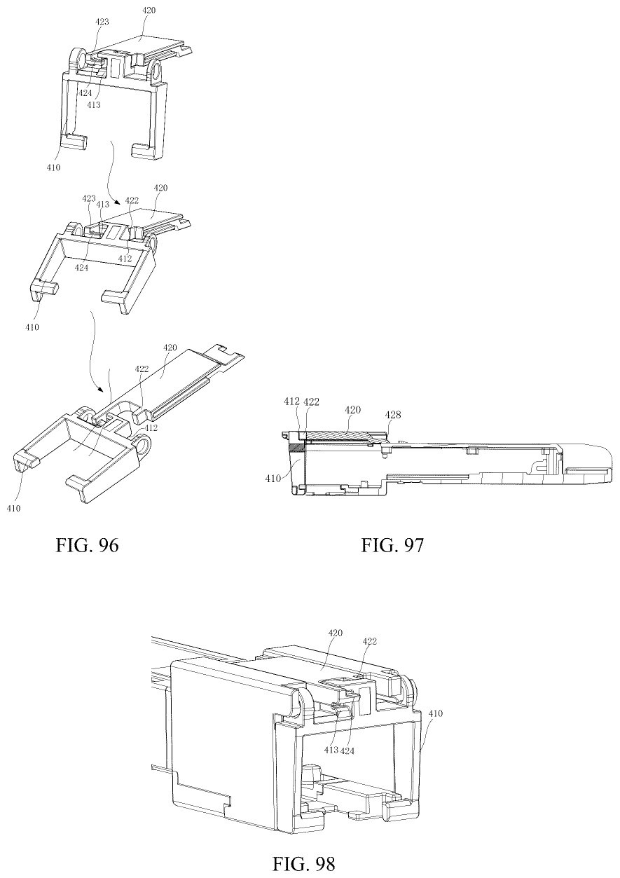

FIG. 96 is a second schematic diagram of an unlocking principle of an unlocking component according to some embodiments. As shown in FIG. 96, the illustrated process is an interaction process between the groove 413 and the bent portion 424 during the unlocking process when the unlocking handle 410 is pulled. When the unlocking handle 410 is not pulled, the groove 413 and the bent portion 424 cannot come into contact with each other; otherwise, a certain unlocking stroke will be generated for the electrical port module 300, compromising the locked state of the electrical port module 300. As the unlocking handle 410 is gradually lifted up, the opening of the groove 413 rotates upward, and the curved surface 4133 comes into contact with the bent portion 424, pushing the bent portion 424 toward the second rounded corner 4132. As the unlocking handle 410 continues to be rotated, the bent portion 424 comes into contact with the second rounded corner 4132 and performs a tangential movement therewith. Taking the tangent point of the bent portion and the second rounded corner as the fulcrum, the bent portion 424 is moved toward the second accommodating cavity 4131. The rotating second accommodating cavity 4131 applies the pressing force on the bent portion 424, thereby causing the second support arm 423 to move forward and driving the body structure 421 to move. This process continues until the unlocker 420 completely pushes up the spring tab 1061, fully disengaging the spring tab 1061 from the clamping component 318, thus releasing the engagement between the electrical port module 300 and the host computer and disengaging the electrical port module 300 from the host computer to unlock the electrical port module 300.

In some embodiments, as the unlocking handle 410 is gradually lifted up, the curved surface 4133 comes into contact with the bent portion 424. In this case, the first support arm 422 is still connected to the notch 412, that is, the moment at which the notch 412 is disconnected from the first support arm 422 is later than the moment when the curved surface 4133 comes into contact with the bent portion 424, so as to ensure the continuity of the unlocking process.

FIG. 97 is a first diagram of an initial unlocking state of an unlocking component according to some embodiments; and FIG. 98 is a second diagram of an initial unlocking state of an unlocking component according to some embodiments. As shown in FIG. 97 and FIG. 98, when the unlocking handle 410 is not pulled, the first support arm 422 is provided within the notch 412 to maintain the stability of the unlocker 420. When the unlocking handle 410 is not pulled, the groove 413 and the bent portion 424 cannot come into contact with each other; otherwise, a certain unlocking stroke will be generated for the electrical port module 300, compromising the locked state of the electrical port module 300.

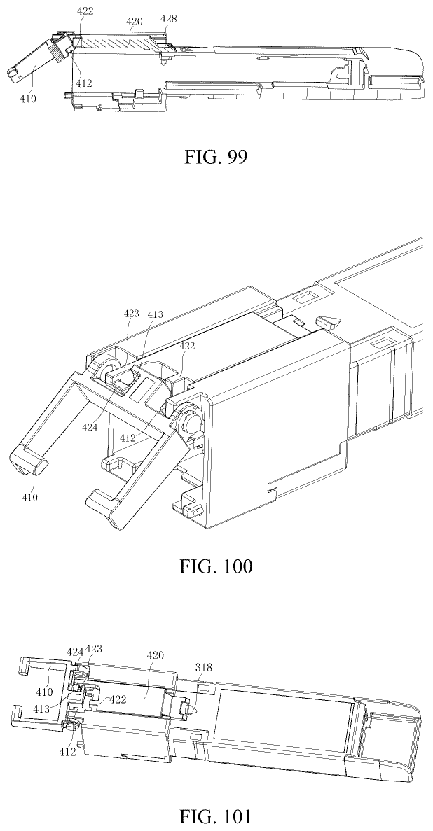

FIG. 99 is a first diagram of an intermediate unlocking state of an unlocking component according to some embodiments; and FIG. 100 is a second diagram of an intermediate unlocking state of an unlocking component according to some embodiments. As shown in FIG. 99 and FIG. 100, as the unlocking handle 410 is rotated, the opening of the groove 413 rotates upward, and the curved surface 4133 comes into contact with the bent portion 424. The curved surface 4133 presses against the bent portion 424, thereby pushing the bent portion 424 to move toward the second rounded corner 4132. As the unlocking handle 410 continues to be rotated, the bent portion 424 comes into contact with the second rounded corner 4132 and performs a tangential movement therewith. Taking the tangent point of the bent portion and the second rounded corner as the fulcrum, the bent portion 424 is moved toward the second accommodating cavity 4131. The second accommodating cavity 4131 presses against the bent portion 424, such that the bent portion 424 pushes the unlocker 420 toward the direction of the clamping component 318 and the spring tab 1061.

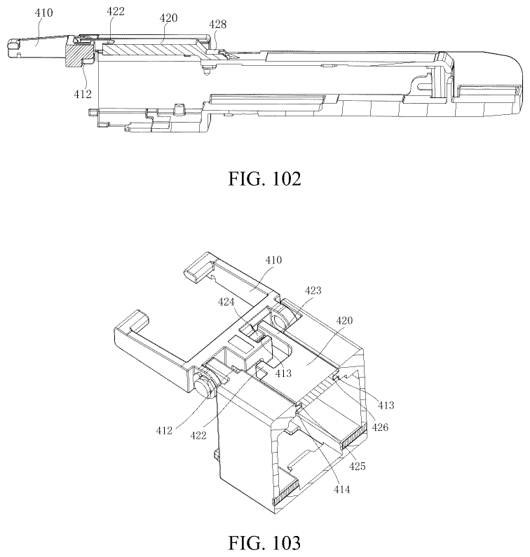

FIG. 101 is a first diagram of a final unlocking state of an unlocking component according to some embodiments; FIG. 102 is a second diagram of a final unlocking state of an unlocking component according to some embodiments; and FIG. 103 is a third diagram of a final unlocking state of an unlocking component according to some embodiments. As shown in FIG. 101 to FIG. 103, upon completion of unlocking, the bent portion 424 is located within the groove 413. In this case, the first support arm 422 has already been disconnected from the notch 412 and is no longer connected.

The electrical port module provided in the present disclosure includes the upper shell and the unlocking component. The surface of the upper shell is provided with the clamping component, and engaged with the spring tab of the host computer through the clamping component, such that the electrical port module is engaged with the host computer. The unlocking component includes the unlocking handle and the unlocker, where the unlocking handle is provided at the end of the upper shell and is rotatably connected to the upper shell. The notch is formed at one end of the unlocking handle, and the groove is formed at the other end thereof. Both the notch and the groove rotate with the unlocking handle. The unlocker is slidably connected to the upper shell and includes the body structure. The body structure extends toward the end face of the unlocking handle to respectively form the first support arm and the second support arm. The first support arm is provided within the notch, and the second support arm includes an extension arm and a bent portion formed by bending the end of the extension arm. The notch applies pressure to the first support arm during rotation, such that the first support arm slides along the inner wall of the notch until it slips out of the notch, and then continues to abut against the side wall connected to the notch, driving the first support arm to move toward the clamping component. When the electrical port module is in the locked state, the first support arm is provided within the notch. To prevent the unlocker from acting on the spring tab and the clamping component, the first support arm is relatively short in length, such that the unlocker is kept as far away as possible from the spring tab and the clamping component in the current state and kept in the current locked state. When the first support arm is relatively short, during movement, the first support arm is disconnected to the notch due to misalignment, and even the first support arm is disconnected to the side wall abutting against the first support arm due to misalignment, thereby resulting in the first support arm no longer being pressed and no longer generating an unlocking stroke. Therefore, as the first support arm moves, the bent portion of the second support arm enters the groove. During the rotation of the groove, the inner wall of the groove presses against the bent portion, such that the second support arm moves toward the clamping component and continues to generate the unlocking stroke until the spring tab is pushed up, and the clamping component is disengaged from the spring tab, releasing the engagement between the electrical port module and the host computer. In the present disclosure, the first support arm and the second support arm are respectively subjected to force, providing a continuous and sufficient unlocking stroke to completely disengage the electrical port module from the host computer, thereby unlocking the electrical port module. It can be understood that the optical module is a type of electrical port module, and the unlocking component provided in the present disclosure is also applicable to optical modules, that is, the optical module may also be the unlocking component provided in the present disclosure.

Finally, it should be noted that the above embodiments are provided merely to illustrate the technical solutions of the present disclosure and not to limit them. Although the present disclosure has been described in detail with reference to the aforementioned embodiments, those of ordinary skill in the art should understand that they can still make modifications on the technical solutions described in the aforementioned embodiments or make equivalent replacements on some of the technical features; and these modifications or replacements do not make the essence of the corresponding technical solutions depart from the spirit and scope of the technical solutions of the various embodiments of the present disclosure.

What is claimed is:

1. An optical module, comprising:
an upper shell;
a lower shell, covering the upper shell to form a shell, wherein one of the upper shell and the lower shell is provided with a support plate, a support surface is formed on the support plate, an assembly mechanism is provided on the support surface, the support surface is provided with a clamping component, the clamping component protrudes from the support surface, and an unlocking surface is provided on a side of the clamping component and is lower than a top surface of the clamping component; and
an unlocking component, comprising an assembly portion and an unlocking portion, wherein one end of the unlocking portion is in assembly connection with the assembly part, the assembly part is connected to the assembly mechanism and is movable relative to the assembly mechanism, the unlocking portion is located on a side of the clamping component, and the unlocking surface is configured to abut against the unlocking portion;
a movable gap for the unlocking component to move is provided between the assembly mechanism and the support surface; a first protruding portion is provided on one side of the assembly mechanism facing the unlocking component; and in a reset process of the unlocking component, the first protruding portion is configured to selectively abut against the unlocking component, such that the first protruding portion pushes the unlocking component to move toward the lower shell.

2. The optical module according to claim 1, wherein
the lower shell covers the upper shell to form an accommodating cavity, a circuit board and an optical transceiver component are provided within the accommodating cavity, and the optical transceiver component is electrically connected to the circuit board; and the lower shell comprises:
a first wall surface; and
a second wall surface, connected to one end of the first wall surface and recessed relative to the first wall surface, wherein a locking portion is provided on the second wall surface, the locking portion is configured to establish a locking relationship with an exterior, and the clamping component comprises the locking portion; and
the unlocking component is movably provided in the lower shell along a length direction of the lower shell and extends from the first wall surface to the second wall surface, and the unlocking component comprises:
a body, provided on the first wall surface, wherein the body is connected to the assembly portion;
an ejector member, connected to one end of the body and inclined relative to the body, wherein the assembly portion comprises the ejector member; and
a force applying member, connected to one end of the ejector member facing the locking portion, wherein when the unlocking component moves toward the first wall surface, the ejector member moves from the second wall surface toward the first wall surface, such that the force applying member moves away from the lower shell to unlock the locking relationship between the locking portion and the exterior; and the unlocking portion comprises the force applying member; and
the assembly mechanism comprises:
an outer cover plate, wherein the outer cover plate covers the first wall surface and is located on one side of the unlocking component facing away from the lower shell.

3. The optical module according to claim 2, wherein when the unlocking component moves toward the first wall surface to a first preset position, the ejector member is separated from the first protruding portion; when the unlocking component moves toward the second wall surface to a first preset position, the first protruding portion abuts against the ejector member, such that the first protruding portion pushes the unlocking component to move toward the lower shell; and when the unlocking component is in a reset state, a vertical distance between the first protruding portion and the second wall surface is less than a vertical distance between a surface of the body facing away from one side of the second wall surface and the second wall surface;
or when the unlocking component is in a reset state, the first protruding portion is in interference fit with the unlocking component.

4. The optical module according to claim 2, wherein the outer cover plate comprises:
a cover plate body, covering the side of the unlocking component facing away from the lower shell; and
a first extension portion, extending toward the second wall surface; and
the first protruding portion comprises:
a first bent portion, bent from one end of the first extension portion facing the second wall surface toward the lower shell, and fitted against an inner wall surface of the first extension portion; and
a second bent portion, bent from the first bent portion toward the lower shell, and configured to abut against the ejector member.

5. The optical module according to claim 4, wherein the second bent portion comprises:
a first sub-bent section, bent from the first bent portion toward the lower shell; and
a second sub-bent section, bent from the first sub-bent section facing away from the lower shell, wherein an arc-shaped bent portion is formed at a connection between the second sub-bent section and the first sub-bent section, and the arc-shaped bent portion is configured to abut against the ejector member.

6. The optical module according to claim 4, wherein a width of the first extension portion is less than a width of the cover plate body, and a width of the second bent portion is less than the width of the first extension portion;
the second bent portion has a first side wall surface and a second side wall surface that are opposite along a width direction; the first bent portion has a third side wall surface and a fourth side wall surface; a first notch is provided between the third side wall surface and the first side wall surface, and a second notch is provided between the fourth side wall surface and the second side wall surface; and the first notch and the second notch are configured to release a bending stress between the second bent portion and the first bent portion.

7. The optical module according to claim 6, wherein the lower shell further comprises a third wall surface, the third wall surface is connected between the first wall surface and the second wall surface, and the third wall surface is configured to abut against a shell of a host computer;
the first wall surface comprises: a first bottom plate, a first side plate, and a second side plate, and the first side plate and the second side plate are oppositely arranged on both sides of the first bottom plate;
an outer surface of the first bottom plate is provided with a first recessed portion and a second recessed portion, the second recessed portion is recessed relative to the first recessed portion and penetrates to the third wall surface, and the unlocking component is provided within the second recessed portion;
the first recessed portion comprises a first sub-recessed portion and a second sub-recessed portion, the first sub-recessed portion is in communication with the second recessed portion, the second sub-recessed portion extends to the third wall surface, and the second sub-recessed portion is in communication with the first sub-recessed portion, the second recessed portion, and the third wall surface; and
the cover plate body is embedded within the first sub-recessed portion, the first extension portion is embedded within the second sub-recessed portion, and the second bent portion is embedded within the second recessed portion.

8. The optical module according to claim 7, wherein the second recessed portion has a first bottom wall surface and an ejector wall surface; the first bottom wall surface protrudes from the second wall surface, the ejector wall surface is connected between the first bottom wall surface and the second wall surface, and the ejector wall surface is inclined; and
a first angle is provided between the ejector wall surface and the second wall surface, a second angle is provided between the ejector member and the second wall surface, and the first angle is greater than the second angle, such that when the unlocking component moves toward the first wall surface, one end of the ejector member facing the second wall surface abuts against the ejector wall surface,
wherein the first angle is 150°-160°, and the second angle is 135°-150°.

9. The optical module according to claim 8, wherein a limiting post is provided on the first bottom plate;
an accommodating through hole is provided on the unlocking component, the limiting post passes through the accommodating through hole, and the limiting post is located at one end of the accommodating through hole facing away from the second wall surface; a positioning post is provided at one end of the accommodating through hole facing the second wall surface; a reset member is provided within the accommodating through hole, one end of the reset member is connected to the positioning post, and the other end of the reset member is connected to the limiting post; and when the unlocking component moves away from the second wall surface, the reset member provides a reset force toward the second wall surface to the unlocking component, such that when an external force on the unlocking component disappears, the reset member drives the unlocking component to move toward the second wall surface,
wherein the second recessed portion comprises the first bottom wall surface, a first limiting wall surface, and a second limiting wall surface, the first limiting wall surface and the second limiting wall surface are oppositely arranged on both sides of the first bottom wall surface along a width direction, the first limiting wall surface is recessed to form a first limiting slot, and a first sub-bottom wall surface of the first limiting slot is recessed relative to the first bottom wall surface; the second limiting wall surface is recessed to form a second limiting slot, and a second sub-bottom wall surface of the second limiting slot is recessed relative to the first bottom wall surface; and the first limiting slot and the second limiting slot are located on both sides of the limiting post, and the body is limited between the first limiting wall surface and the second limiting wall surface; and
the unlocking component further comprises:
a first limiting support arm, wherein the first limiting support arm protrudes from the body and is located on one side of the accommodating through hole; the first limiting support arm comprises a first limiting extension arm and a first limiting bending arm, the first limiting extension arm extends to the first limiting slot along a width direction of the body, and the first limiting bending arm is bent toward the first sub-bottom wall surface; and
a second limiting support arm, wherein the second limiting support arm protrudes from the body and is located on the other side of the accommodating through hole; the second limiting support arm comprises a second limiting extension arm and a second limiting bending arm, the second limiting extension arm extends to the second limiting slot along the width direction of the body, and the second limiting bending arm is bent toward the second sub-bottom wall surface; and
when the unlocking component moves toward the first wall surface to a second preset position, the first limiting support arm abuts against a wall surface of the first limiting slot facing away from one side of the second wall surface, and the second limiting support arm abuts against a wall surface of the second limiting slot facing away from one side of the second wall surface, to define a movement stroke of the unlocking component.

10. The optical module according to claim 7, wherein the second recessed portion comprises a first bottom wall surface, a first limiting wall surface, and a second limiting wall surface, the first limiting wall surface and the second limiting wall surface are oppositely arranged on both sides of the first bottom wall surface along a width direction, and the unlocking component is limited between the first limiting wall surface and the second limiting wall surface; and
the second recessed portion further comprises a second bottom wall surface, a third limiting wall surface, and a fourth limiting wall surface, the second bottom wall surface is located at one end of the first bottom wall surface facing away from the second wall surface, and the second bottom wall surface is recessed relative to the first bottom wall surface; the third limiting wall surface and the fourth limiting wall surface are located on both sides of the second bottom wall surface along a width direction of the second bottom wall surface, the third limiting wall surface is recessed relative to the first limiting wall surface, and the fourth limiting wall surface is recessed relative to the second limiting wall surface;
the unlocking component further comprises an overmolded handle, one end of the overmolded handle covers one end of the body facing away from the second wall surface, the other end of the overmolded handle extends to an outer side of the second recessed portion, and the overmolded handle is limited between the third limiting wall surface and the fourth limiting wall surface;
wherein the overmolded handle is a soft member;
a plurality of slots are provided at the end of the body facing away from the second wall surface, the slots extend along a width direction of the body, and the plurality of slots are arranged along a length direction of the body; and
part of the overmolded handle is embedded into the slots to be connected to the overmolded handles located on both sides of the body, wherein a thickness of a part of the overmolded handle covering the body is greater than a thickness of the rest part; and
the outer cover plate further comprises:
a second extension portion, wherein the second extension portion is located at one end of the cover plate body facing away from the second wall surface and extends away from the second wall surface, a width of the second extension portion is less than the width of the cover plate body, and the second extension portion is limited between the third limiting wall surface and the fourth limiting wall surface; and
a third bent portion, bent from one end of the second extension portion facing away from the second wall surface toward the lower shell, and fitted against an inner wall surface of the second extension portion, wherein a width of the third bent portion is greater than a width of the second extension portion, such that an end of the third bent portion is in contact with an inner wall surface of the cover plate body;
a recessed slot is formed by recessing an outer wall surface of the cover plate body toward the inner wall surface, the recessed slot is configured to accommodate a label, and a depth of the recessed slot is greater than a thickness of the label; and
a second protruding portion is formed by protruding the inner wall surface of the cover plate body corresponding to the recessed slot, and a protrusion height of the second protruding portion is greater than a thickness of the third bent portion.

11. The optical module according to claim 2, wherein the force applying member comprises a fourth bent portion, the fourth bent portion is bent from one end of the force applying member facing away from the body toward the second wall surface, and the fourth bent portion is fitted against one side of the force applying member facing the second wall surface;
sunken slots are provided in both sides of the locking portion, the sunken slots are recessed relative to the second wall surface, and a side wall of the sunken slot facing the first wall surface is a ramp wall surface; and when the unlocking component is in a reset state, the fourth bent portion sinks into the sunken slots.

12. The optical module according to claim 1, wherein the unlocking component comprises a gripping portion and a connecting portion, one end of the connecting portion is connected to the gripping portion, and the other end of the connecting portion is connected to one end of the assembly portion; the unlocking component comprises an unlocking body and an unlocking support body, one end of the unlocking body is connected to the other end of the assembly portion, the other end of the unlocking body is connected to the unlocking support body, a height of the unlocking support body is greater than a thickness of the unlocking body, and the unlocking surface is configured to abut against the unlocking support body.

13. The optical module according to claim 12, wherein the support plate is located at a top of one end of the lower shell; the support surface is formed at a top of the support plate, a bottom of the assembly mechanism is connected to the support surface; and the clamping component is provided at an end of the support surface.

14. The optical module according to claim 13, wherein the assembly mechanism comprises a first baffle and a second baffle, the first baffle is provided at an edge of one side of the support surface, and the second baffle is provided at an edge of the other side of the support surface;
a first limiting assembly is provided on one side of the first baffle facing the second baffle, and a first assembly cavity is formed among the first baffle, the first limiting assembly, and the support surface; and
a second limiting assembly is provided on one side of the second baffle facing the first baffle, a second assembly cavity is formed among the second baffle, the second limiting assembly, and the support surface, and the first assembly cavity and the second assembly cavity are in limiting connection with the assembly portion.

15. The optical module according to claim 14, wherein the assembly portion comprises an assembly body, a first assembly component and a first notch are provided on one side of the assembly body, and a second assembly component and a second notch are provided on the other side of the assembly body;
the first assembly component comprises a first assembly post and a second assembly post, a first gap is provided between the first assembly post and the second assembly post, a first assembly protrusion is provided on the first assembly post, the first assembly protrusion is located on a side of the first gap, and the first notch is located on a side of the first assembly protrusion and is in communication with the first gap; and
the second assembly component comprises a third assembly post and a fourth assembly post, a second gap is provided between the third assembly post and the fourth assembly post, a second assembly protrusion is provided on the third assembly post, the second assembly protrusion is located on a side of the second gap, the second notch is located on a side of the second assembly protrusion, and the second notch is in communication with the second gap.

16. The optical module according to claim 15, wherein a mounting hole is provided at a top of the assembly body, an accommodating slot is provided at a bottom of the assembly body, and the accommodating slot is in communication with the mounting hole; a first limiting block is provided on the support surface, the first limiting block is located at one end of the accommodating slot, and a second limiting block is provided on a side wall of the other end of the accommodating slot; and
a spring is provided in the accommodating slot, one end of the spring is connected to the first limiting block, and the other end of the spring is connected to the second limiting block.

17. The optical module according to claim 13, wherein the unlocking support body comprises a first support body and a second support body, a notch is formed between the first support body and the second support body, and one end of the first support body and one end of the second support body are respectively connected to the unlocking portion body;
the clamping component is located within the notch, such that the first support body is located on one side of the clamping component and the second support body is located on the other side of the clamping component; and
the first support body comprises a first extension surface and a second extension surface, one end of the first extension surface is connected to a bottom surface of the unlocking body, one end of the second extension surface is connected to a top surface of the unlocking body, and the first extension surface and the second extension surface enable a height of the other end of the first support body to be greater than a height of one end of the first support body.

18. The optical module according to claim 17, wherein a locking surface is provided at the top of the support plate, the locking surface is located at the other end of the support plate, the locking surface is configured to assemble and support a locking spring tab, and a position of the locking surface is higher than a position of the support surface; and
the unlocking surface comprises a first unlocking inclined surface and a second unlocking inclined surface, the first unlocking inclined surface is located on one side of the locking surface, and the second unlocking inclined surface is located at the other side of the locking surface.

19. The optical module according to claim 13, wherein an assembly slot is provided in an inner side of a side wall of the lower shell; and the optical module further comprises:
an optical emission component, with a first optical fiber adapter provided at one end thereof, wherein a first stop boss and a second stop boss are provided on the first optical fiber adapter, and a first gap is formed between the first stop boss and the second stop boss;
an optical reception component, with a second optical fiber adapter provided at one end thereof, wherein a third stop boss and a fourth stop boss are provided on the second optical fiber adapter, and a second gap is formed between the third stop boss and the fourth stop boss; and
a shielding sheet, comprising a shielding sheet body, and a first pressing portion and a second pressing portion that are provided at a top of the shielding sheet, wherein a first through hole and a second through hole are provided in the shielding sheet body, and an elastic bend is provided on a side of the shielding sheet body;
the first optical fiber adapter is embedded into the first through hole, the second optical fiber adapter is embedded into the second through hole, and the elastic bend is pressed against the assembly slot, such that a side of the shielding sheet body abuts against a side surface of the first stop boss and a side surface of the second stop boss; and the first pressing portion is located above the first optical fiber adapter, and the second pressing portion is located above the second optical fiber adapter.

20. The optical module according to claim 19, further comprising a fixing sheet, wherein the fixing sheet comprises a first fixing portion, a bridging portion, and a second fixing portion, one end of the bridging portion is connected to a top end of the first fixing portion, and the other end of the bridging portion is connected to a top end of the second fixing portion; and
a first assembly notch and a second assembly notch are provided in the second fixing portion, the first assembly notch is in assembly connection with the first optical fiber adapter, and the second assembly notch is in assembly connection with the second optical fiber adapter; and a first side surface of the first fixing portion abuts against the first stop boss and the third stop boss, and a second side surface of the second fixing portion abuts against the third stop boss and the fourth stop boss.
